(19) United States
(12) Patent Application Publication
(10) Pub. No.: US 2002/0144091 A1
(43) Pub. Date: Oct. 3, 2002

(54) Method and apparatus for dynamic register management in a processor

(76) Inventor: Larry Widigen, Salinas, CA (US)

Correspondence Address: BEYER WEAVER & THOMAS LLP, P.O. BOX 778, BERKELEY, CA, 94704-0778, US

(21) Appl. No.: 09/825,753

(22) Filed: Apr. 3, 2001

(51) Int. Cl. G06F 9/30

(52) U.S. Cl. 712/217

(57) ABSTRACT

A method for mapping a plurality of virtual registers to a plurality of physical registers is provided. Generally, a plurality of virtual registers are provided where each virtual register comprises physical register address bits. A status indicator for indicating the status of each virtual register is also provided.

A processing device is also provided. The processing device has a plurality of physical registers. A plurality of virtual registers, wherein each virtual register comprises physical register address bits form part of the processing device. The processing device also has a status indicator for indicating a status of each virtual register.

### BACKGROUND OF THE INVENTION

The present invention relates to microprocessors. More particularly, the present invention relates to register management for superscalar microprocessors.

User visible registers are referred to as virtual or logical registers. Physical registers refer to the actual register storage in a register file. There may exist more physical register addresses than physical registers, in which case the implemented physical registers are in the form of a cache with the rest of the addressable physical register space being in the form of a table in memory. There may exist more physical register addresses than virtual register addresses. Each virtual register address may be allocated a physical register address which assignment renames the register. These allocations change over time.

Source virtual register references or addresses in an instruction are mapped to reference the currently assigned physical register address when the instruction is decoded. A technique to map a source virtual register address to a mapped physical register address that is commonly used is to have the virtual register address field of the instruction drive the select lines of a multiplexer which has its corresponding input data ports connected to each of the virtual register to physical register current mappings. The multiplexer output will then be the physical register address of the mapping for the virtual register reference specified by the source instruction field, and this physical register address will replace the virtual register reference in the issued instruction.

Destination virtual register references or addresses in an instruction which will update the register are mapped to a new physical register address when the instruction is decoded. This new physical register address is allocated from and removed from a list of free or unallocated physical register addresses. A list, table, queue status, or other equivalent means may be used to identify which physical registers are unallocated. This new physical register address becomes the replacement assignment for the currently allocated physical address and its register and is referred to as the address of the new destination register (or just the “new dest” address). Generally, the current physical register address is moved to a retirement list entry associated with the instruction and is referred to as the old destination register (or just the “old dest”) address while the “new dest” address replaces it as the new current assignment or rename for the virtual register. When an instruction that specified an update of a destination register retires the “old dest” addresses are removed from that instruction's retirement list and placed upon the unallocated register address list. An instruction retires when it and all older instructions that have been issued have completed without exception. The most typical exception is the mispredicted direction of a conditional branch instruction. An interrupt can also be considered to be an exception as can a fault.

It is this method of providing a new physical register address for the update of an instruction's virtual register that allows the issuance of instructions on a speculative basis without having to wait for the actual update to occur. This allows ensuing instructions' source references to be mapped to reference the new physical register destination address. It also allows ensuing instructions that have the same virtual register reference as a destination to be issued with a destination reference map to a new physical register. Typically, a means is provided for remembering the state of the virtual register address assignments for an instruction in case it faults and it and any speculatively ensuing instructions need to be aborted or discarded and the state of the address assignments restored. The abort of an instruction stream in response to an exception such as a mispredicted branch direction or memory fault allows the processor to backup to a known state prior to the instruction causing the fault.

A procedure or subprogram or subroutine is typically activated by transferring control to it by a “Call Subroutine” instruction, and it is deactivated by transferring control back, in response to executing a “Return” instruction, to the next sequential instruction following the “Call Subroutine” instruction. Arguments for a subroutine are values or references that are passed between the subroutine and the program that calls the subroutine. If a subroutine is to use arguments, it specifies variables that will accept the values of the arguments. These variables are called the formal parameters of the subroutine. They behave like any other local variables inside the subroutine. When a subroutine is executed the formal parameters accept the values of the arguments. This acceptance method is described as the binding of the arguments to the formal parameters.

Typically the procedure's program saves the contents of some of the registers to memory in order to use said registers, and later the procedure's program restores the contents of said registers from memory. This allows the procedure to use some registers for intermediate computation and to later return them to their original state such that those registers of the program that invoked the procedure, the calling program, appear to be unchanged. To facilitate discussion, FIG. 1 is a schematic view of a computer system with registers R0 100, R1 102, and R2 104, and a last-in first-out stack 106, used in the prior art. A Call command for a subroutine may specify that values in register R1 102 and register R2 104 be used by the subroutine (allowing the calling program to pass values to the subroutine through R1 and R2) and that the value calculated by the subroutine be placed in register R0 100, allowing the subroutine to pass a value back to the calling program through R0. In such a case, the values in registers R1 and R2 102, 104 may be pushed onto the last-in first-out stack 106. The subroutine may then manipulate the values in registers R1 and R2 100, 102, which may change the values in these registers. The subroutine then places the calculated value in register R0 and prepares to revert the process back to the calling program. Since, the calling program may use the original values in registers R1 and R2 100, 102 before the subroutine was called, the original values are popped by the subroutine from the last-in first-out stack 106 and placed in registers R1 and R2 100, 102. The subroutine then provides a “Return” command, which reverts the process back to the calling program. The saving and restoring of these registers, sometimes referred to as “pushing” and “popping” said registers, consumes time as the contents of each such register is moved between the register file and the memory system.

To facilitate discussion, FIG. 2 is a schematic view of a computer system that uses overlapping registers. Such a system may have a first set of registers R0-R7 and a second set of registers R0′-R7′, which overlap with the first set of registers. A third set of registers R0″-R7″ may be provided that overlap with the second set of registers R0′-R7′. In the example shown in FIG. 2, registers R6 and R7 are identical to registers R0′ and R1′ respectively, and registers R6′ and R7′ are identical to R0″ and R1″ respectively. The main program may store unshared values in registers R0-R5 and use registers R6 and R7 to pass data to and from a subroutine. The subroutine may use registers R2′ to R5′ to store unshared values and use registers R0′ and R1′ to exchange data with the main program. The subroutine may also use registers R6′ and R7′ to exchange data with a subroutine of the subroutine, which uses registers R0″ and R1″ to exchange data with the subroutine. Some computer architectures provide multiple register sets in the form of a circular stack of registers referred to as register windows to communicate data between the calling program and the called subprogram and to provide temporary register storage for use of the subprogram. In a circular stack, if the number of subroutines called requires that registers R0-R7, which store values of a main program, be used to store values for a subroutine, the values in R0-R7 may then be placed on a last-in first-out stack. The number of shared and unshared registers could be changed according the design of the computer system. Some of the disadvantages of such systems is that each program and subroutine may be assigned a fixed number of registers when in some circumstances more registers may be desired or less registers may be desired, causing an inefficiency. In addition, when too many subroutines are called, such systems may require a last-in first-out stack, which may slow the system. In addition, a certain amount of manipulation may be required by programmers to allow the passing of data from a main program to a subroutine of a subroutine.

### SUMMARY OF THE INVENTION

To achieve the foregoing and other objects and in accordance with the purpose of the present invention for mapping a plurality of virtual registers to a plurality of physical registers generally, a plurality of virtual registers are provided where each virtual register comprises physical register address bits. A status indicator for indicating the status of each virtual register is also provided.

A processing device is also provided. The processing device has a plurality of physical registers. A plurality of virtual registers, wherein each virtual register comprises physical register address bits form part of the processing device. The processing device also has a status indicator for indicating a status of each virtual register.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic view of a computer system used in the prior art.

FIG. 2 is a schematic view of a computer system that uses overlapping registers.

FIG. 3 is a block diagram of a central processing unit.

FIG. 4 is a more detailed schematic view of the mapping unit.

FIG. 5 is a high level flow chart of the operation of an embodiment of the invention.

FIG. 6 is a flow chart of the dirty processing procedure.

FIG. 7 is a more detailed flow chart of the state processing step used in the first preferred embodiment.

FIG. 8 is a more detailed flow chart of the exception processing step.

FIG. 9 is a more detailed flow chart of the instruction wait step.

FIG. 10 is a more detailed flow chart of the process call step.

FIG. 11 is a more detailed flow chart of the process return step.

FIG. 12 is a flow chart of the remap step.

FIG. 13 is a more detailed flow chart of the bind argument step.

FIG. 14 is a more detailed flow chart of the process VABR's step.

FIG. 15 is a more detailed view of the process shadow storage step.

FIG. 16 is a prioritization logic circuit.

FIG. 17 illustrates a five stage pipeline for an example processor.

FIG. 18 shows a program of instructions used in a first example.

FIG. 19 shows an Initial Physical Register State in the Decode Stage at the first clock cycle.

FIG. 20 is a drawing, which represents the virtual registers VR0 through VR15.

FIG. 21 illustrates the dynamic instruction flow of the example program as viewed by the programmer.

FIG. 22 shows the contents of the virtual registers for each instruction that is executed.

FIGS. 23A and 23B show a clock by clock description of the pipeline.

FIG. 24 shows how Instruction 1 is mapped.

FIG. 25 shows how Instruction 2 is mapped.

FIG. 26 summarizes the state of the Physical Registers at the end of Clock 2.

FIG. 27 shows how Instruction 3 is mapped.

FIG. 28 shows how Instruction 4 is mapped.

FIG. 29 summarizes the state of the Physical Registers at the end of Clock 3.

FIG. 30 shows how Instruction 5 is mapped.

FIG. 31 shows how Instruction 6 is acted upon.

FIG. 32 summarizes the state of the Physical Registers at the end of Clock 4.

FIG. 33 shows how Instruction 7 is mapped.

FIG. 34 shows how Instruction 8 is mapped.

FIG. 35 summarizes the state of the Physical Registers at the end of Clock 5.

FIG. 36 shows how Instruction 9 is mapped.

FIG. 37 shows how Instruction 10 is acted upon.

FIG. 38 summarizes the state of the Physical Registers at the end of Clock 6.

FIG. 39 shows how Instruction 11 is mapped.

FIG. 40 shows how Instruction 12 is mapped.

FIG. 41 summarizes the state of the Physical Registers at the end of Clock 7.

FIG. 42 shows how Instruction 13 is mapped.

FIG. 43 shows how Instruction 14 is acted upon.

FIG. 44 summarizes the state of the Physical Registers at the end of Clock 8.

FIG. 45 shows how Instruction 15 is mapped.

FIG. 46 shows how Instruction 15 is mapped.

FIG. 47 summarizes the state of the Physical Registers at the end of Clock 9.

FIG. 48 shows how Instruction 17 is mapped.

FIG. 49 shows how Instruction 18 is mapped.

FIG. 50 summarizes the state of the Physical Registers at the end of Clock 10.

FIG. 51 shows that there is no change in the physical register state at the end of this clock even though Instructions 9, 10, and 11 have retired.

FIG. 52 shows changes in the physical register state in Clock 12.

FIG. 53 shows changes in the physical register state in Clock 13.

FIG. 54 shows changes in the physical register state in Clock 14.

FIG. 55 shows changes in the physical register state in Clock 15.

FIG. 56 shows a program of instructions that will be used in the example.

FIG. 57 shows the Initial Physical Register State in the Decode Stage at the first clock.

FIG. 58 is a drawing representing the virtual registers VR0 through VR15.

FIG. 59 describes the dynamic instruction flow of the example program as viewed by the programmer.

FIG. 60 shows the contents of the virtual registers for each instruction that is executed.

FIG. 61 is a clock by clock description of the pipeline from the Fetch of instructions 1 and 2 in Clock 1 through the Retirement of instructions 14-18 in Clock 15.

FIG. 62 shows how Instruction 1 is mapped.

FIG. 63 shows how Instruction 2 is mapped.

FIG. 64 summarizes the state of the Physical Registers at the end of Clock 2.

FIG. 65 shows how Instruction 3 is mapped.

FIG. 66 shows how Instruction 4 is mapped.

FIG. 67 summarizes the state of the Physical Registers at the end of Clock 3.

FIG. 68 shows how Instruction 5 is mapped.

FIG. 69 shows how Instruction 6 is acted upon.

FIG. 70 summarizes the state of the Physical Registers at the end of Clock 4.

FIG. 71 shows how Instruction 7 is mapped.

FIG. 72 shows how Instruction 8 is mapped.

FIG. 73 summarizes the state of the Physical Registers at the end of Clock 5.

FIG. 74 shows how Instruction 9 is mapped.

FIG. 75 shows how Instruction 10 is acted upon.

FIG. 76 summarizes the state of the Physical Registers at the end of Clock 6.

FIG. 77 shows how Instruction 11 is mapped.

FIG. 78 shows how Instruction 12 is mapped.

FIG. 79 summarizes the state of the Physical Registers at the end of Clock 7.

FIG. 80 shows how Instruction 13 is mapped.

FIG. 81 shows how Instruction 14 is acted upon.

FIG. 82 summarizes the state of the Physical Registers at the end of Clock 8.

FIG. 83 shows how Instruction 15 is mapped.

FIG. 84 shows how Instruction 16 is acted upon.

FIG. 85 summarizes the state of the Physical Registers at the end of Clock 9.

FIG. 86 shows how Instruction 17 is mapped.

FIG. 87 shows how Instruction 18 is mapped.

FIG. 88 summarizes the state of the Physical Registers at the end of Clock 10.

FIG. 89 shows that there is no change in the physical register state at the end of this clock even though Instructions 9, 10, and 11 have retired.

FIG. 90 shows changes in the physical register state in Clock 12.

FIG. 91 shows changes in the physical register state in Clock 13.

FIG. 92 shows changes in the physical register state in Clock 14.

FIG. 93 shows changes in the physical register state in Clock 15.

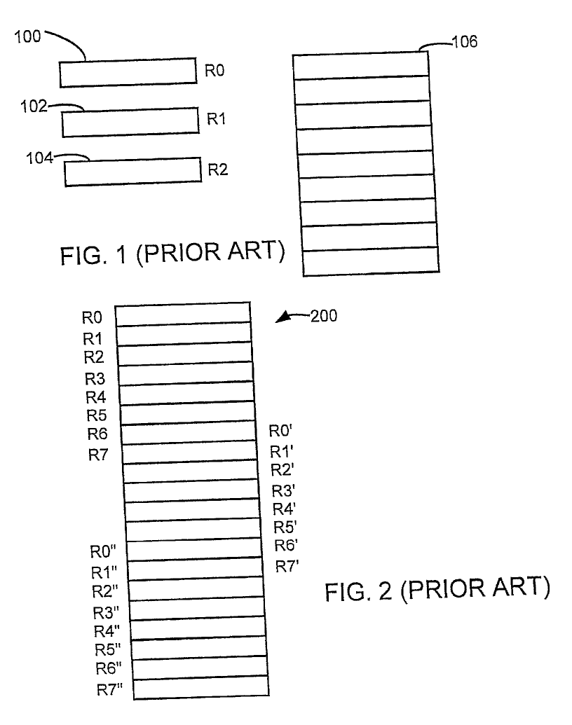

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

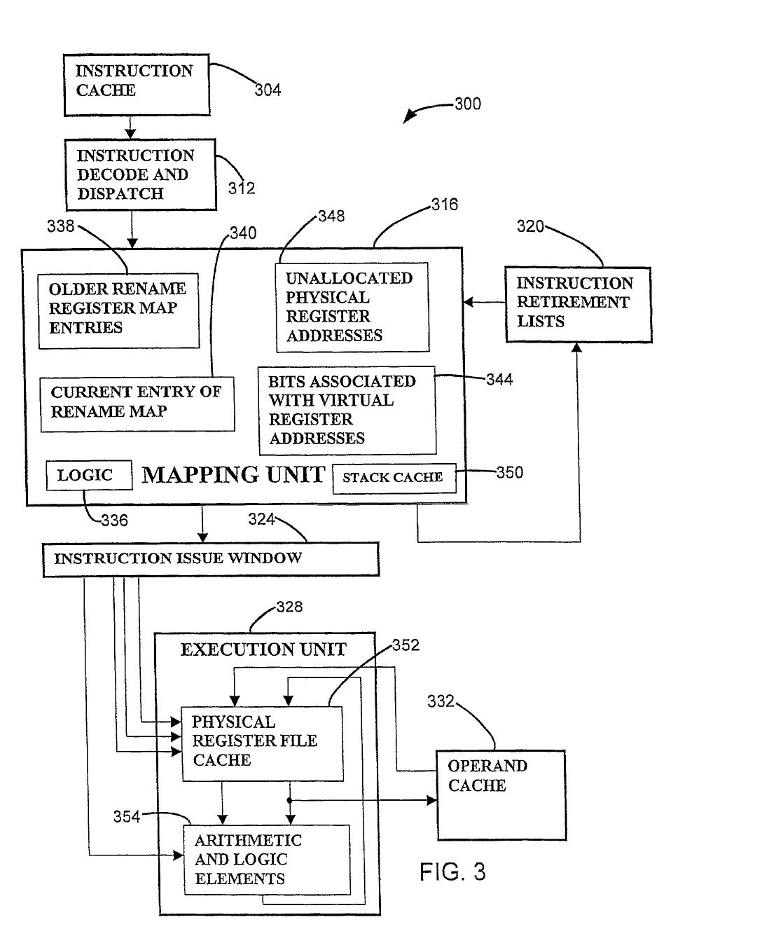

To facilitate understanding, FIG. 3 is a block diagram of a central processing unit (CPU) 300, which forms a preferred embodiment of the invention, which comprises an instruction cache (IC) 304, an instruction decode and dispatch unit (DEC) 312, a mapping unit (MU) 316, instruction retirement lists 320, an instruction issue window 324, an execution unit (EU) 328, and an operand cache 332. The MU 316 includes mapping logic 336, older rename register map entries 338, a current entry of rename map 340, bits associated with virtual register address 344 which hold “dirty” or “clean” status, unallocated physical register addresses 348 and a stack cache 350. In other embodiments of the invention, the stack cache 350 or other features may be placed separate from the mapping unit 316. The execution unit 328 may be any instruction execution unit known in the art, such as an integer instruction execution unit or equivalent or a floating point instruction execution unit or equivalent, and can be used in conjunction with the teachings of the present disclosure. The EU 328 in this embodiment of the invention includes a physical register file cache 352 and arithmetic and logic elements 354.

The DEC 312 is capable of issuing a number of instructions where for all practical purposes, each instruction comprises the necessary opcode to perform an operation, the source address, and destination address. The source address or addresses identify the register or registers from which the data comprising the operands for the operation will be retrieved. The destination address or addresses indicates the register or registers to which the results will be written after the execution unit has completed the instruction.

By contrast memory instructions typically contain the opcode, one or more integer register addresses for memory address computation, zero or one integer destination register address corresponding to where an address arithmetic result may be stored, and a single integer or floating point register address corresponding to the register where data will be read from or stored into. Memory operations include integer and floating point stores, in which the contents of the respective integer or floating point register are stored in memory, and integer and floating point loads, in which the respective integer or floating point register is loaded with a value from memory.

The instruction cache 304 provides a source of instructions to DEC 312. The operand cache 332 provides storage to load and store operands from the EU 328. These caches perform the normal functions associated with a cache including verifying whether a read of an instruction or operand from the cache is successful, termed a hit. When a cache access is not successful it is termed a miss. The cache logic subsequently accesses the memory system on a miss to transfer data between the memory and the cache.

In the preferred embodiment of the invention, the register address information contained in the instruction (source address or destination address) is “virtual” address information defined by the instruction set used by the system. Virtual register addresses correspond to user addressable or “virtual” registers. The number of virtual registers is defined by the instruction set architecture implemented by a system.

The mapping unit 316 associates a physical register for every virtual register in an instruction to provide a mapped instruction. The DEC 312 and the MU 316 send the remapped instructions to the instruction issue window 324. The instruction issue window 324 comprises storage holding a list or queue of mapped instructions that have been issued by the DEC and which are available and waiting to be processed by the execution unit or units.

The instruction retirement list 320 holds the physical register addresses that will no longer have an active rename register map entry when the instruction completes execution and retires. Instruction retirement listings are maintained for all outstanding instructions, which are instructions that have been issued and are not yet retired.

In the illustrative embodiment of the present invention the physical register file cache 352 of the execution unit 328 contains a plurality of physical registers each physical register having a unique physical register address, wherein the number of physical registers addresses exceeds the number of virtual register addresses, where there is no set correspondence between the virtual register addresses and the physical registers, and where the number of physical registers actually used may be less than the number of physical registers that can be addressed by the physical register addresses.

The mapping unit 316 is responsible for mapping each virtual register address to a physical register address 348, for allocating a subset of the virtual registers for the local use of a subprogram as it needs, and for restoring the state of said subset of the virtual registers to the state that existed immediately prior to calling the subprogram.

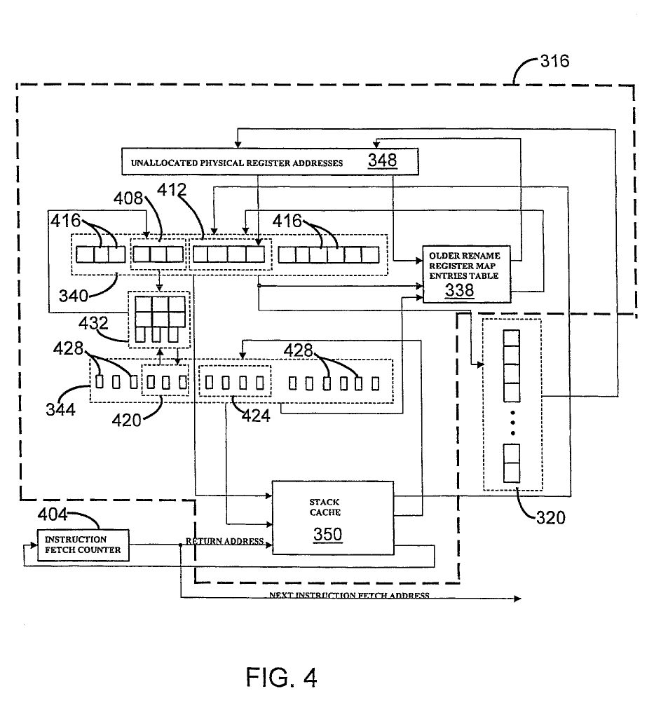

FIG. 4 is a more detailed schematic view of the mapping unit (MU) 316 illustrated together with its relationship to a stack cache 350, the instruction retirement list 320 and an instruction fetch counter 404. The functional units of the MU 316 include the list of unallocated physical register addresses 348, the current entry of the rename map 340, the older rename register map entries 338, status bits associated with the virtual register addresses 344, and the stack cache 350. In the current entry of the rename map 340, each virtual register contains the address of the associated physical register. A virtual argument binding register subset 408 of virtual registers is allocated within the renaming map. A virtual local register subset 412 of virtual registers is allocated within the renaming map 340. In an example illustrated in FIG. 4, the rename map 340 maps three virtual registers as virtual argument binding registers (VABR's) in the virtual argument binding register subset 408 of virtual registers, and four virtual registers as virtual local registers (VLR's) in the virtual local register subset 412 of virtual registers, with the remaining nine virtual registers being mapped as virtual global registers 416.

In the preferred embodiment of the invention, the instruction set architecture implemented by a system specifies that a formal parameter of a subroutine may be referenced by means of a dedicated virtual register address. Each virtual argument binding register (VABR) provides a means for a subroutine to reference such a formal parameter. Besides the physical register mapping that is associated with each virtual register, each VABR also has a binding or mapping to a non-global virtual register that holds the value or reference of the calling program's argument. When the subroutine is executed each VABR provides the associated formal parameter of the subroutine with a map to the value or reference specified for the argument as bound by the calling program. The instruction set architecture implemented by a system may limit the number of formal parameters that it directly supports. When more formal parameters are used by a subroutine than are supported by said instruction set architecture a software convention is typically used to handle the excess.

The status bits associated with the virtual register addresses 344 has in this example one bit associated with each register, so that the status bits associated with the virtual register addresses 344 has in this example three status bits 420 associated with the three virtual registers of the VABR's 408, four status bits 424 associated with the four VLR's 412, and the remaining status bits 428 associated with the global registers 416. In this example, a VABR shadow storage 432 is used, when processing a Return instruction, to store the three virtual register mappings and the three bindings of the VABR's 408 and the three status bits 420 associated with them.

Upon reset of the processor all associated status bits of every virtual register is set to indicate a “clean” state. An initial “clean” state indicates that no physical register address has yet been mapped as a destination reference to a virtual register.

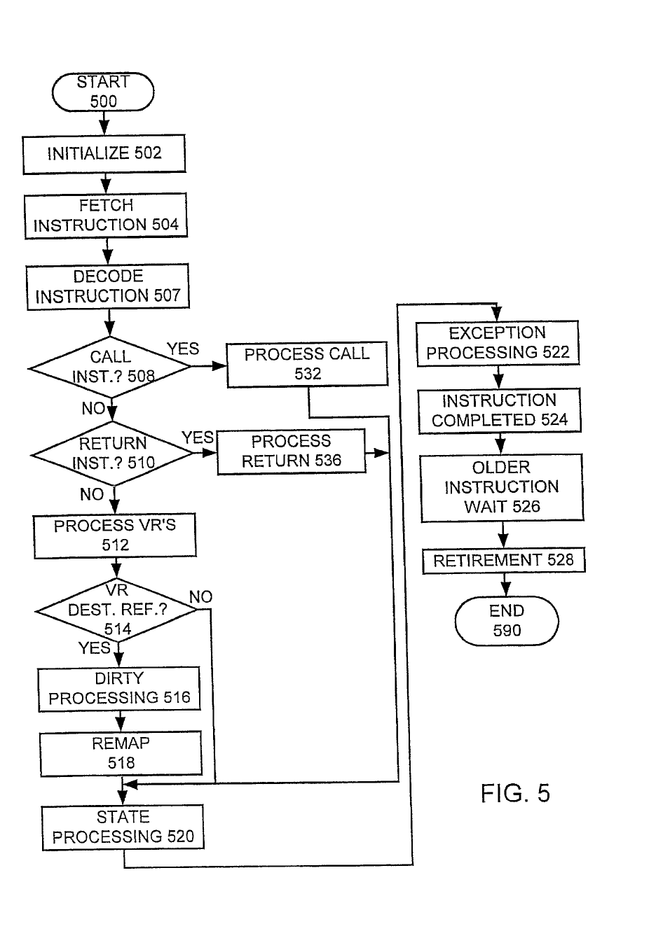

FIG. 5 is a high level flow chart of the operation of an embodiment of the invention. This flow chart does not take an instruction from a fetch stage all the way to it's execution and termination as a single thread of time, because once an instruction is placed in an instruction queue another instruction may be executed out of order. When a program is begun, an initialization step (step 502) occurs. In a first preferred embodiment of the invention, during initialization the status of each physical register is set as “free” and the status of each virtual register is set as “clean”. In a second preferred embodiment of the invention, during the initialization step each virtual register is mapped to a unique physical register, the status of each physical register that is mapped is set to “valid”, the status of each physical register that is unmapped is set to “free”, and the status of each and every virtual register is set to “dirty”. In a third preferred embodiment some virtual registers are mapped to corresponding unique physical registers, the status of each physical register that is mapped is set to “valid”, the status of each physical register that is unmapped is set to “free”, the status of each virtual register that is mapped is set to “dirty”, and the status of each virtual register that is unmapped is set to “clean”.

The instruction decode and dispatch 312 then fetches an instruction from the instruction cache 304 (step 504). The instruction decode and dispatch 312 decodes the instruction (step 507). Next the instruction decode and dispatch 312 checks to see if the fetched instruction is a call instruction (step 508). If the instruction is not a call instruction, then the instruction decode and dispatch 312 checks to see if the fetched instruction is a return instruction (step 510). If the fetched instruction is not a return instruction, the instruction decode and dispatch 312 replaces all of the source references to virtual registers in the fetched instruction with references to the physical registers to which the virtual registers are mapped, in a process VR's step (step 512). Next the instruction decode and dispatch 312 checks to see if the fetched instruction has a virtual register destination reference (step 514). If the fetched instruction has a virtual register destination reference, then the instruction decode and dispatch 312 performs a dirty processing procedure (step 516).

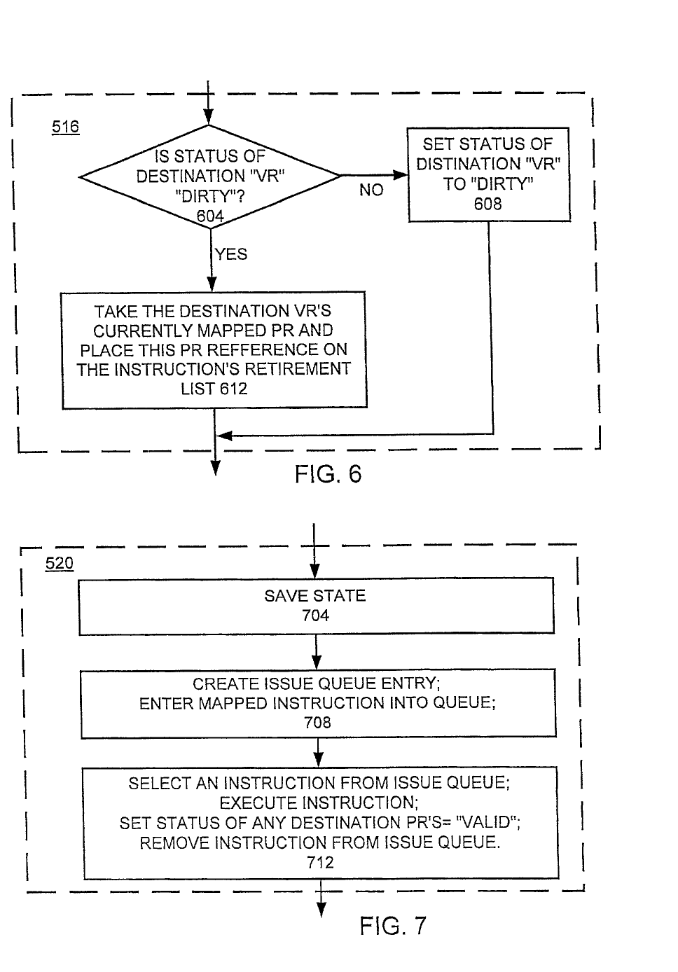

FIG. 6 is a flow chart of the dirty processing procedure (step 516). The instruction decode and dispatch 312 checks to see if the status of the destination virtual register is “dirty” (step 604). This is done by checking the status bits 344 associated with the virtual register addresses 340. If the fetched instruction has a destination virtual register with an associated status bit that has a “dirty” status, then the physical register currently mapped to the destination virtual register is placed on the instruction's retirement list 320 (step 612). If the status of the destination virtual register is not “dirty” (step 604), then instead of step 612 the status of the destination virtual register is set to “dirty” (step 608).

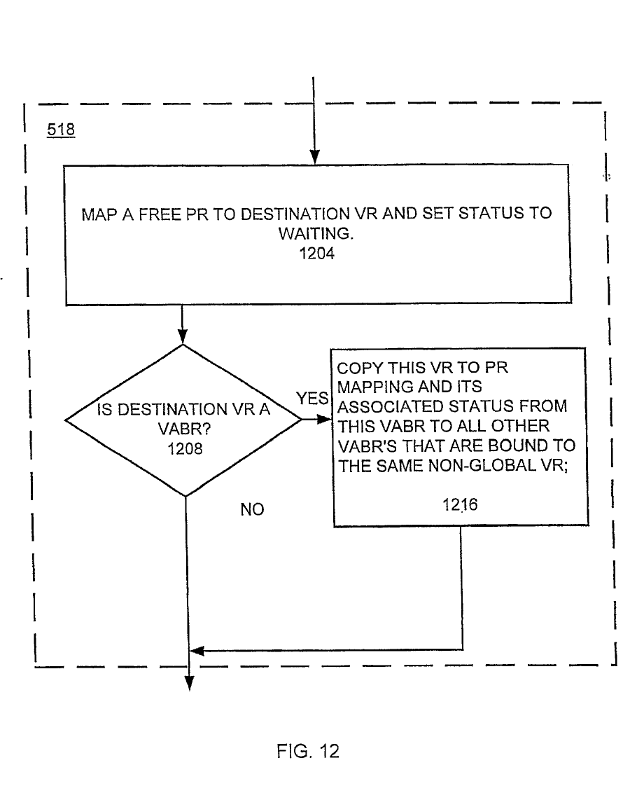

Next a remap step (step 518) is performed. FIG. 12 is a flow chart of the remap step (step 518). A free physical register is mapped to the destination virtual register and the status of this physical register to be set to “waiting” (step 1204). Then the destination virtual register is checked to see if the destination virtual register is a virtual argument binding register (VABR) (step 1208). If the destination virtual register is a VABR, then this virtual register to physical register mapping and its status are copied to all other VABR's that are bound to the same virtual register (step 1216). Then both branches of the condition proceed to the state processing (step 520).

For the step of determining if the instruction has a virtual register destination reference (step 514), if there is no virtual register destination, then the instruction decode and dispatch 312 skips to the state processing (step 520).

Next a state processing step is performed (step 520). FIG. 7 is a more detailed flow chart of the state processing step (step 520) used in the first preferred embodiment. The state processing step (step 520) comprises a save state step (step 704), which saves the status of all virtual registers, saves the values of all “call/return” stack pointers, and all of the current virtual register to physical register mappings. This step saves the state so that if an instruction after its execution is subjected to an exception, all younger instructions may be thrown away by changing the current mapping (the current state) to the saved state. In essence, the saved state is a snap shot of where the system was before the excepted instruction was executed. The saved state is saved in the older rename register map entries 338 in the mapping unit 316. The older rename register map entries 338 may sometimes be referred to as a history table. Next an entry is created in an issue queue 324 where the instruction is stored (step 708). Next an instruction is taken from the issue queue and executed and the status of any destination physical registers of the instruction is set to “valid” and the instruction is removed from the issue queue (step 712). In the first preferred embodiment, the instructions are not taken out of the queue and executed in the same order in which they are placed in the queue. Instead in the first preferred embodiment, the instructions are taken out of the queue and executed in the order in which the source operands for the instructions are ready. In essence, the first instruction with all source operands being ready is the first instruction taken out of the queue and executed. In a second preferred embodiment, the instructions are taken out of the queue and executed in the same order in which they are placed in the queue. In other embodiments the instruction may be removed from the issue queue any time after execution.

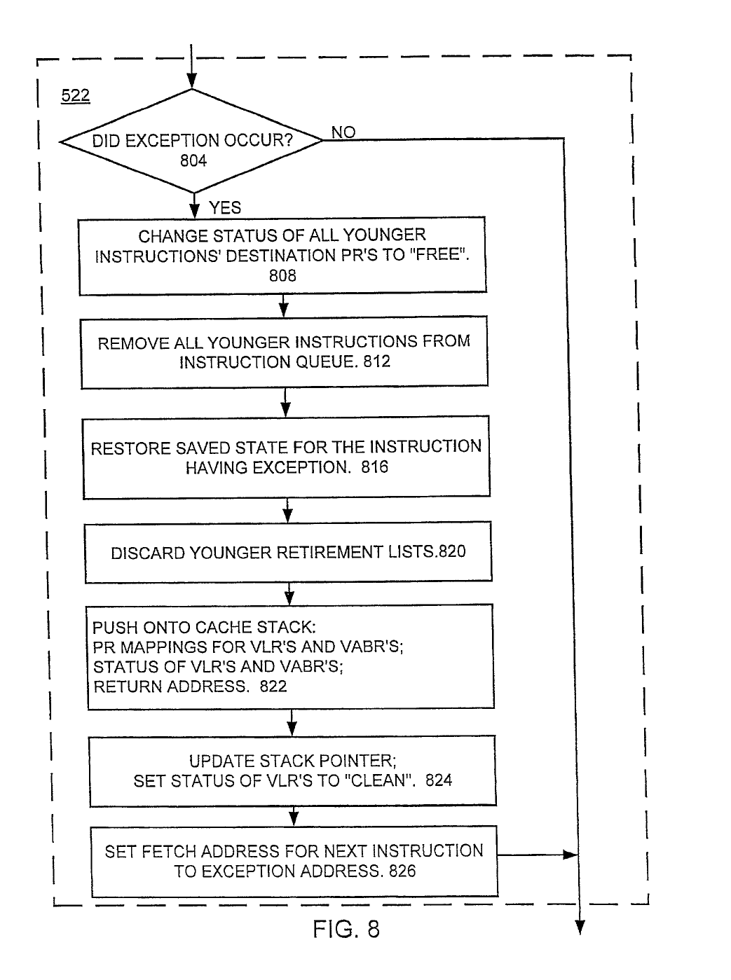

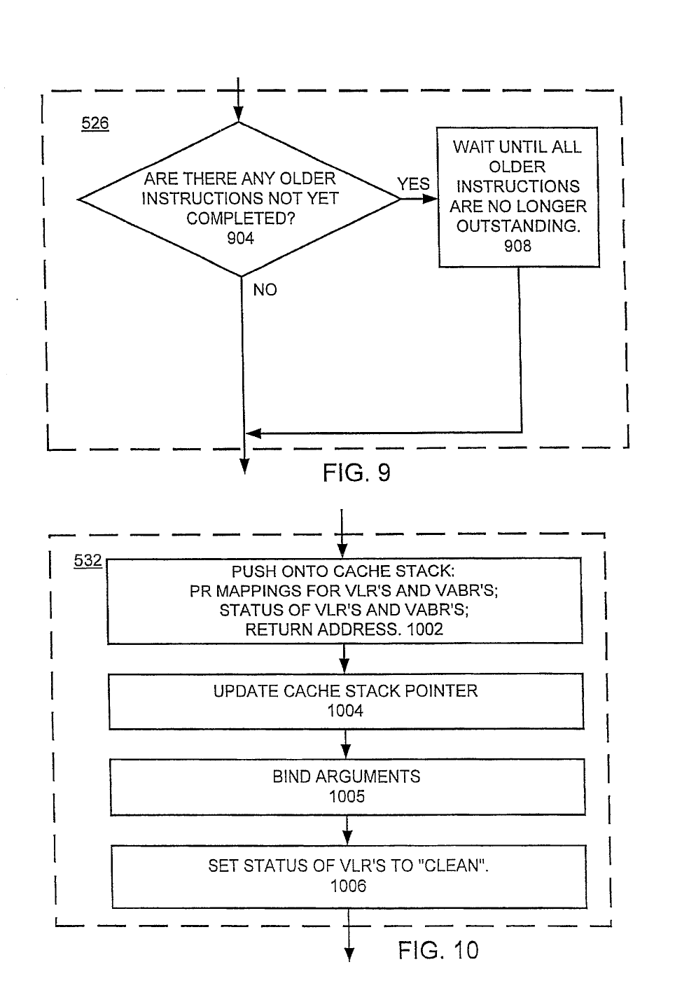

Now that the instruction has been executed, an exception processing step is performed (step 522). FIG. 8 is a more detailed flow chart of the exception processing step (step 522). First a check for exceptions step (step 804) is performed. Exceptions may be an arithmetic overflow, or a bad address of memory, or an error, or some other process that requires exceptional processing. If no exceptions are found, then the exception processing step (step 522) is completed and the next step is performed. If an exception is found, then the status of all destination physical registers for all younger instructions, instructions occurring after the current instruction, are set to “free” (step 808). This causes data from the younger instructions to be deleted and restores the status of the physical registers related to the younger instructions. Next all the younger instructions are removed from the instruction queue (step 812), so that they will no longer be executed. Next the saved state for the instruction having the exception (the current instruction) is restored (step 816). Younger instructions on the retirement list are also discarded (step 820). The physical register mappings for the virtual local registers (VLR's) and the virtual argument binding registers (VABR's), the status of bits associated with the VLR's and VABR's, and the return address are pushed onto the stack cache 350 (step 822). This saves on the stack cache 350 the mappings of the VLR's and VABR's, the status of the virtual registers of the subsets, and the return address. Instead of saving the values for the virtual registers in the stack, the invention places the mappings in the stack. This allows for less information per virtual register to be pushed onto the stack and allows the mappings to be pushed in a single instruction, instead of requiring a push instruction for each virtual register where data for the virtual register is to be pushed onto a stack. Thus the invention is more efficient, since it may effectively move data at a faster rate. Then the stack pointer is updated and the status of the virtual local registers is set to “clean” (step 824). The fetch address is then set to the instruction next to the exception (step 826).

The next step is an instruction completed step (step 524). During this step the instruction is marked as complete so that it is ready to be retired. Next an older instruction wait step (step 526) is performed. FIG. 9 is a more detailed flow chart of the instruction wait step (step 526). First a check is made to see if there are any older instructions that are still outstanding and yet to complete (step 904). If there are instructions that are older than the current instruction, then the current instruction is placed in a wait state until all older instructions are no longer outstanding, but are executed (step 908). Once all older instructions have been executed and are no longer outstanding, the current instruction is then the oldest instruction and therefore may go to the next step, which is the retirement step (step 528). In the retirement step (step 528), the status of all physical registers on the instruction's retirement list are set to “free”. The lifetime of that instruction then ends (step 590).

Going back to the call instruction condition (step 508), if an instruction call is found a process call step (step 532) is executed. FIG. 10 is a more detailed flow chart of the process call step (step 532). The physical register mappings for both the virtual local register subset 404 and virtual argument binding register subset 408 of the virtual registers, the status of the VLR and VABR subsets, and the return address are pushed onto the stack cache 350 (step 1002). This saves on the stack cache 350 the mappings of the VLR and VABR subsets, the status of the VLR and VABR subsets, and the return address. Instead of saving the values in the virtual register in the stack, the invention places the mapping in the stack. This allows for less information per virtual register to be pushed onto the stack and allows the mappings to be pushed in a single instruction, instead of requiring a push instruction for each virtual register where data for the virtual register is to be pushed onto a stack. Thus the invention is more efficient, since it may effectively move data at a faster rate. Then the stack pointer is updated (step 1004).

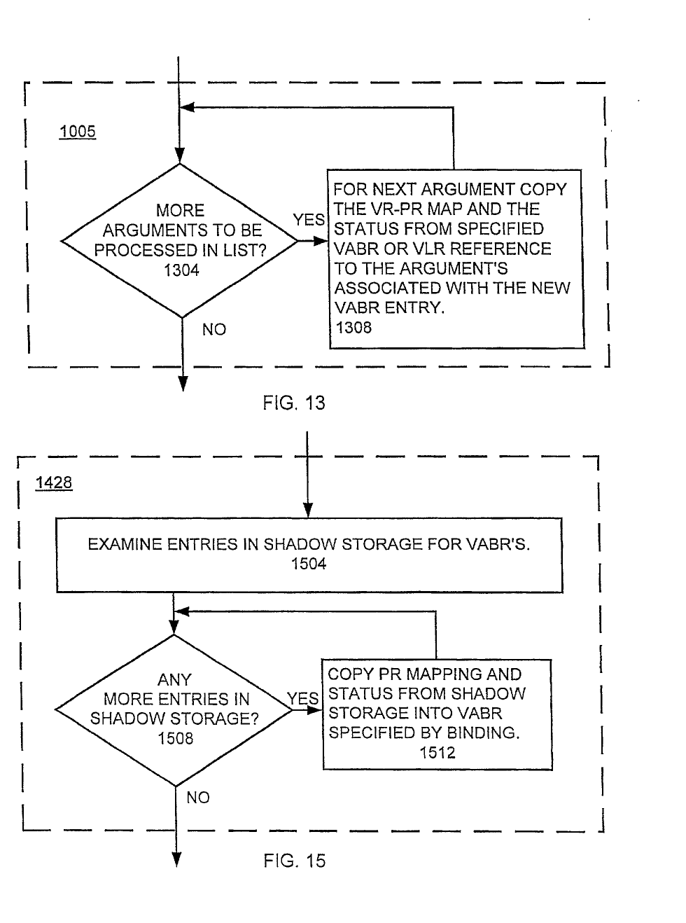

A bind arguments step (step 1005) is then executed. FIG. 13 is a more detailed flow chart of the bind argument step (step 1005). A condition step checks to see if there are more arguments to be processed in the list of arguments provided by the calling program that are to be bound to the formal parameters of the subroutine (step 1304). In the preferred embodiment the list of arguments is a list of non-global virtual register addresses where the value or reference of each argument is held. In the preferred embodiment the first entry in the list of arguments is to be bound to the first formal parameter of the subroutine, the second entry is to be bound to the second formal parameter of the subroutine, and so on for all formal parameters defined by the instruction set architecture implemented by a system. If there is another argument, then for this next argument the virtual register to physical register mapping together with the status from specified non-global virtual register referenced by the argument is copied to the new VABR entry (step 1308). This copy process is binding the value or reference of the argument specified by the calling program to the formal parameter of the subroutine as represented by the VABR. This process is continued until there are no more arguments to be processed in the list. Next, the status of the virtual local registers in the subset of virtual registers 424 is set to “clean” (step 1006). The instruction is then directed to the state processing step (step 520).

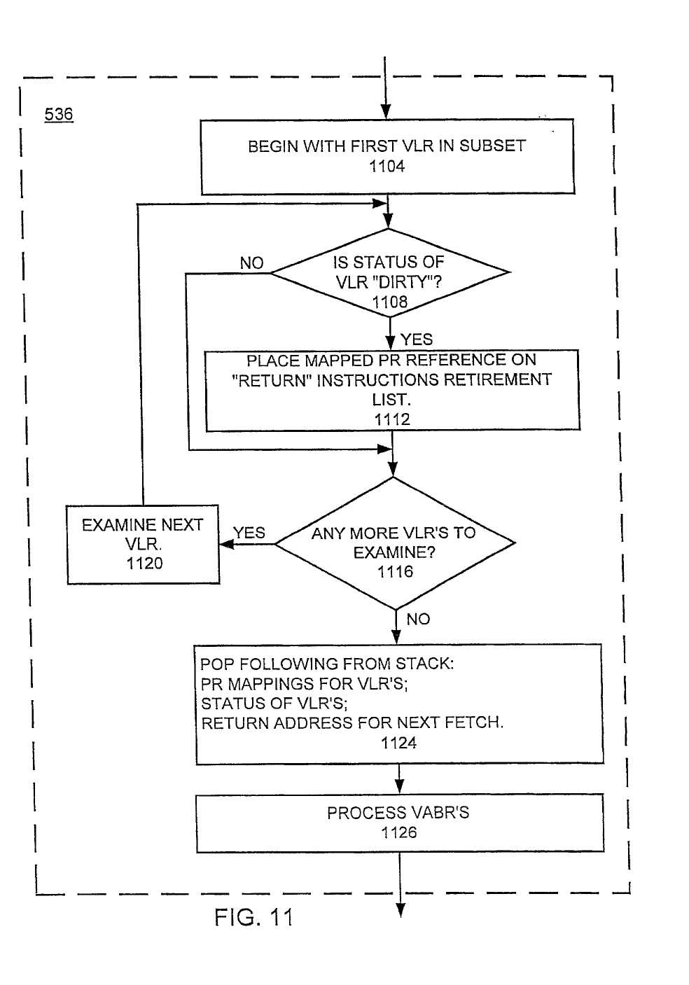

Going back to the return condition (step 510) if a return is detected a process return step (step 536) is performed. FIG. 11 is a more detailed flow chart of the process return step (step 536). The process return step (step 536) begins with the first virtual local register in the subset (step 1104). The status of the virtual local register is checked to see if the status is “dirty” (step 1108). If the status is “dirty” then the mapped physical register reference is placed on the “Return” instruction's retirement list (step 1112). If the status is not “dirty” the placement step (step 1112) is skipped. Then a check is made to see if there are any more virtual local registers in the subset (step 1116). If there are more virtual local registers in the subset, then the next virtual local register in the subset is examined (step 1120). Then the step of checking to see if the status of the examined virtual register is “dirty” (step 1108) is repeated, as shown. If there are no more virtual local registers in the subset, then the physical register mappings for the virtual local registers, the status of the virtual local registers, and the return address for the next fetch are popped from the stack cache.

Next a process VABR's step is performed (step 1126). FIG. 14 is a more detailed flow chart of the process VABR's step (step 1126). Every virtual argument binding register is examined (step 1404). A check is made to see if the binding is made to another VABR or to the same VABR (step 1408). This check is made to cover the situation that can occur in nested subroutine calls when a binding of a formal parameter represented by a VABR was made to another VABR. This is the case when the calling program bound one of its formal parameters that was previously bound, when the program itself was called, to the formal parameter of the subroutine that it was calling. For this situation, any value stored by the subroutine must be passed on the return to the previously bound parameter of the calling program. For the scenario where a VABR is being restored there are two possible sources for the restoration of the physical register mapping and status. The “call/return” stack is one source and a current VABR entry is the other source. The virtual register binding of the VABR is always restored from the stack. The priority selection between the two sources for the restoration of the physical register mapping and status is fixed with the VABR source having the higher priority. Any parallel or serial method may be used to restore the VABR physical register and status mapping as long as this prioritization order is maintained. Since the serial method is the easier to understand it is incorporated in step 1126.

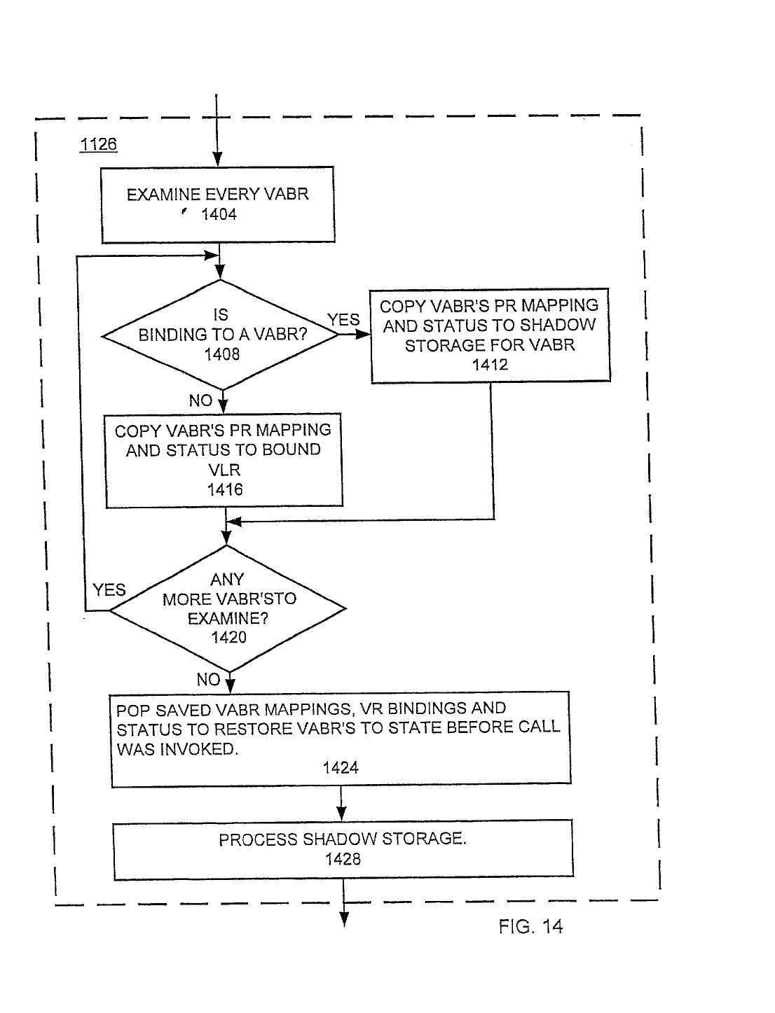

If the binding is to a VABR, then the VABR's physical register mapping and status are copied to the shadow storage 432 for the VABR (step 1412). If the binding is not to a VABR, but instead to a VLR then the VABR's physical register mapping and status are copied to the bound VLR (step 1416). Next a check is made for any more VABR's (step 1420). If there is another VABR, then step 1408 is repeated. If there is no other VABR, then all saved VABR mappings, VR bindings and status are popped from the stack to restore the VABR back to the state it was in before the call was invoked (step 1424). Next the shadow storage is processed (step 1428). FIG. 15 is a more detailed view of the process shadow storage step (step 1428). The entries in the shadow storage for the VABR's are examined (step 1504). A check is made to see if there are any more entries in the shadow storage (step 1508). If there is an entry, then the physical register mapping and status from the shadow storage is copied into the VABR specified by the binding (step 1512) and then step 1508 is repeated. If there are no more entries in the shadow storage then step 1428 is completed. Then the instruction is directed to the state processing step (step 520).

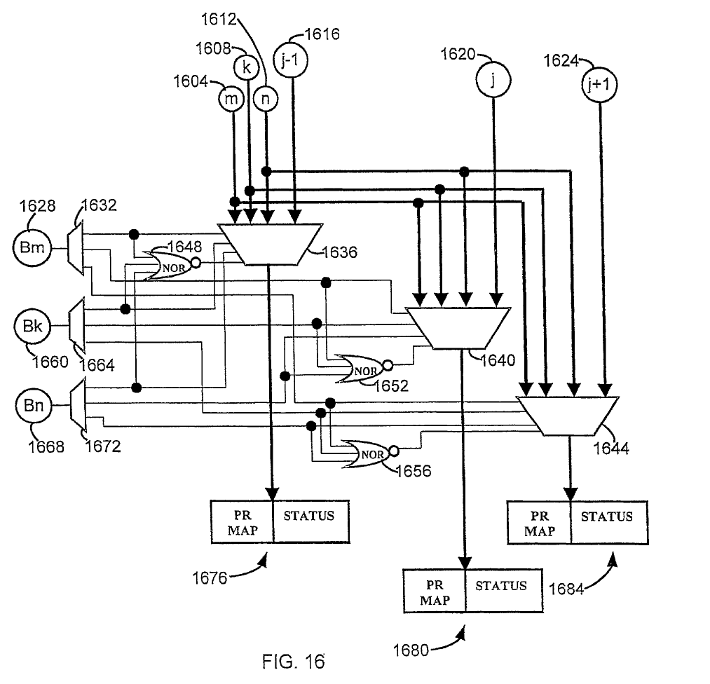

Although steps 1404 to 1428 of FIG. 14 are ordered in a serial fashion that ensures the correct prioritization of updating the VABR entries, these same steps can be accomplished in parallel in a single clock by the circuit of FIG. 16. The serial process steps 1404 to 1428 update the PR and Dirty status Bit of a VLR or VABR entry by first selecting a current VABR as the source that has its Binding to the VLR or VABR. Should no such Binding be found amongst the set of VABR's then the update source defaults to the stack entry. In the situation for the update of a VABR entry a source for the VABR from the shadow storage outranks other update sources. This process typically uses dedicated registers as shadow storage.

In an alternative embodiment a prioritization logic circuit as shown in FIG. 16 allows the circuit to function as a parallel alternative to using the serial VABR shadow storage method. The prioritization logic circuit, as illustrated in FIG. 16, comprises a first, a second and a third VABR 1604, 1608, 1612 and a first, second, and third VR of the set of VLR and VABR entries that are being popped from the “call/return” stack 1616, 1620, 1624, where the stack's first VR 1616 represents a saved j−1 VR in a series, the stack's second VR 1620 represents a saved j VR in a series, and the stack's third VR 1624 represents a saved j+1 VR in a series. The binding 1628 of the first VABR 1604 is provided as input to a first decoder 1632. The first decoder 1632 provides as output a control signal to a first multiplexer 1636, a second multiplexer 1640, and a third multiplexer 1644 and input to a first nor gate 1648, a second nor gate 1652, and a third nor gate 1656. Output of the first nor gate 1648 provides a control signal to the first multiplexer 1636. Output of the second nor gate 1652 provides a control signal to the second multiplexer 1640. Output of the third nor gate 1656 provides a control signal to the third multiplexer 1644. The binding 1660 of the second VABR 1608 is provided as input to a second decoder 1664. The second decoder 1664 provides as output a control signal to the first multiplexer 1636, the second multiplexer 1640, and the third multiplexer 1644 and input to the first nor gate 1648, the second nor gate 1652, and the third nor gate 1656. The binding 1668 of the third VABR 1612 is provided as input to a third decoder 1672. The third decoder 1672 provides as output a control signal to the first multiplexer 1636, the second multiplexer 1640, and the third multiplexer 1644 and input to the first nor gate 1648, the second nor gate 1652, and the third nor gate 1656. The first, second, and third VABR 1604, 1608, 1612 provide current physical register mapping and status input to the first, second and third multiplexers 1636, 1640, 1644. The first virtual register 1616 of the set of VLR and VABR entries from the “call/return” stack provides saved physical register mapping and status input to the first multiplexer 1636, which provides output to the first virtual register 1676 of the set of VLR and VABR entries. The second virtual register 1620 of the set of VLR and VABR entries from the “call/return” stack provides saved physical register mapping and status input to the second multiplexer 1640, which provides output to the second virtual register 1680 of the set of VLR and VABR entries. The third virtual register 1624 of the set of VLR and VABR entries from the “call/return” stack provides saved physical register mapping and status input to the third multiplexer 1644, which provides output back to the third virtual register 1684 of the set of VLR and VABR entries.

### EXAMPLES

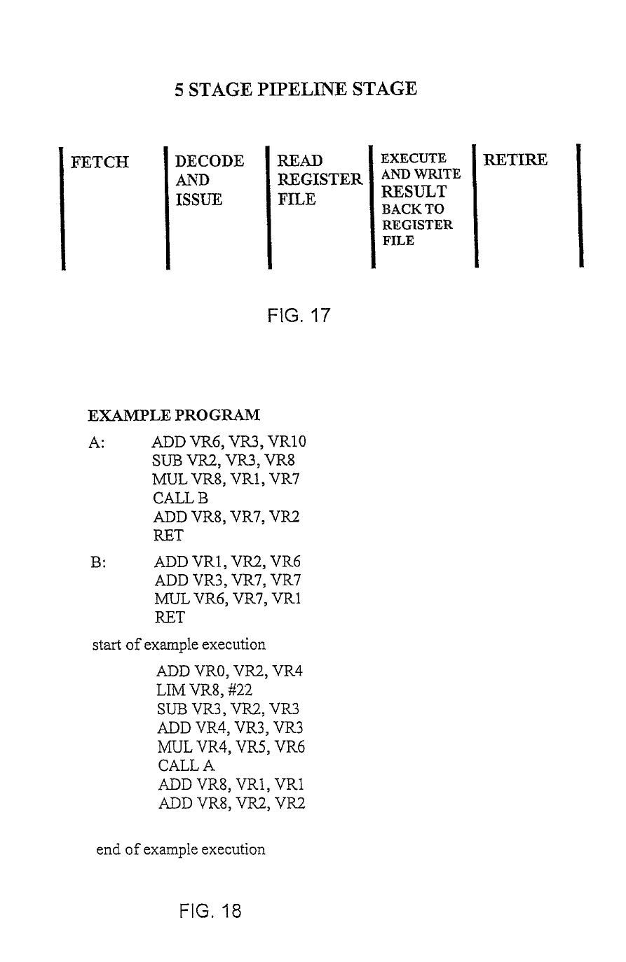

FIG. 17 illustrates a five stage pipeline for an example processor. The stages consist of Fetch, Decode and Issue, Read Register File, Execute and Write Result Back to Register File, and Retire instructions. In this example up to two instructions can be fetched in each clock cycle, up to two instructions can be pre-execution processed in each clock cycle, up to 4 registers can be read from the register file in each clock cycle, up to 2 instructions can be executed and their results written back to the register file in each clock cycle, and up to 8 instructions can be retired in each clock cycle. Note that in this example unconditional transfer of control instructions such as the Call Subroutine instruction and the Return from Subroutine instruction are executed in the Decode stage as they do not make use of execution stage resources such as the Register File.

### Example 1

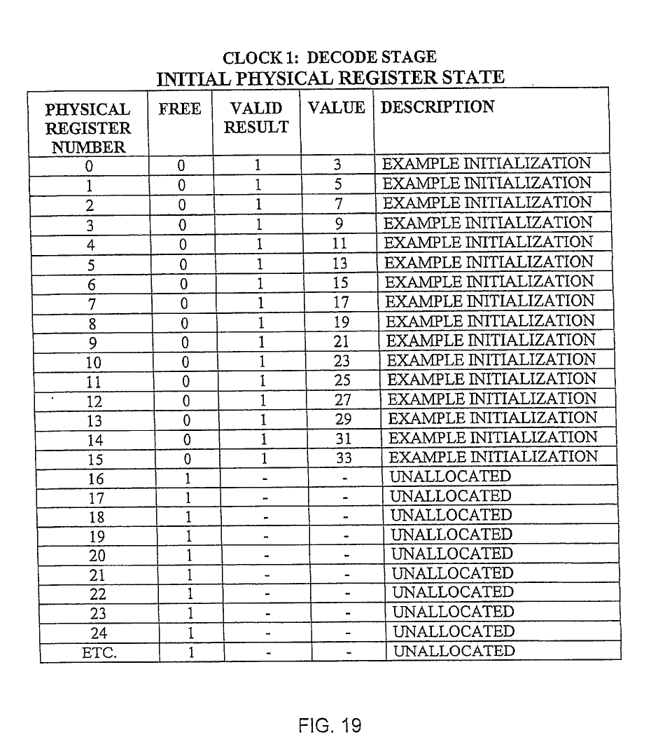

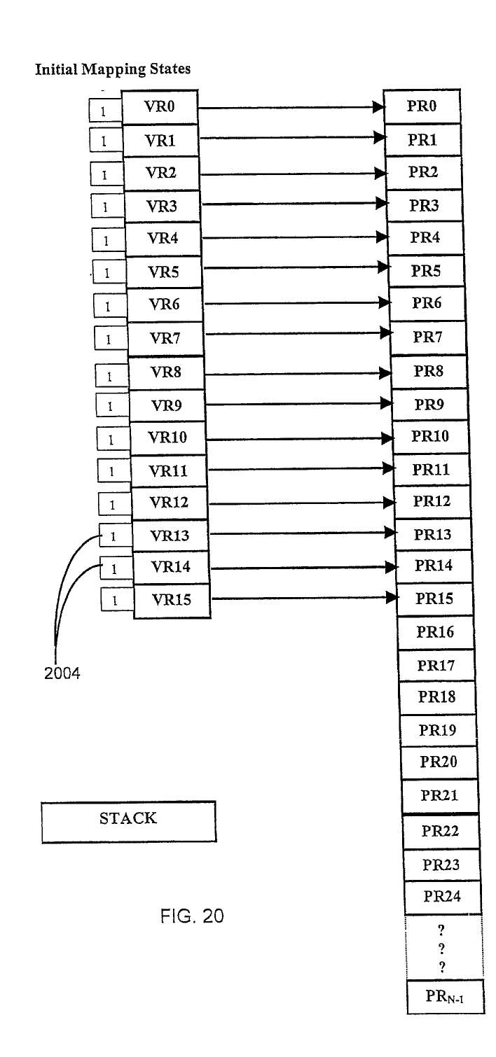

FIG. 18 shows a program of 18 instructions that will be used in a first example. There are two subroutines (A and B) labeled in the instructions and a section of instructions where fetching is to begin. In this example the instruction set architecture implemented by a system has specified local virtual registers (VR6-VR9) for use by subroutines, but it has not defined formal parameters or VABR's. Consequently, all virtual register references are either to global registers or to the subset of virtual registers that are local (VLR) to the subroutine. FIG. 19 shows an Initial Physical Register State in the Decode Stage at the first clock cycle. The example processor has 16 virtual registers that are initially mapped to the first 16 physical registers. FIG. 19 shows the physical register numbers, whether the physical registers are mapped or free, whether the mapped physical register has a valid result or not, and the value of the result. For this example the virtual registers 0 through 15 have been mapped to physical registers 0 through 15 and initialized with odd values beginning with 3 through 33. FIG. 20 is a drawing, which represents the 16 virtual registers VR0 through VR15 with arrows showing how they initially are mapped to 16 physical registers PR0 through PR15. In addition, each virtual register has its Dirty Bit status 2004. Dirty state Bits are being used in this illustration as a possible embodiment although other means can be used to determine dirty status. Note that all of the Dirty Bits for VR0 though VR15 have been initialized to ones. Virtual registers VR6 through VR9 are the virtual local registers that can be temporarily saved and reallocated as private temporary registers for use by a subprogram.

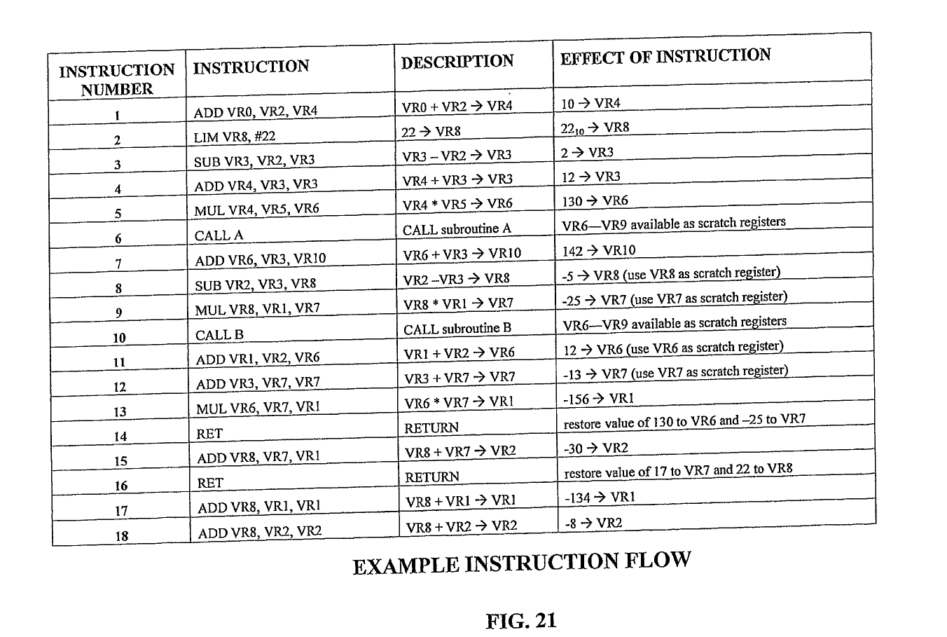

FIG. 21 illustrates the dynamic instruction flow of the example program as viewed by the programmer. Each of the 18 instructions to be executed is numbered in the order in which the instructions are to retire from the pipeline. A pseudo-assembly like instruction is given in the second column followed by a description of what the instruction is expected to do. The last column indicates the effect of the instruction using the values of the registers as initialized and shown in FIG. 19. Note that the effect of the instruction is described from the programmer's viewpoint in terms of Virtual registers.

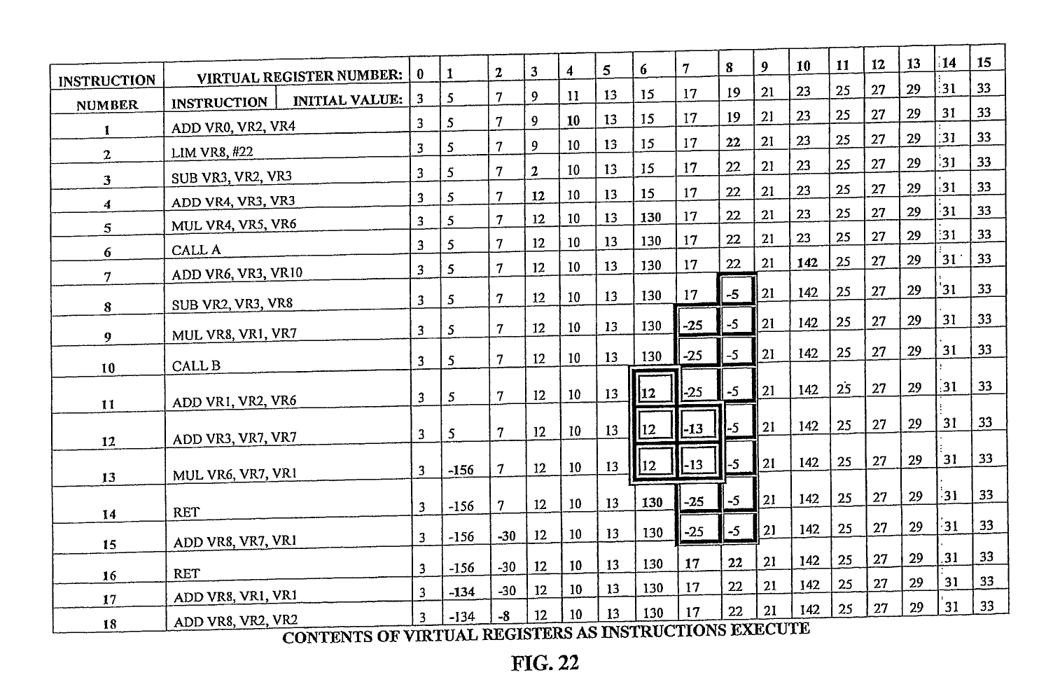

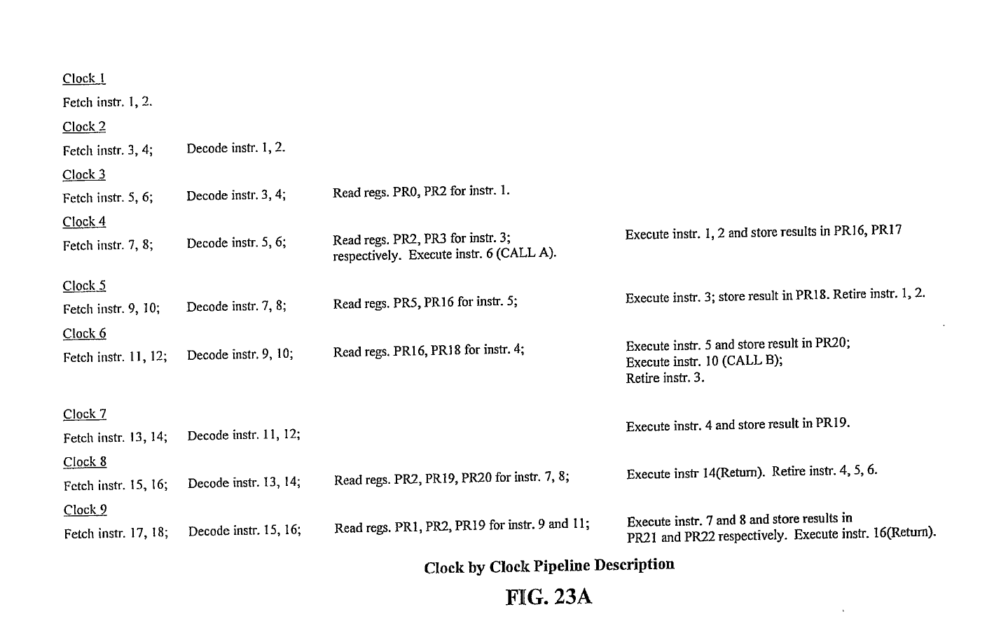

The contents of the virtual registers are shown in FIG. 22 for each instruction that is executed. Instructions 8 through 15 have the contents of VR7 and VR8 highlighted by a Bold outline showing where these 2 registers of the previously mentioned subset are being used to hold temporary computation results for subprogram A. Similarly, instructions 11 through 13 have the contents of VR6 and VR7 highlighted by a Double Bold outline showing where these 2 registers of the subset are being used to hold temporary computation results for subprogram B.

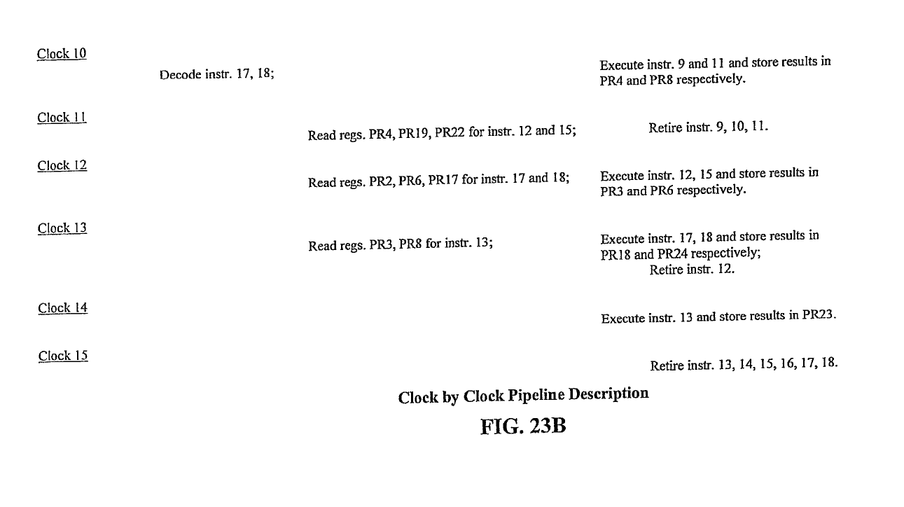

FIGS. 23A and 23B show a clock by clock description of the pipeline from the Fetch of instructions 1 and 2 in Clock 1 through the Retirement of instructions 14-18 in Clock 15. The example begins with the Fetch of instructions 1 and 2 (step 504) while the remainder of the pipeline is empty. Clock 2 shows the Fetching of instructions 3 and 4 (step 504) while instructions 1 and 2 are decoded (step 507). It is during the decode stage that the Virtual registers are mapped to Physical Registers. Clock 3 shows when the physical registers are read for instruction 1 with instruction 1's execution and result write back occurring in Clock 4. Clock 4 is also when instruction 2 is executed (step 714). Clock 5 is when instructions 1 and 2 retire (step 528). Note that while FIGS. 23A and 23B completely describes all stages of the pipeline some of the instructions are executed in an order different from their Fetch and Decode order, yet all instructions retire in the same order as their Fetch and Decode order.

To illustrate the effect of mapping transformations on each instruction and specifically to illustrate the effect of transformations on subroutine Call and Return instructions, each Clock period in the example from the viewpoint of the Decode Stage of the pipeline will be described.

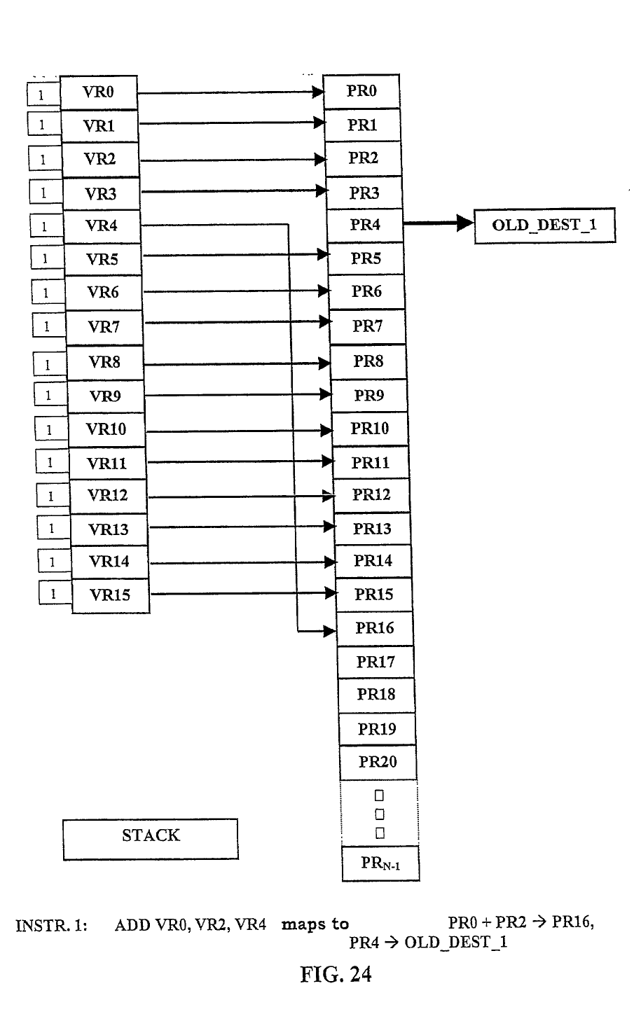

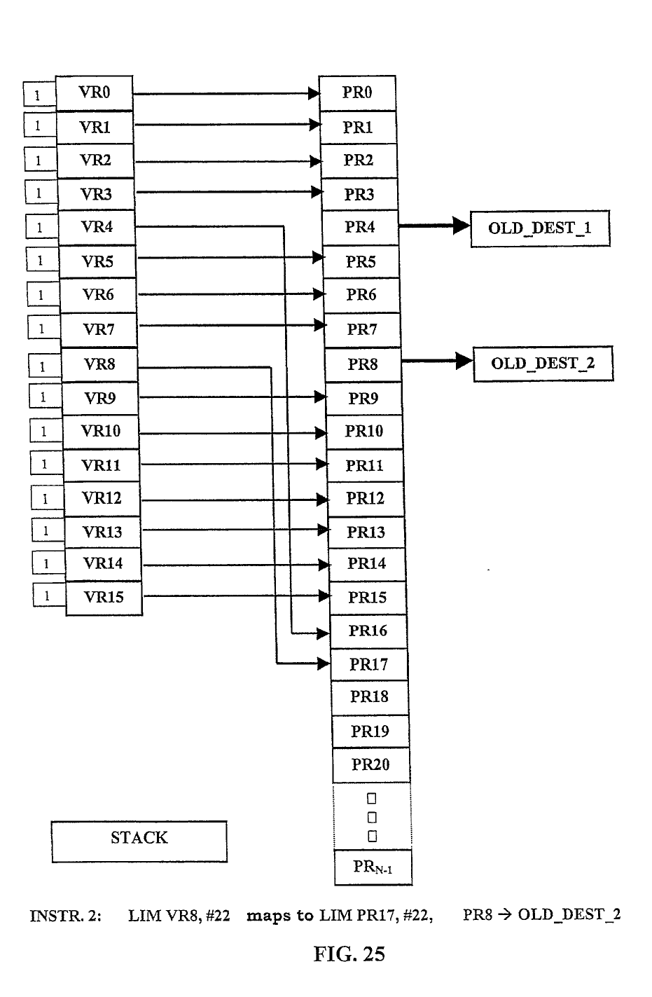

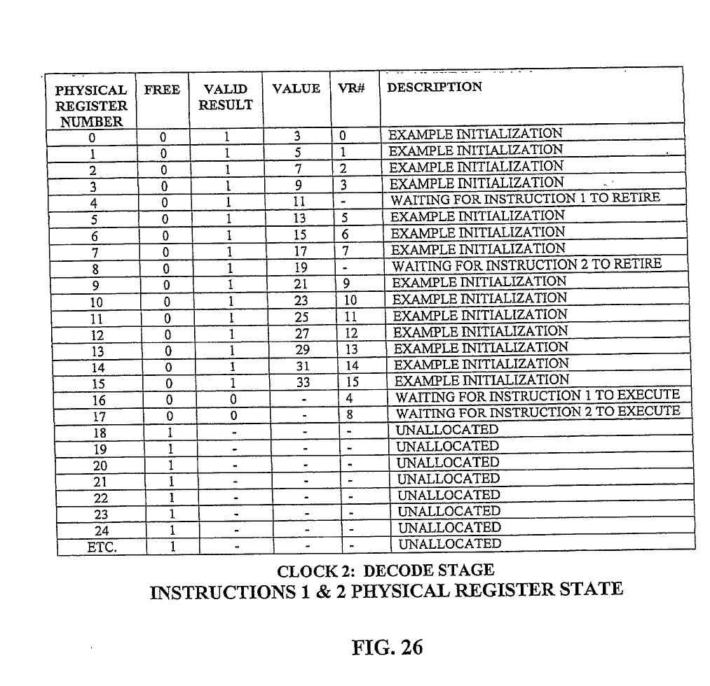

Clock 2 performs pre-execution processing steps 507, 508, 510, 512, 514, 516, 518, 532, 536, 704, 708 on Instructions 1 and 2 and maps their Virtual registers to Physical Registers. FIG. 24 shows how Instruction 1 is mapped. Virtual registers VR0 and VR2 are source registers that are currently mapped to PR0 and PR2 respectively while VR4 is mapped to a new Physical Register PR16 and its old destination PR4 is referenced by Instruction 1's Old Destination (Retirement List) field in the mapped instruction. FIG. 25 shows how Instruction 2 is mapped. The immediate datum 22 serves as a constant source value while VR8 is mapped to a new Physical Register PR17 and its old destination PR8 is referenced by Instruction 2s Old Destination field in the mapped instruction. FIG. 26 summarizes the state of the Physical Registers at the end of Clock 2. Shown in FIG. 26 are the Physical Register numbers, whether the Physical Register is free or allocated, whether the allocated Physical Register has a valid result or not, the value held in the Physical Register when it has a valid result, The Virtual register number that is currently mapped to the Physical Register, and a simple description of the Physical Register's status. Note that when a Virtual register has been mapped only the latest (current) mapping of the Virtual register is shown in FIG. 26.

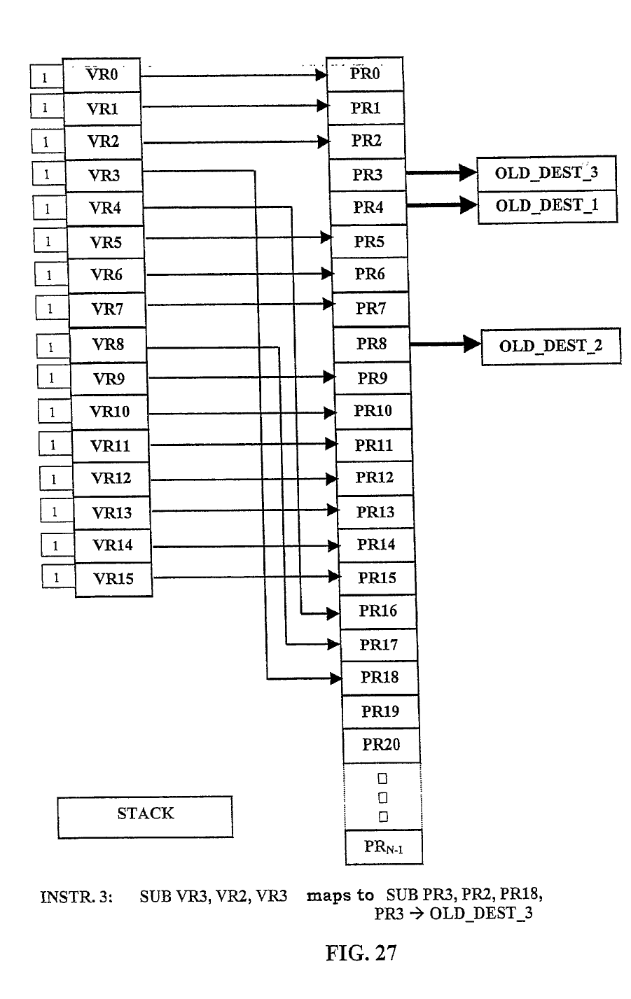

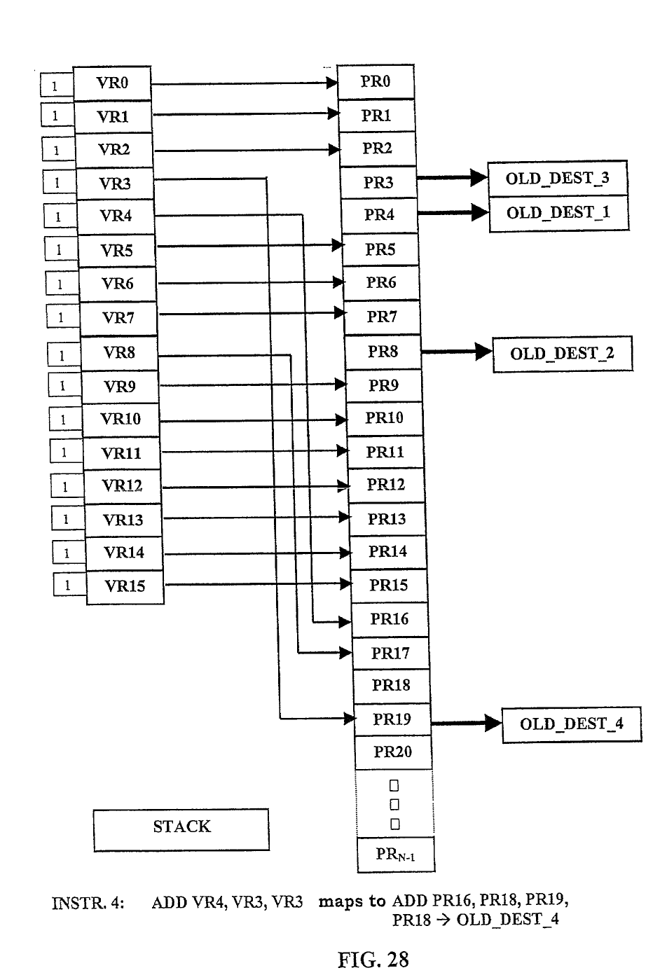

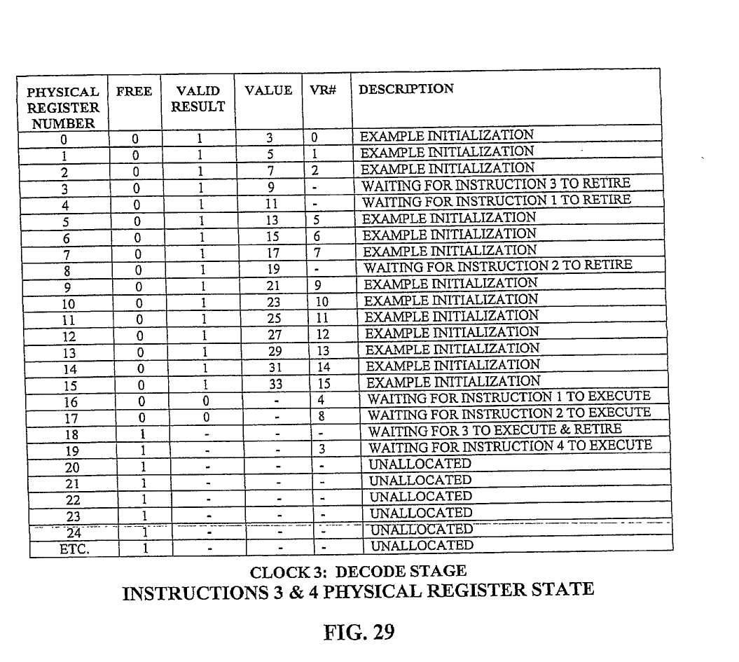

Clock 3 performs pre-execution processing steps 507, 508, 510, 512, 514, 516, 518, 532, 536, 704, 708 on Instructions 3 and 4 and maps their Virtual registers to Physical Registers. FIG. 27 shows how Instruction 3 is mapped. Virtual registers VR3 and VR2 are source registers that are currently mapped to PR3 and PR2 respectively while the destination VR4 is mapped to a new Physical Register PR18 and its old destination PR3 is referenced by Instruction 3's Old Destination field in the mapped instruction. FIG. 28 shows how Instruction 4 is mapped. Virtual registers VR4 and VR3 are source registers that are currently mapped to PR16 and PR18 respectively while the destination VR3 is mapped to a new Physical Register PR19 and its old destination PR18 is referenced by Instruction 4's Old Destination field in the mapped instruction. FIG. 29 summarizes the state of the Physical Registers at the end of Clock 3. Note the status of PR18 and PR19.

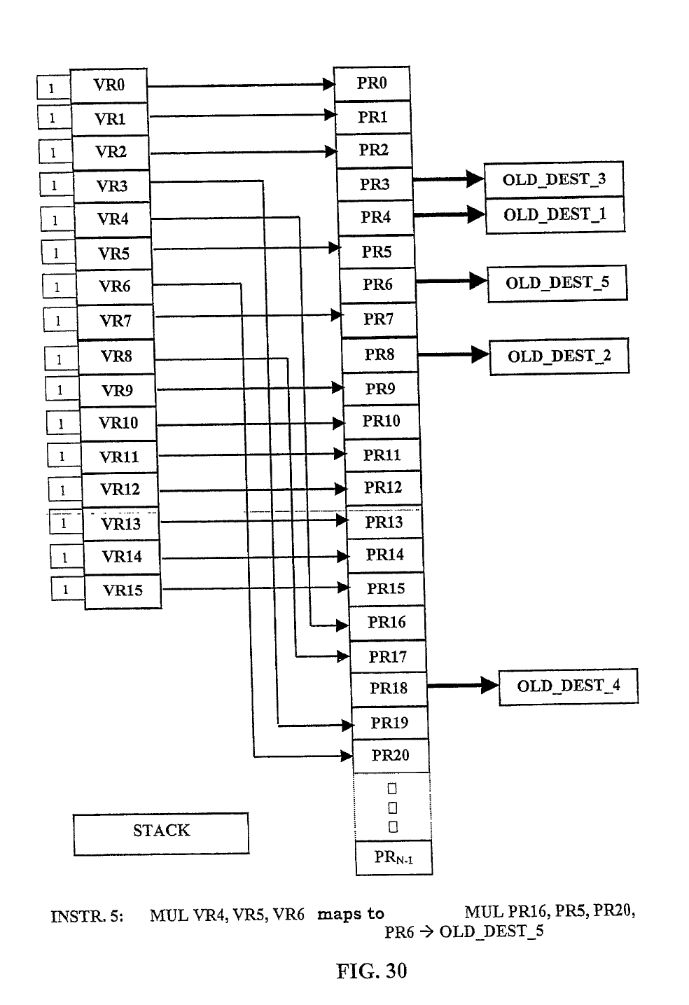

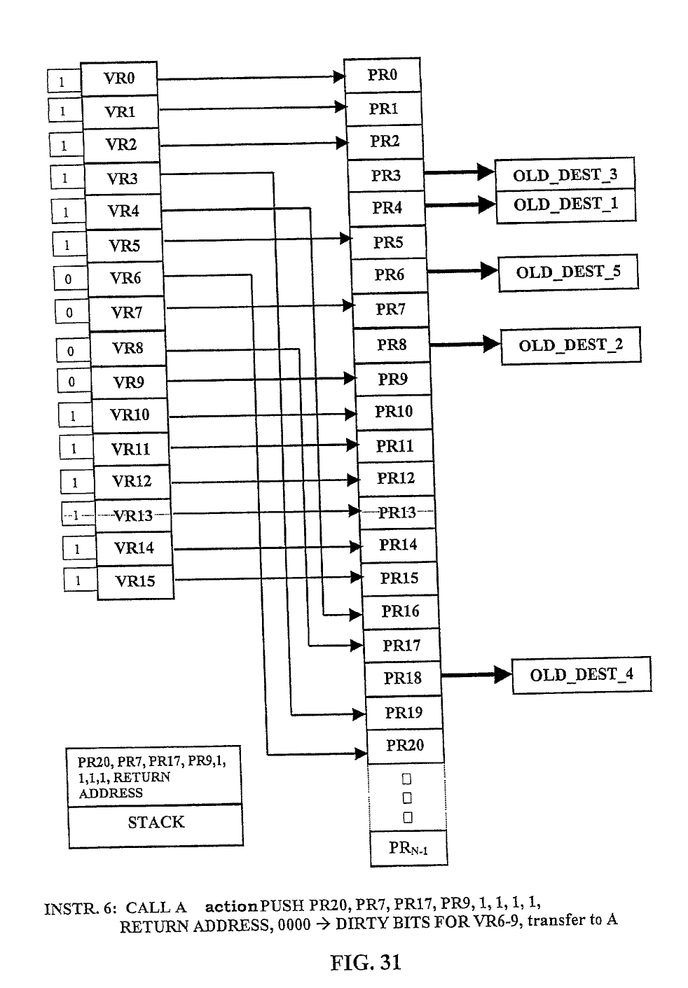

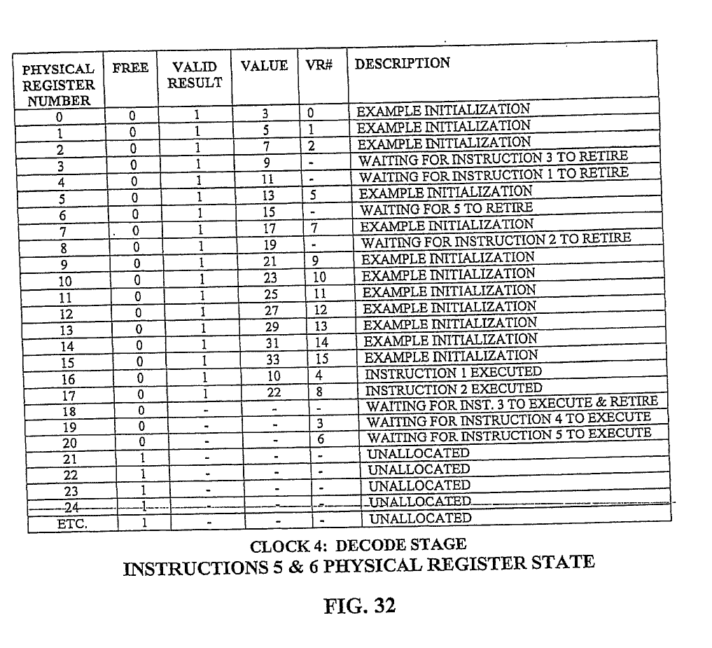

Clock 4 performs pre-execution processing steps 507, 508, 510, 512, 514, 516, 518, 532, 536, 704, 708 on Instructions 5 and 6 and maps their Virtual registers to Physical Registers. FIG. 30 shows how Instruction 5 is mapped. Virtual registers VR4 and VR5 are source registers that are currently mapped to PR16 and PR5 respectively while the destination VR6 is mapped to a new Physical Register PR20 and its old destination PR6 is referenced by Instruction 5's Old Destination field in the mapped instruction. FIG. 31 shows how Instruction 6 is acted upon. This Call instruction is executed in the decode stage by pushing the Physical Register mappings PR20, PR7, PR17, and PR9 for the virtual local registers, which are virtual registers 6-9 respectively, together with their Dirty status Bits and the Return Address of the next sequential instruction onto the stack cache 350 (step 1002). The action is completed by clearing the Dirty status Bits for Virtual registers 6-9 (step 1006) and transferring control to the instruction addressed by the symbolic reference ‘A’. FIG. 31 shows the new entry on the stack cache 350. FIG. 32 summarizes the state of the Physical Registers at the end of Clock 4. Note the status of PR20. Instruction 6's actions are not reflected in FIG. 32 because this figure does not describe either the stack or the Dirty status Bits. Also note that Instructions 1 and 2 have executed in this clock and their results were stored in PR16 and PR17.

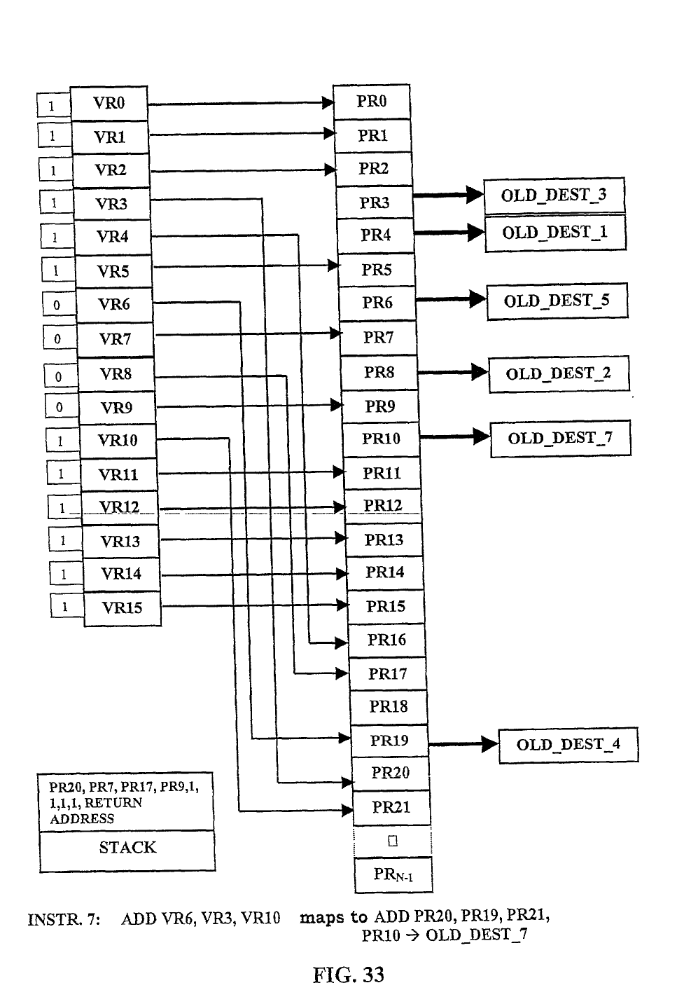

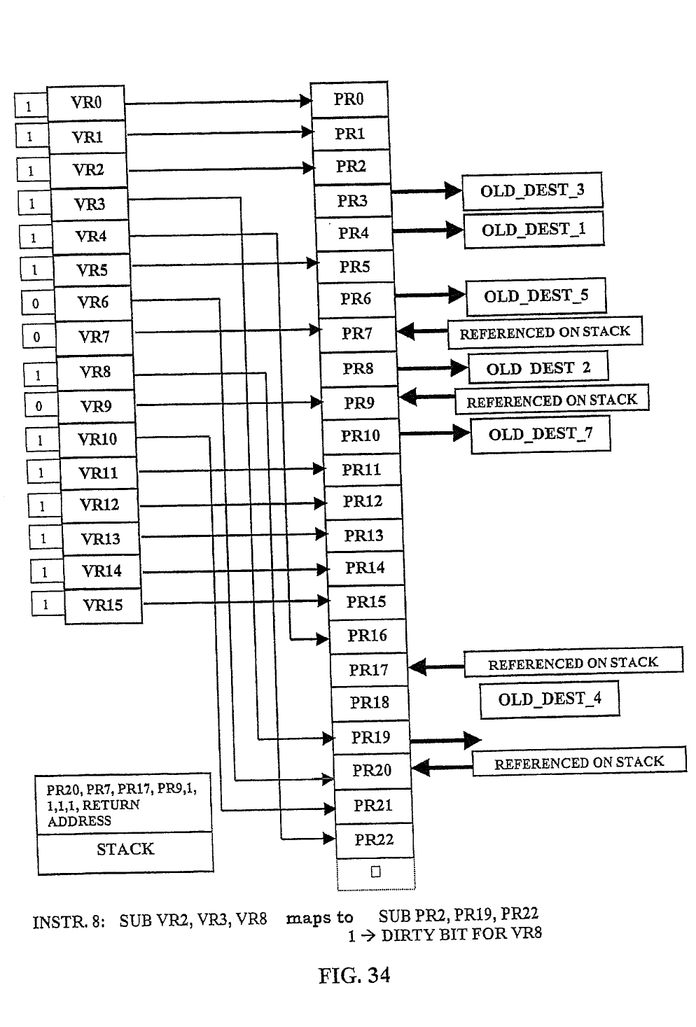

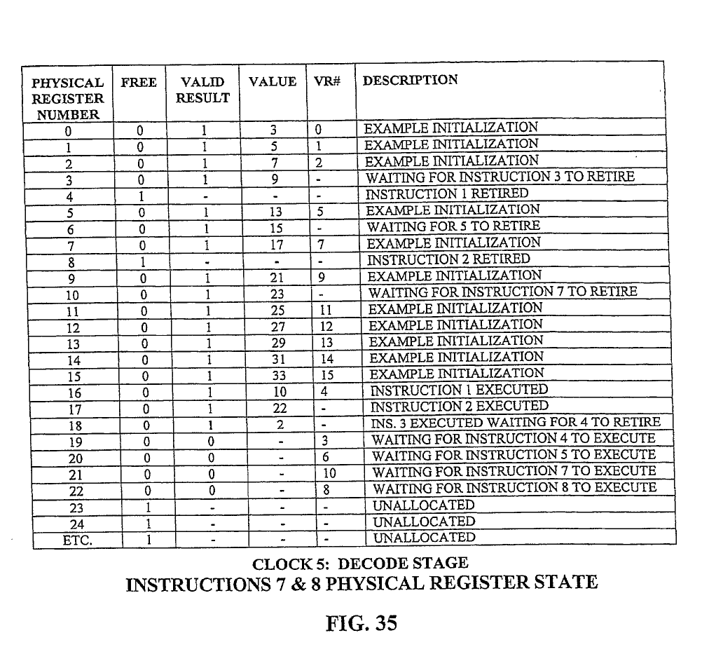

Clock 5 performs pre-execution processing steps 507, 508, 510, 512, 514, 516, 518, 532, 536, 704, 708 on Instructions 7 and 8 and maps their Virtual registers to Physical Registers. FIG. 33 shows how Instruction 7 is mapped. Virtual registers VR6 and VR3 are source registers that are currently mapped to PR20 and PR19 respectively while the destination VR10 is mapped to a new Physical Register PR21 and its old destination PR10 is referenced by Instruction 7's Old Destination field in the mapped instruction. FIG. 34 shows how Instruction 8 is mapped. Virtual registers VR2 and VR3 are source registers that are currently mapped to PR2 and PR19 respectively while the destination VR8 is mapped to a new Physical Register PR22 and the Dirty Bit of VR8 is set. The old destination PR17 for VR8 is not referenced by Instruction 8's Old Destination field in the mapped instruction because VR8's Dirty Bit was previously clear. PR17 is, however, referenced by the stack entry made for Instruction 6. FIG. 35 summarizes the state of the Physical Registers at the end of Clock 5. Note the status of PR21 and PR22. Also note that Instructions 1 and 2 have retired and the state of PR4 and PR8 have been changed to Free.

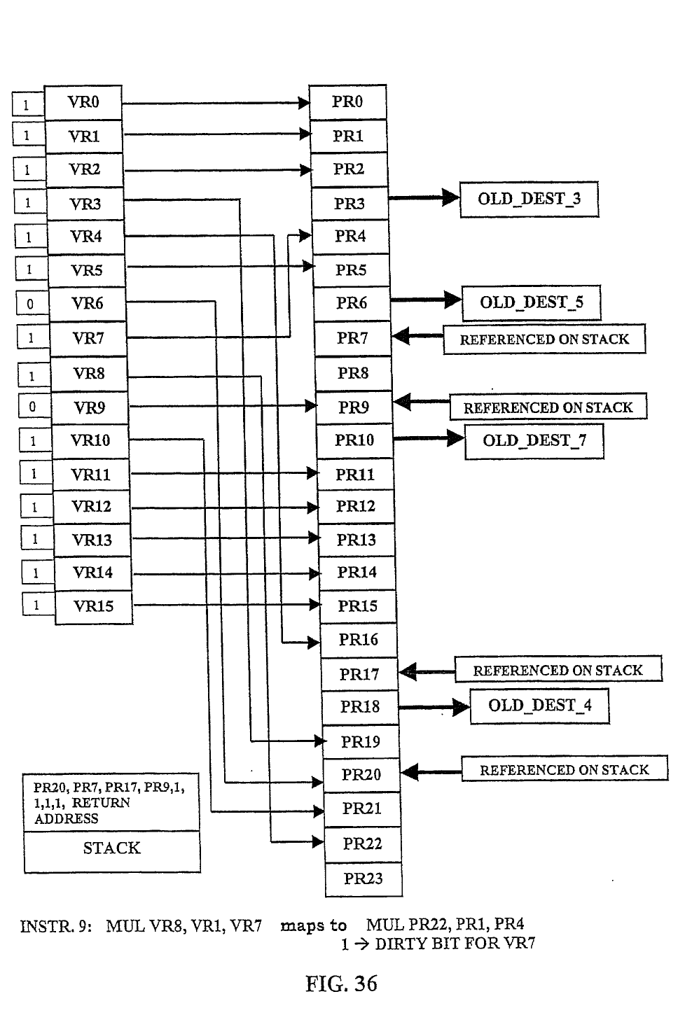

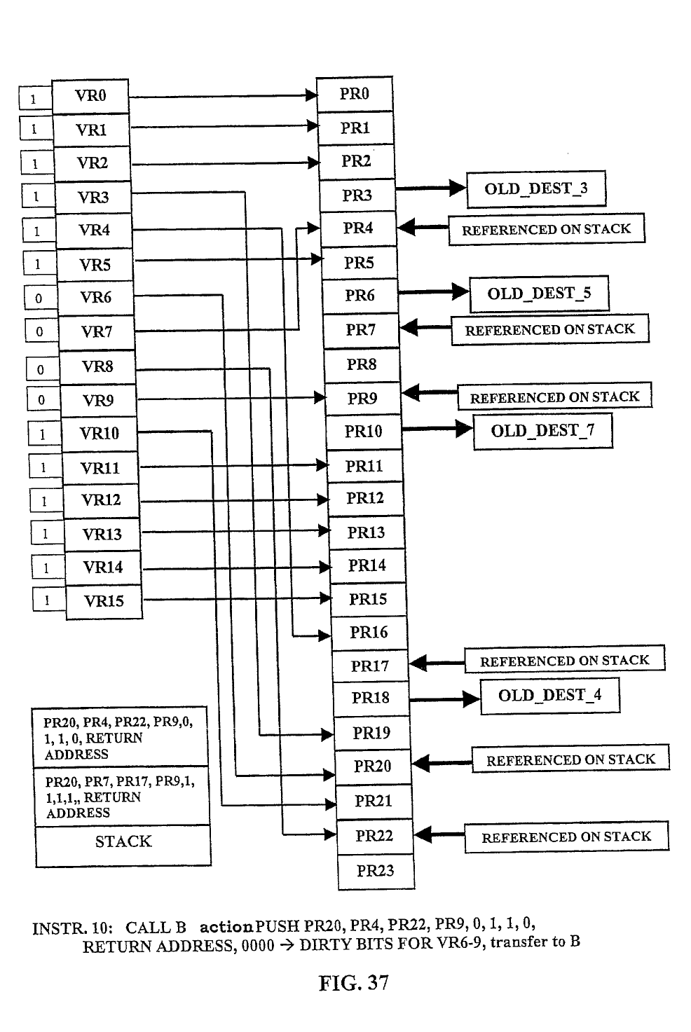

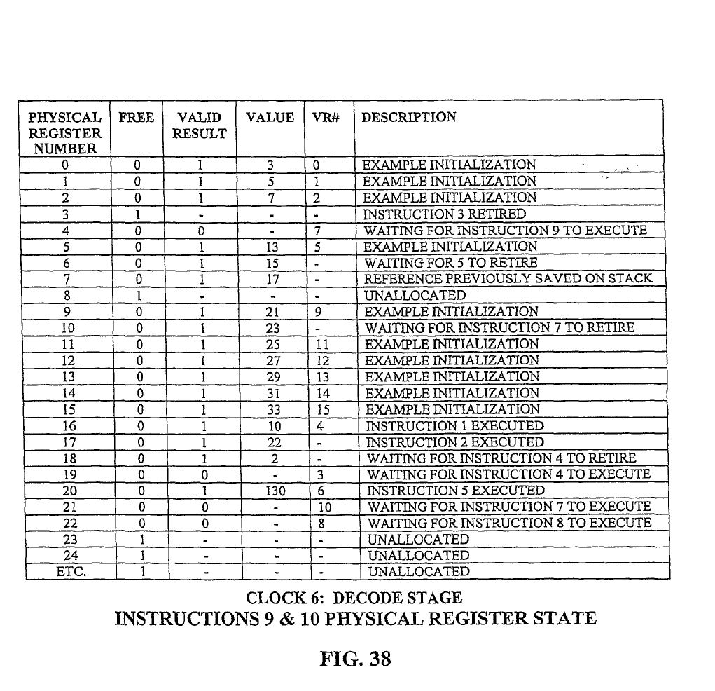

Clock 6 performs pre-execution processing steps 507, 508, 510, 512, 514, 516, 518, 532, 536, 704, 708 on Instructions 9 and 10 and maps their Virtual registers to Physical Registers. FIG. 36 shows how Instruction 9 is mapped. Virtual registers VR8 and VR1 are source registers that are currently mapped to PR19 and PR1 respectively while the destination VR7 is mapped to a new Physical Register PR4 and the Dirty Bit of VR7 is set. The old destination PR7 for VR7 is not referenced by Instruction 9's Old Destination field in the mapped instruction because VR9's Dirty Bit was previously clear (step 516). PR7 is, however, referenced by the stack entry made for Instruction 6. FIG. 37 shows how Instruction 10 is acted upon. This Call instruction is executed in the decode stage by pushing the Physical Register mappings PR20, PR4, PR22, and PR9 for the virtual local registers, which are virtual registers 6-9 respectively, together with their Dirty status Bits and the Return Address of the next sequential instruction onto the previously mentioned stack. The action is completed by clearing the Dirty status Bits for Virtual registers 6-9 and transferring control to the instruction addressed by the symbolic reference ‘B’. FIG. 37 shows the new entry on the stack. FIG. 38 summarizes the state of the Physical Registers at the end of Clock 6. Note the status of PR4. Instruction 10's actions are not reflected in FIG. 38 because the figure does not describe either the stack or the Dirty status Bits. Also note that Instruction 5 has executed and restored its result in PR20 and Instruction 3 has retired and the state of PR3 has changed to Free.

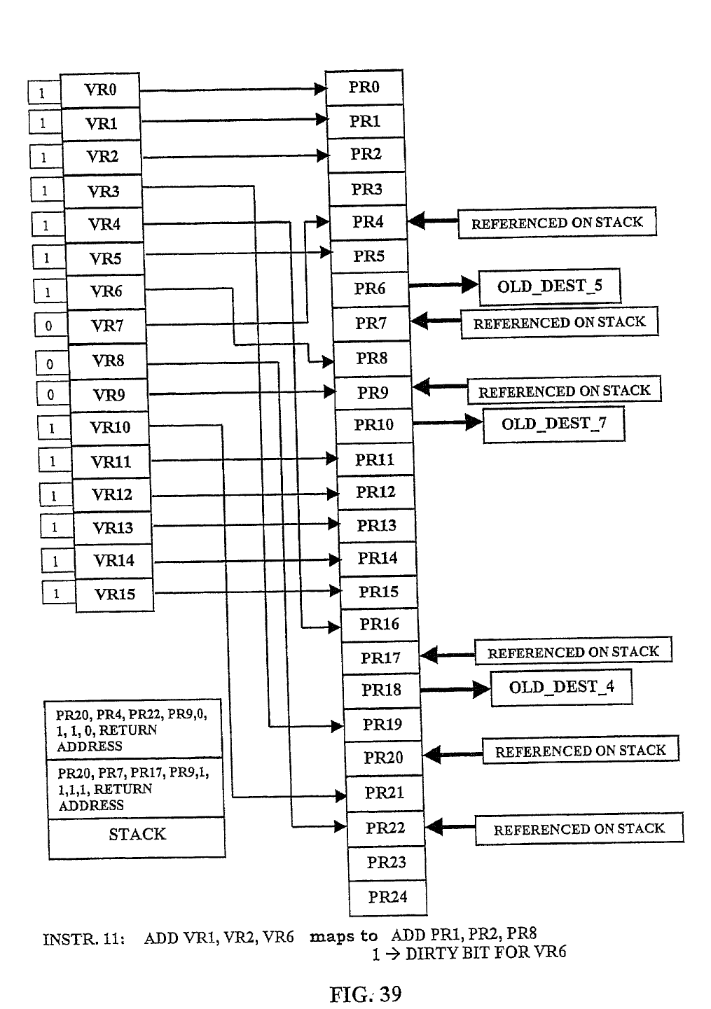

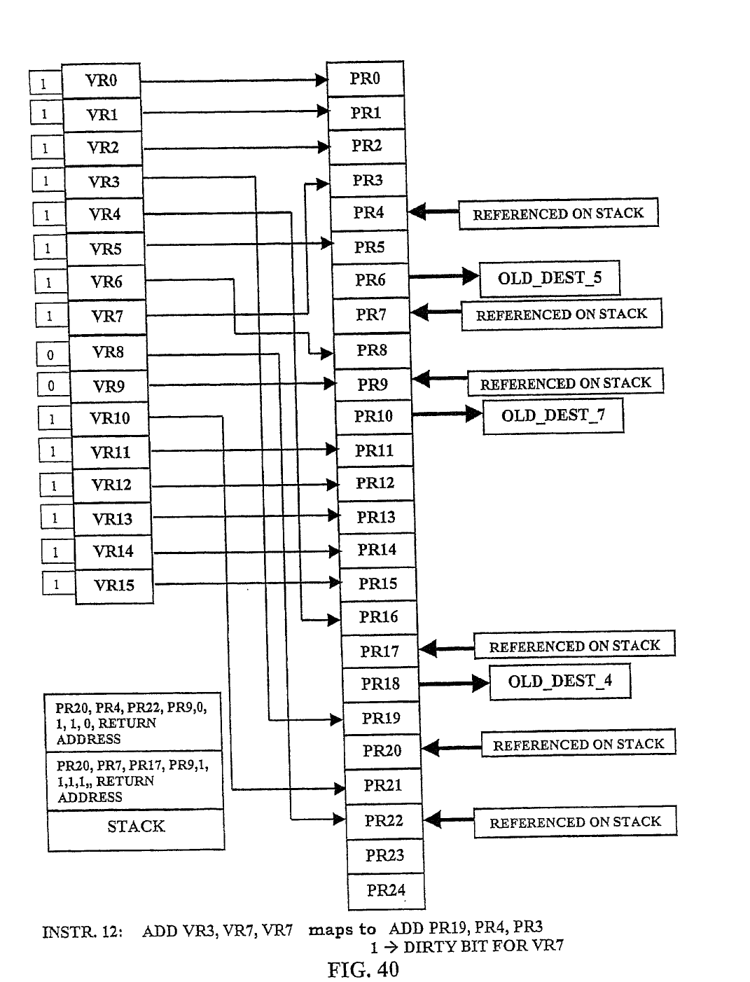

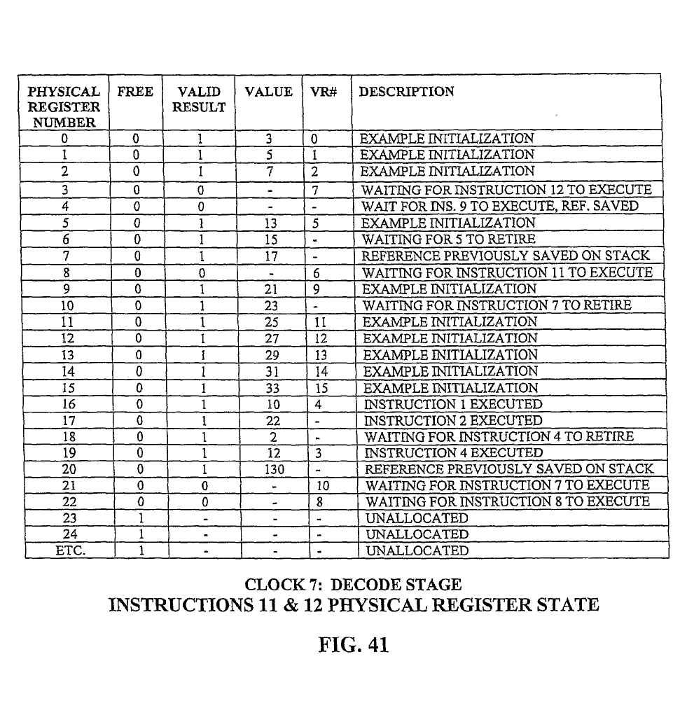

Clock 7 performs pre-execution processing steps 507, 508, 510, 512, 514, 516, 518, 532, 536, 704, 708 on Instructions 11 and 12 and maps their Virtual registers to Physical Registers. FIG. 39 shows how Instruction 11 is mapped. Virtual registers VR1 and VR2 are source registers that are currently mapped to PR1 and PR2 respectively while the destination VR6 is mapped to a new Physical Register PR8 and the Dirty Bit of VR6 is set. The old destination PR20 for VR6 is not referenced by Instruction 11's Old Destination field in the mapped instruction because VR6's Dirty Bit was previously clear. PR20 is, however, referenced by the stack entry made for Instruction 10. FIG. 40 shows how Instruction 12 is mapped. Virtual registers VR3 and VR7 are source registers that are currently mapped to PR19 and PR4 respectively while the destination VR7 is mapped to a new Physical Register PR3 and the Dirty Bit of VR7 is set. The old destination PR4 for VR7 is not referenced by Instruction 12's Old Destination field in the mapped instruction because VR7's Dirty Bit was previously clear. PR4 is, however, referenced by the stack entry made for Instruction 10. FIG. 41 summarizes the state of the Physical Registers at the end of Clock 7. Note the status of PR8 and PR3. Also note that Instruction 4 has executed and stored its result in PR19.

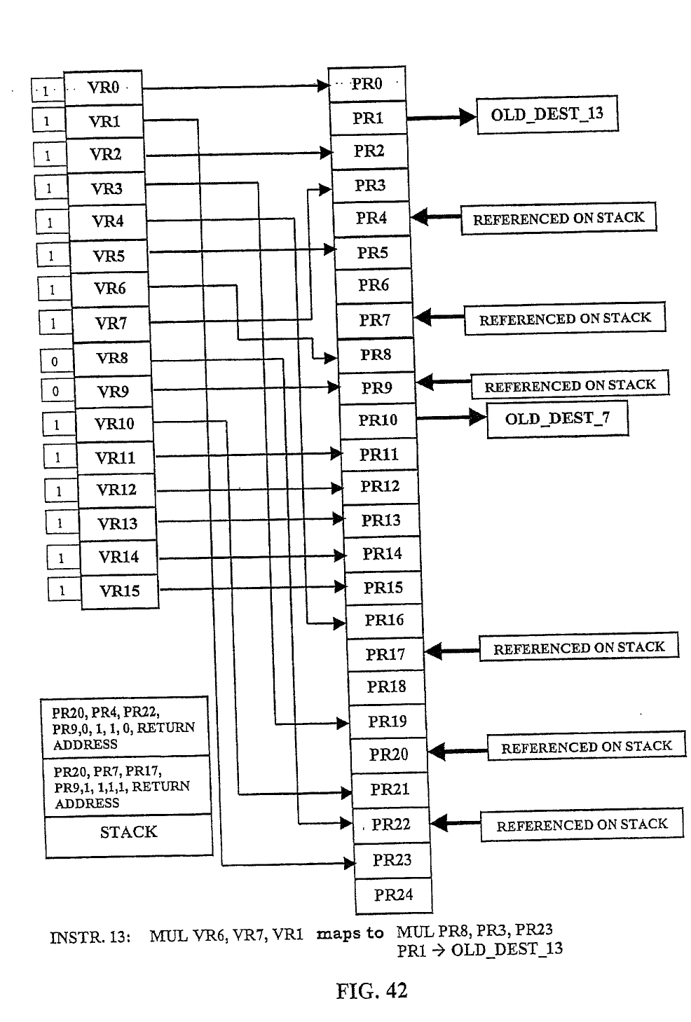

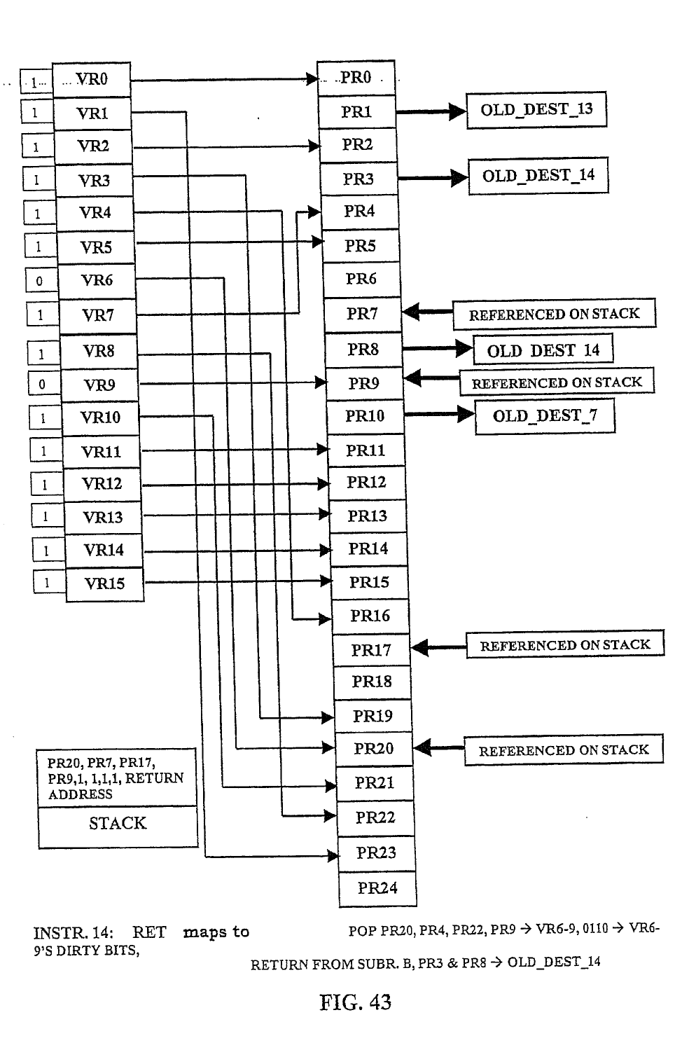

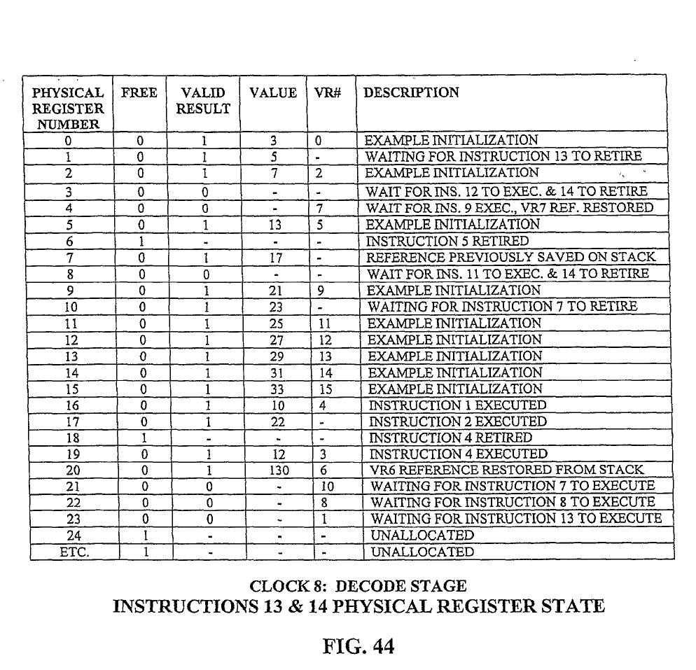

Clock 8 performs pre-execution processing steps 507, 508, 510, 512, 514, 516, 518, 532, 536, 704, 708 on Instructions 13 and 14 and maps their Virtual registers to Physical Registers. FIG. 42 shows how Instruction 13 is mapped. Virtual registers VR6 and VR7 are source registers that are currently mapped to PR8 and PR3 respectively while the destination VR1 is mapped to a new Physical Register PR23 and its old destination PR1 is referenced by Instruction 13's Old Destination field in the mapped instruction. FIG. 43 shows how Instruction 14 is acted upon. This Return instruction is executed in the decode stage by popping the Physical Register mappings PR20, PR4, PR22, and PR9 into Virtual registers 6-9 respectively together with their Dirty status Bits (step 1124). Control is then transferred to the instruction addressed by the Return address from the stack. The action is completed by making old destinations PR8 and PR3 referenced by Instruction 14's Old Destination field because the Dirty status Bits for VR6 and VR7 were set which indicated that their mappings had been changed since the Call to the subroutine was made in Instruction 10. FIG. 43 shows the popped state of the stack. FIG. 44 summarizes the state of the Physical Registers at the end of Clock 8. Note the status of PR23, PR8, PR3, PR20, and PR4. Also note that Instructions 4, 5, and 6 have retired and that the state of PR18 and PR6 have been changed to Free.

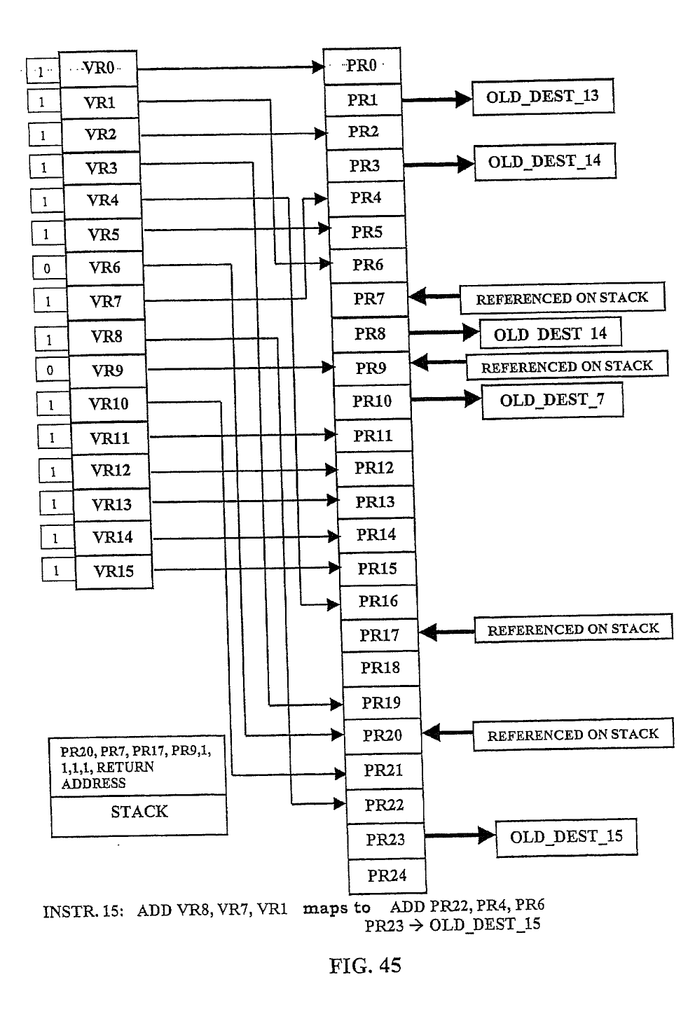

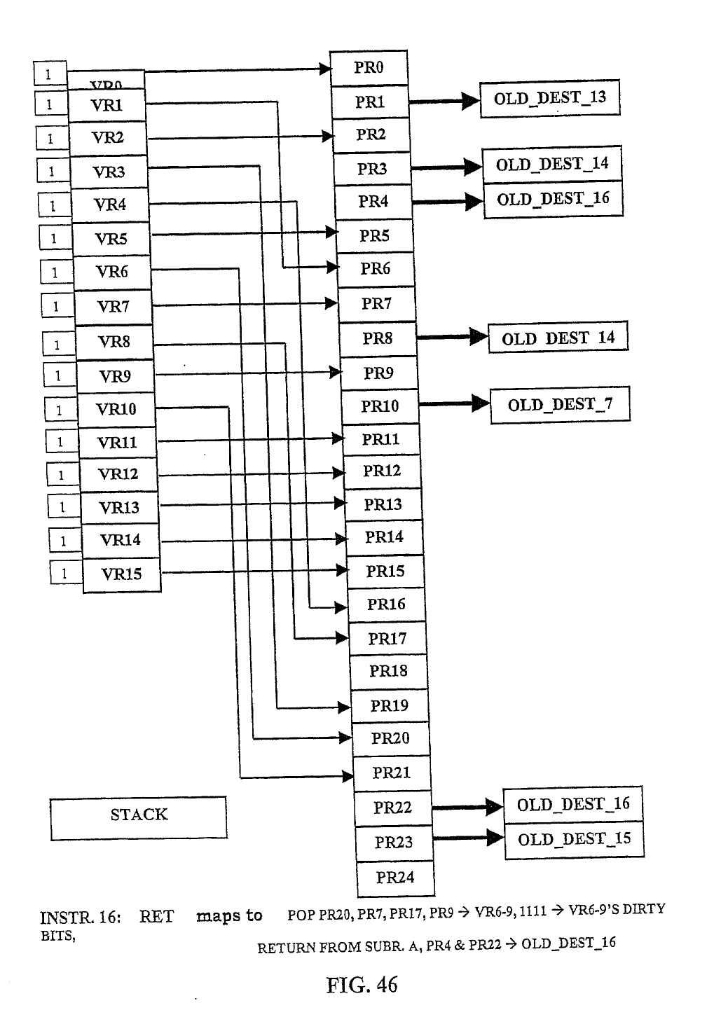

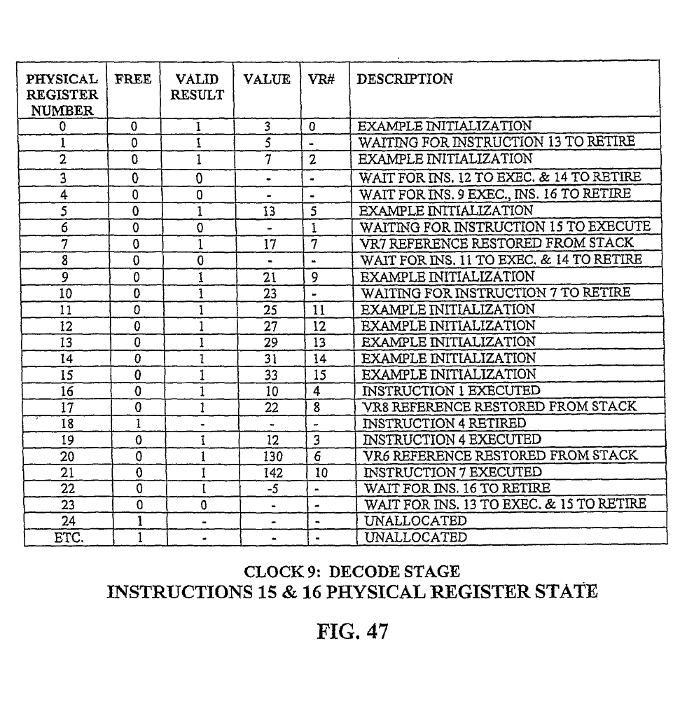

Clock 9 performs pre-execution processing steps 507, 508, 510, 512, 514, 516, 518, 532, 536, 704, 708 on Instructions 15 and 16 and maps their Virtual registers to Physical Registers. FIG. 45 shows how Instruction 15 is mapped. Virtual registers VR8 and VR7 are source registers that are currently mapped to PR22 and PR4 respectively while the destination VR1 is mapped to a new Physical Register PR6 and its old destination PR23 is referenced by Instruction 15's Old Destination field in the mapped instruction. Note that VR7's mapping to PR4 is to the mapping that existed before the Call to subroutine ‘B’ was executed in Instruction 10. FIG. 46 shows how Instruction 16 is acted upon. This Return instruction is executed in the decode stage by popping the Physical Register mappings PR20, PR7, PR17, and PR9 into Virtual registers 6-9 respectively together with their Dirty status Bits. Control is then transferred to the instruction addressed by the Return address from the stack. The action is completed by making old destinations PR4 and PR22 referenced by Instruction 16's Old Destination field because the Dirty status Bits for VR7 and VR8 were set which indicated that their mappings had been changed since the Call to the subroutine was made in Instruction 6. FIG. 46 shows the popped state of the stack. FIG. 47 summarizes the state of the Physical Registers at the end of Clock 9. Note the status of PR6, PR4, PR22, PR7, and PR17. Also note that Instructions 7 and 8 have executed and stored their results in PR21 and PR22.

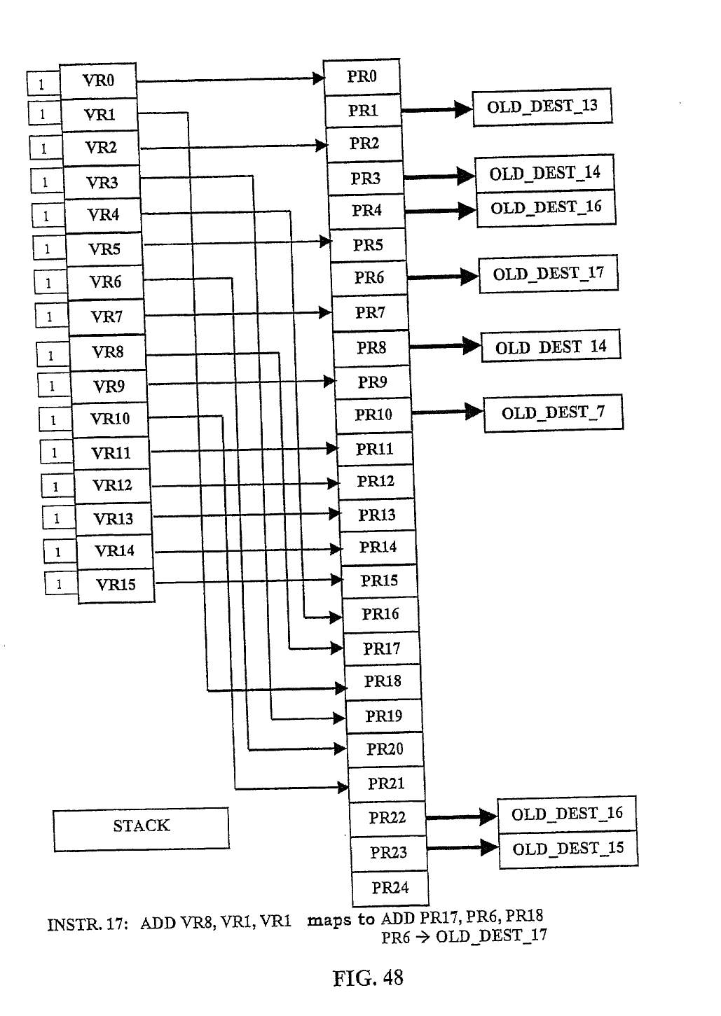

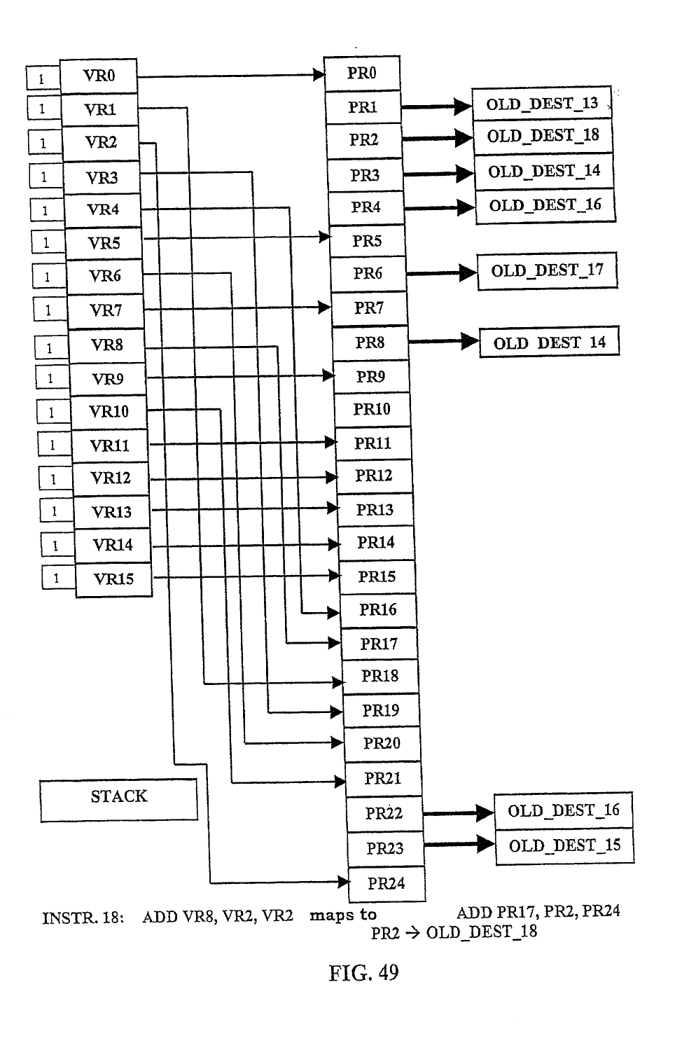

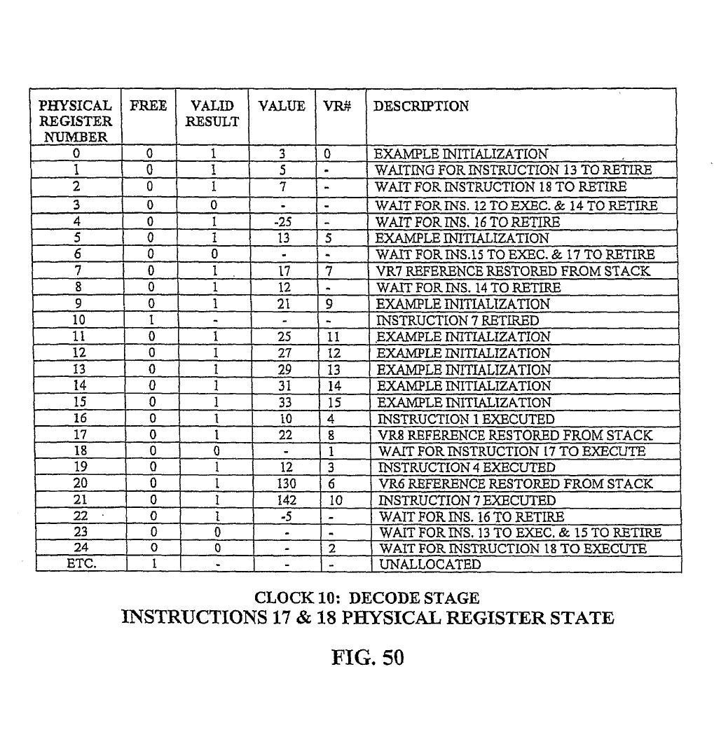

Clock 10 performs pre-execution processing steps 507, 508, 510, 512, 514, 516, 518, 532, 536, 704, 708 on Instructions 17 and 18 and maps their Virtual registers to Physical Registers. FIG. 48 shows how Instruction 17 is mapped. Virtual registers VR8 and VR1 are source registers that are currently mapped to PR17 and PR6 respectively while the destination VR1 is mapped to a new Physical Register PR18 and its old destination PR6 is referenced by Instruction 17's Old Destination field in the mapped instruction. FIG. 49 shows how Instruction 18 is mapped. Virtual registers VR8 and VR2 are source registers that are currently mapped to PR17 and PR2 respectively while the destination VR2 is mapped to a new Physical Register PR24 and its old destination PR2 is referenced by Instruction 18's Old Destination field in the mapped instruction. FIG. 50 summarizes the state of the Physical Registers at the end of Clock 10. Note the status of PR18 and PR24. Also note that Instructions 9 and 11 have executed and stored their results in PR4 and PR8.

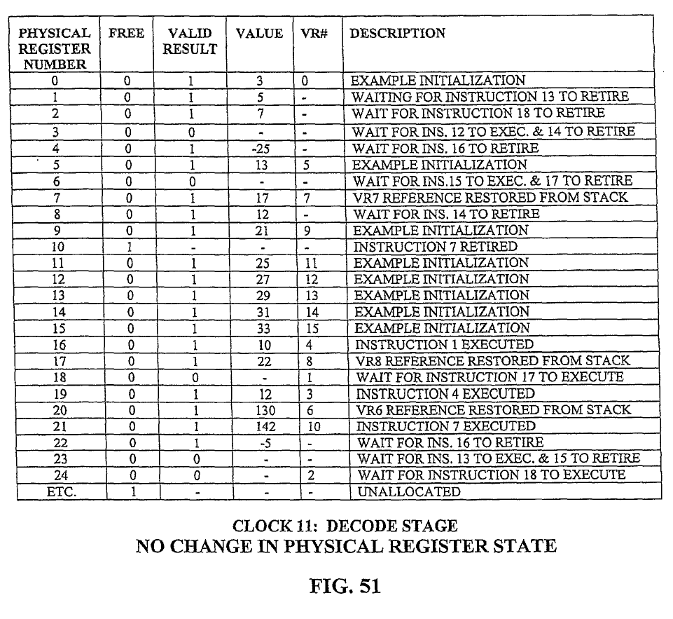

Clock 11 has no further instructions to decode in this example. FIG. 51 shows that there is no change in the physical register state at the end of this clock even though Instructions 9, 10, and 11 have retired.

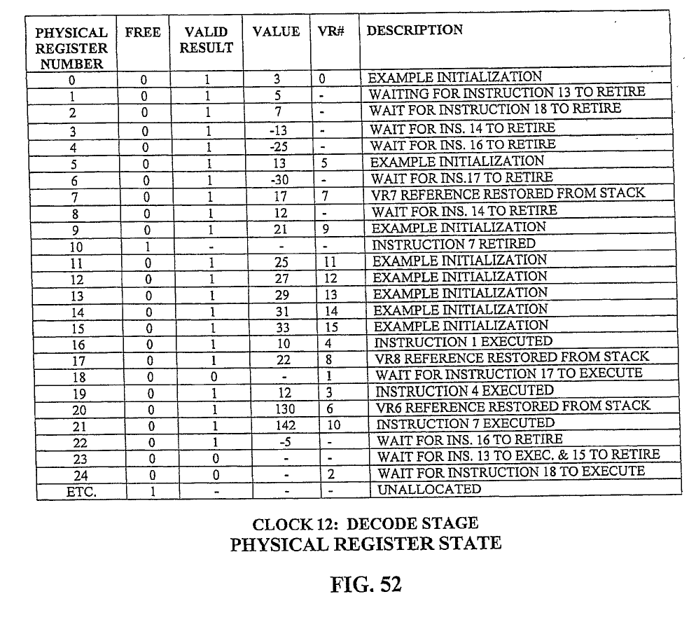

Clock 12 has changes in the physical register state as shown in FIG. 52. Note that Instructions 12 and 15 have executed and stored their results in PR3 and PR6.

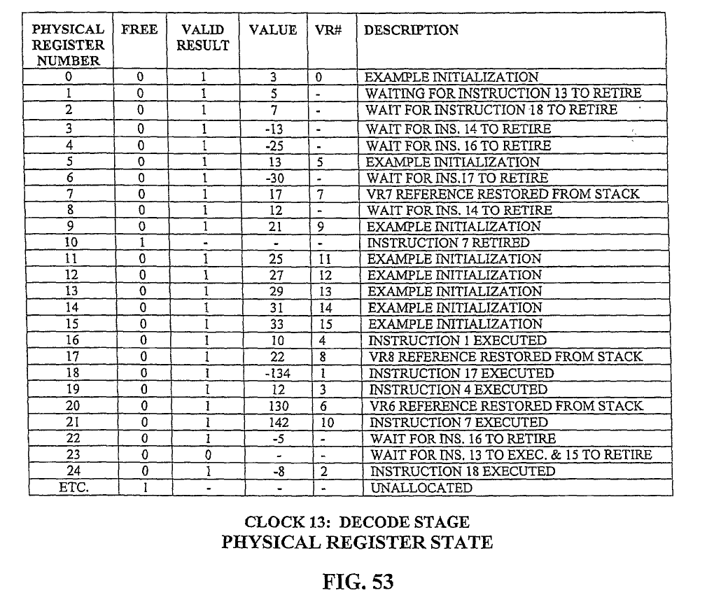

Clock 13 has changes in the physical register state as shown in FIG. 53. Note that Instructions 17 and 18 have executed and stored their results in PR18 and PR24. Also note that Instruction 12 has retired.

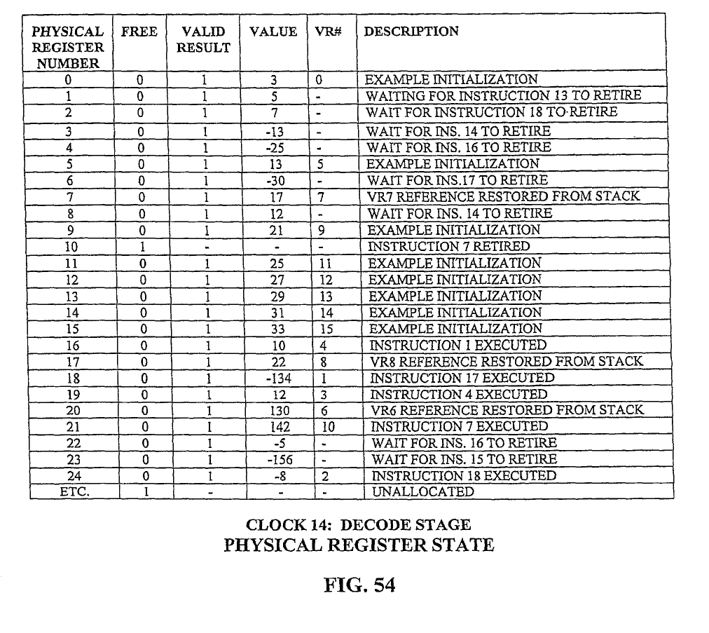

Clock 14 has changes in the physical register state as shown in FIG. 54. Note that Instruction 13 has executed and stored its result in PR23.

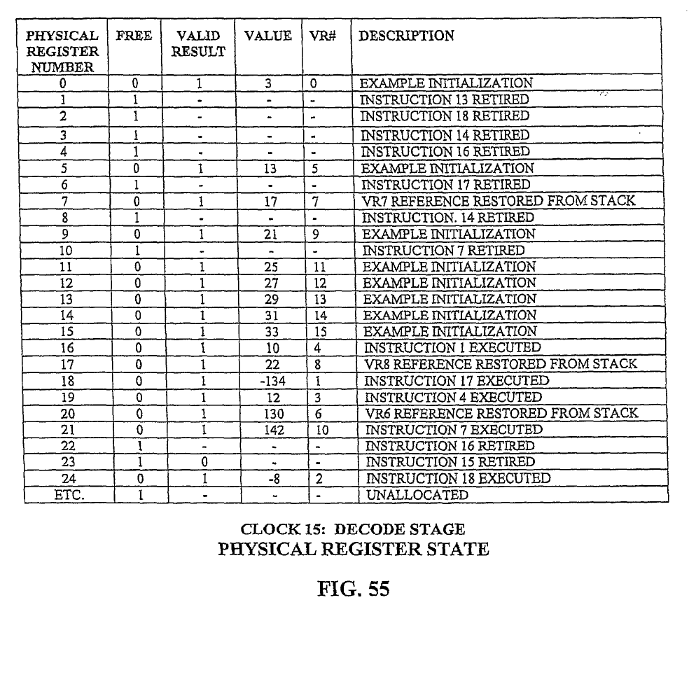

Clock 15 has changes in the physical register state as shown in FIG. 55. Note that Instructions 13, 14, 15, 16, 17, and 18 have retired and that the state of PR3, PR8, PR23, PR4, PR22, PR6, and PR2 have been changed to Free. So all the instruction have now been completed.

### Example 2

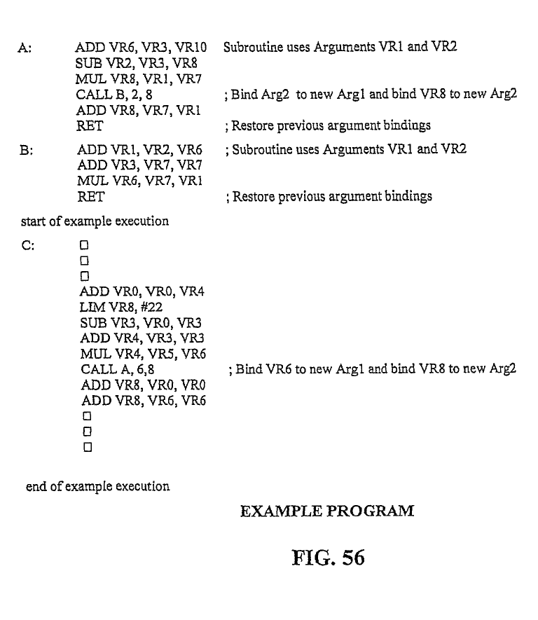

FIG. 56 shows a program of 18 instructions that will be used in the example. Note that the 18 instructions in this example differ slightly from those instructions in the example described by FIG. 18.

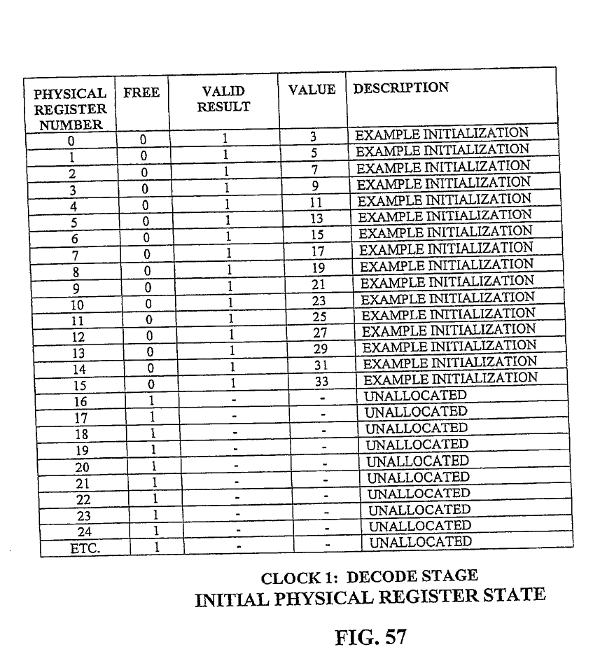

There are two subroutines (A and B) labeled in the instructions and a section of instructions where fetching is to begin. In this example the instruction set architecture implemented by a system has specified local registers (VR6-VR9) for use by subroutines and two formal parameters (VR1 and VR2) for the use of subroutines. FIG. 57 shows the Initial Physical Register State in the Decode Stage at the first clock. The example processor has 16 virtual registers that are initially mapped to the first 16 physical registers. FIG. 57 shows the physical register numbers, whether the physical registers are mapped or free, whether the mapped physical register has a valid result or not, and the value of the result. For this example the virtual registers 0 through 15 have been mapped to physical registers 0 through 15 and initialized with odd values beginning with 3 through 33.

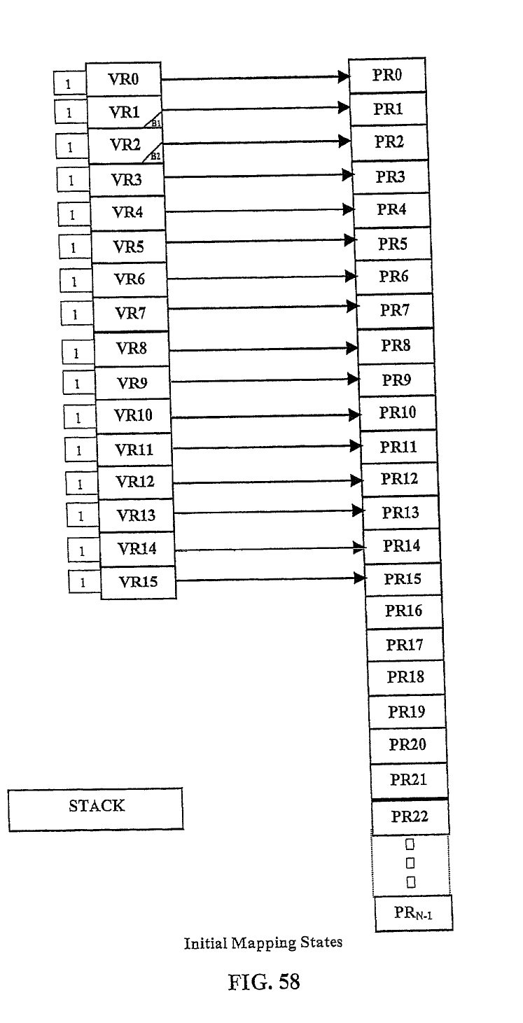

FIG. 58 is a drawing represents the 16 virtual registers VR0 through VR15 with arrows showing how they initially are mapped to 16 physical registers PR0 through PR15. In addition, each virtual register has its Dirty Bit status drawn as an appendage just to the left of the virtual register. Dirty state Bits are being used in this illustration as a possible embodiment although other means can be used to determine dirty status. Note that all of the Dirty Bits for VR0 though VR15 have been initialized to ones. Virtual Registers VR6 through VR9 are the Virtual Registers that can be temporarily saved and reallocated as private temporary registers for use by a subprogram. Virtual Registers VR1 and VR2 are the subset of the Virtual Registers that can be used to bind arguments to Virtual Registers for use by subroutine instructions. VR1 and VR2 are Virtual Argument Binding Registers and are initially shown to be bound to undefined symbolic Virtual Registers “B1” and “B2”.

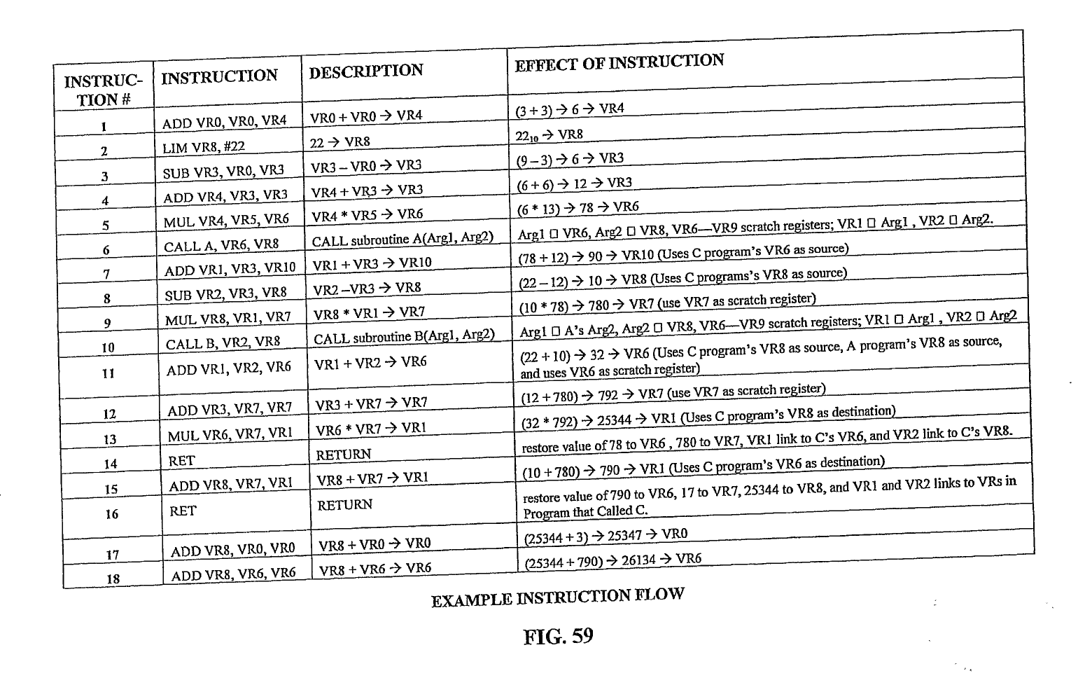

FIG. 59 describes the dynamic instruction flow of the example program as viewed by the programmer. Each of the 18 instructions to be executed is numbered in the order in which the instructions are to retire from the pipeline. A pseudo-assembly like instruction is given in the second column followed by a description of what the instruction is expected to do. The last column indicates the effect of the instruction using the values of the registers as initialized and shown in FIG. 57. Note that the effect of the instruction is described from the programmer's viewpoint in terms of Virtual Registers.

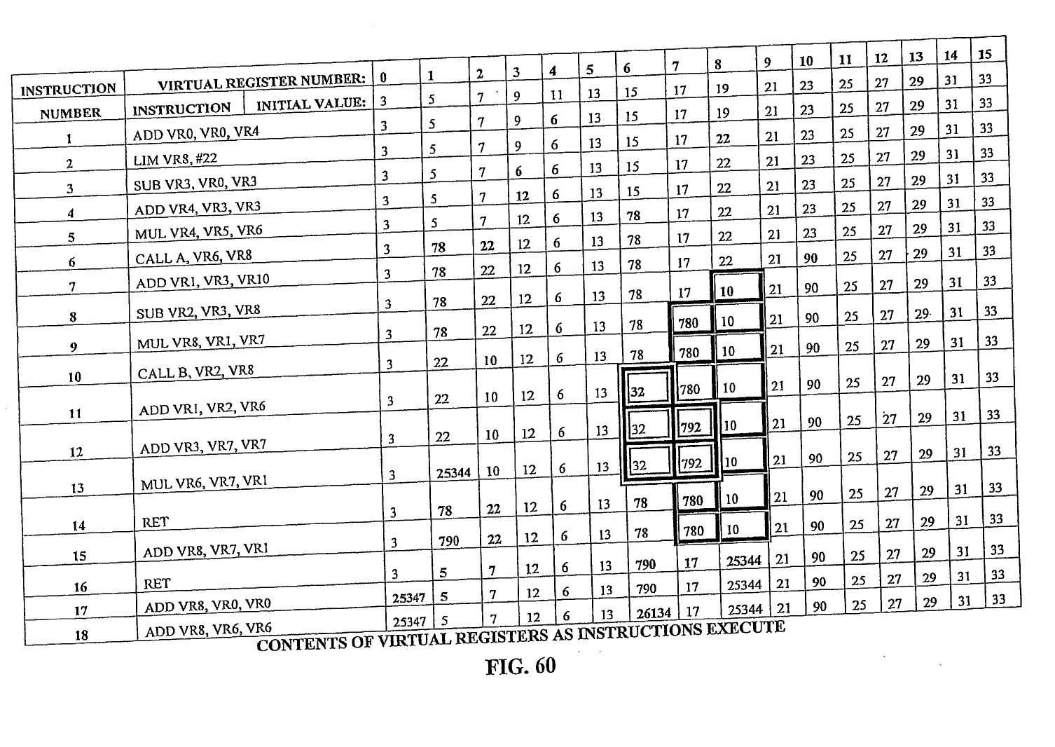

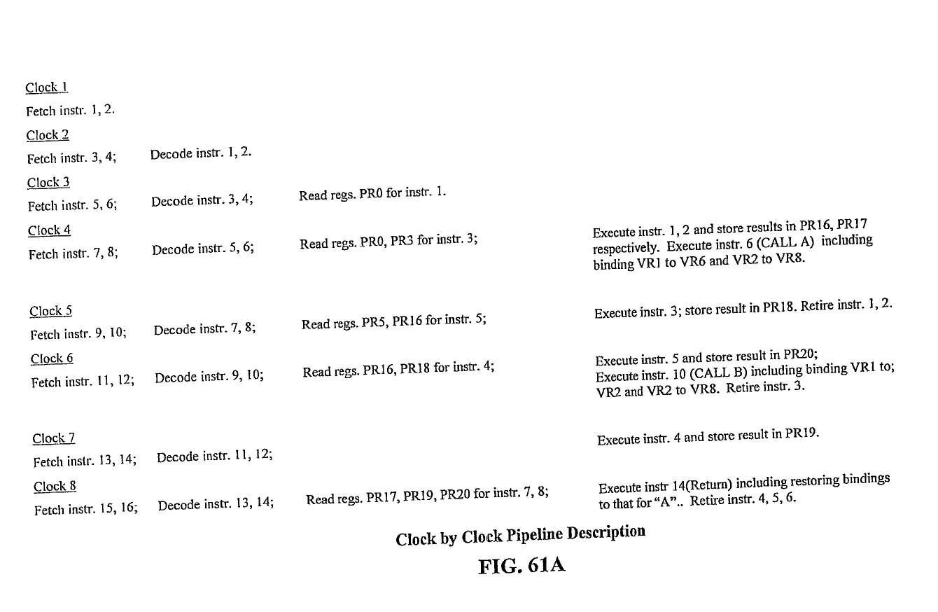

The contents of the virtual registers are shown in FIG. 60 for each instruction that is executed. Instructions 8 through 15 have the contents of VR7 and VR8 highlighted by a Bold outline showing where these 2 registers of the previously mentioned subset are being used to hold temporary computation results for subprogram A. Similarly, instructions 11 through 13 have the contents of VR6 and VR7 highlighted by a Double Bold outline showing where these 2 registers of the subset are being used to hold temporary computation results for subprogram B.

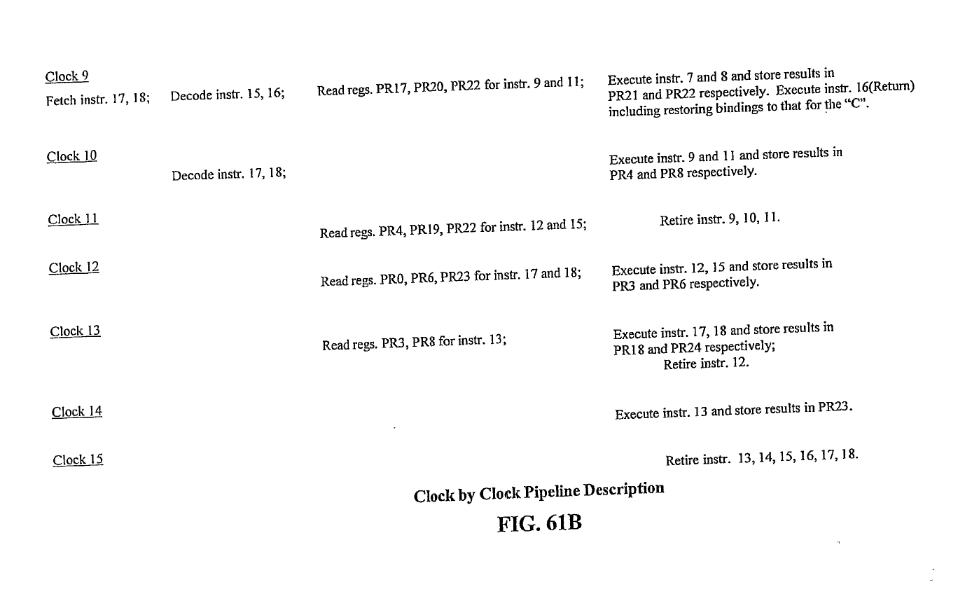

FIG. 61 is a clock by clock description of the pipeline from the Fetch of instructions 1 and 2 in Clock 1 through the Retirement of instructions 14-18 in Clock 15. The example begins with the Fetch of instructions 1 and 2 while the remainder of the pipeline is empty. Clock 2 shows the Fetching of instructions 3 and 4 while instructions 1 and 2 are decoded. It is during the decode stage that the Virtual Registers are mapped to Physical Registers. Clock 3 shows when the physical registers are read for instruction 1 with instruction 1's execution and result write back occurring in Clock 4. Clock 4 is also when instruction 2 is executed. Clock 5 is when instructions 1 and 2 retire. Note that while FIG. 61 completely describes all stages of the pipeline some of the instructions are executed in an order different from their Fetch and Decode order, yet all instructions retire in the same order as their Fetch and Decode order.

To illustrate the effect of mapping transformations on each instruct ion and specifically to illustrate the effect of transformations on subroutine Call and Return instructions, each Clock period in the example will be illustrated from the viewpoint of the Decode Stage of the pipeline.

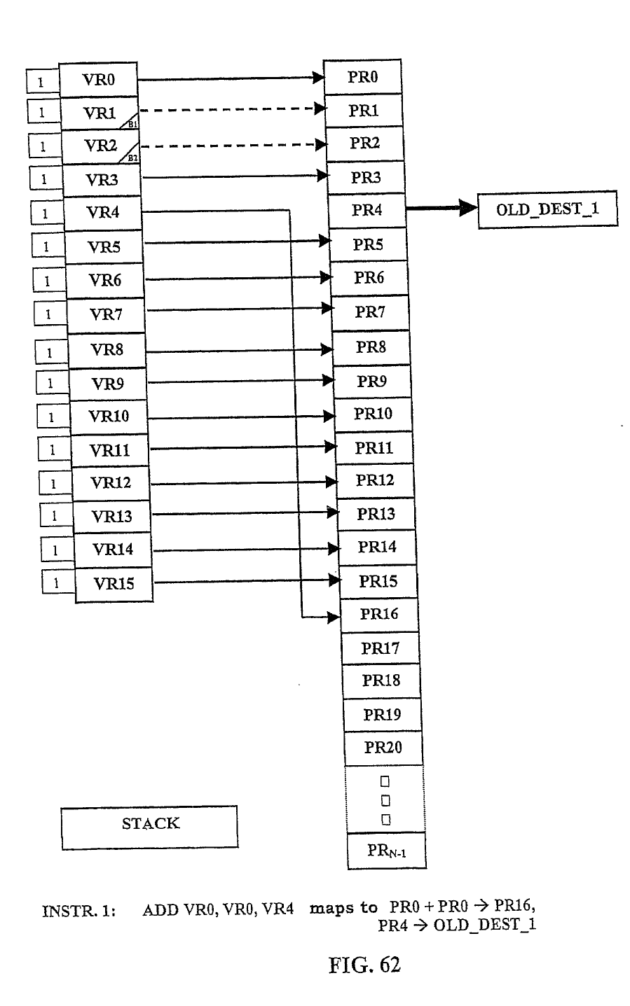

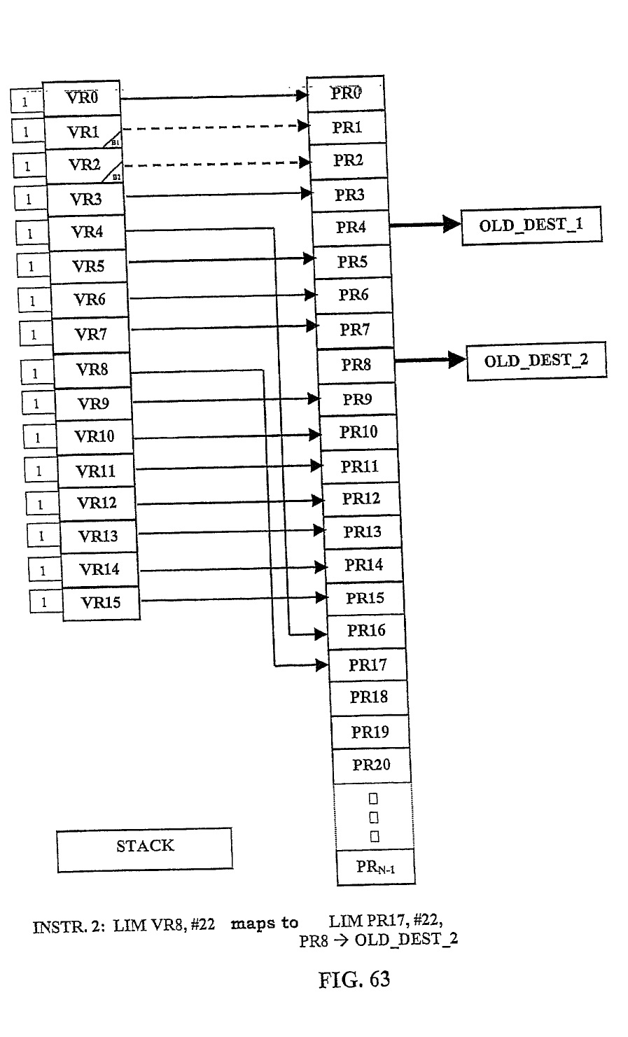

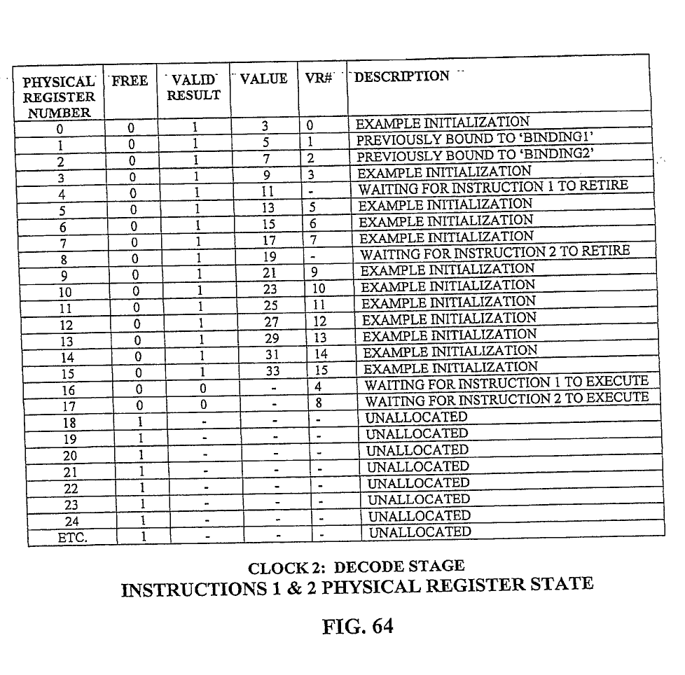

Clock 2 performs pre-execution processing steps 507, 508, 510, 512, 514, 516, 518, 532, 536, 704, 708 on Instructions 1 and 2 and maps their Virtual Registers to Physical Registers. FIG. 62 shows how Instruction 1 is mapped. Virtual Register VR0 source register is currently mapped to PR0 while VR4 is mapped to a new Physical Register PR16 and its old destination PR4 is referenced by Instruction 1's Old Destination field (Retirement List) in the mapped instruction. FIG. 63 shows how Instruction 2 is mapped. The immediate datum 22 serves as a constant source value while VR8 is mapped to a new Physical Register PR17 and its old destination PR8 is referenced by Instruction 2s Old Destination field (Retirement List) in the mapped instruction. FIG. 64 summarizes the state of the Physical Registers at the end of Clock 2. Shown in FIG. 64 are the Physical Register numbers, whether the Physical Register is free or allocated, whether the allocated Physical Register has a valid result or not, the value held in the Physical Register when it has a valid result, The Virtual Register number that is currently mapped to the Physical Register, and a simple description of the Physical Register's status. Note that when a Virtual Register has been mapped only the latest (current) mapping of the Virtual Register is shown in the figure.

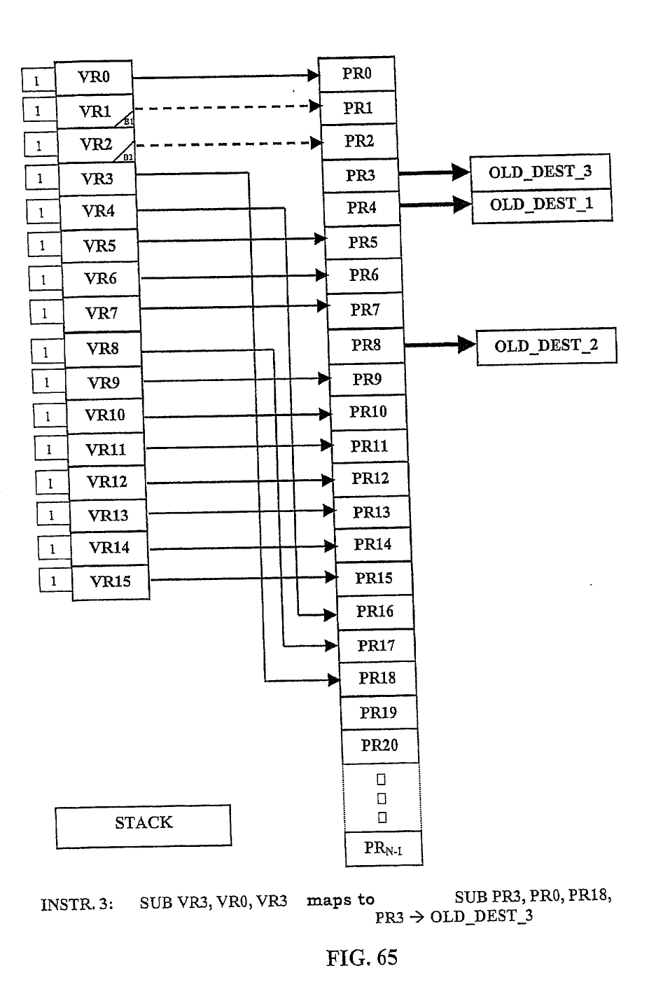

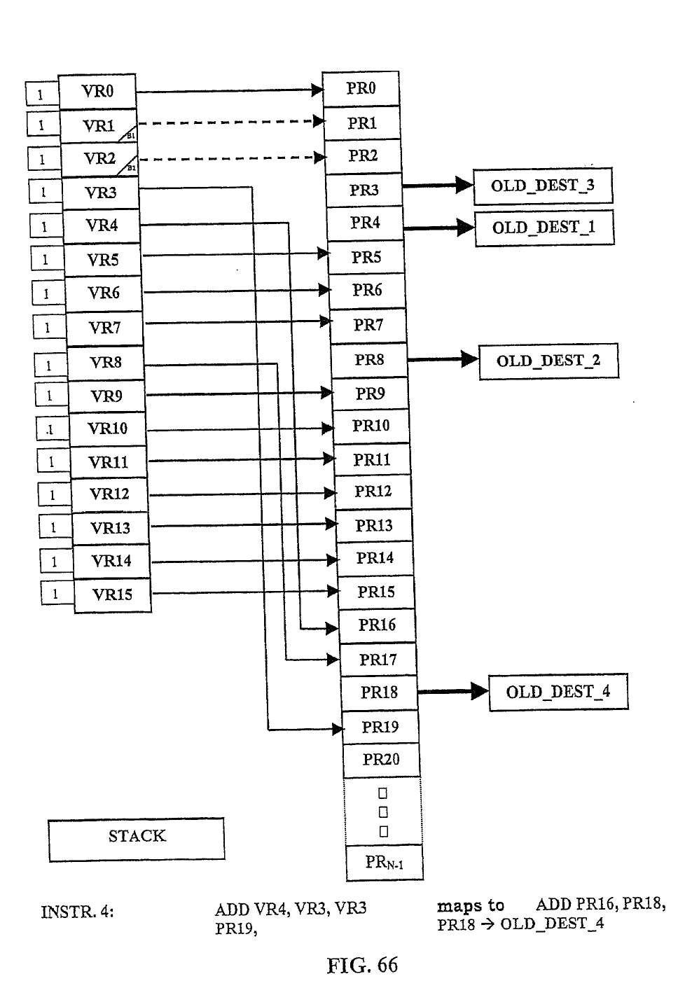

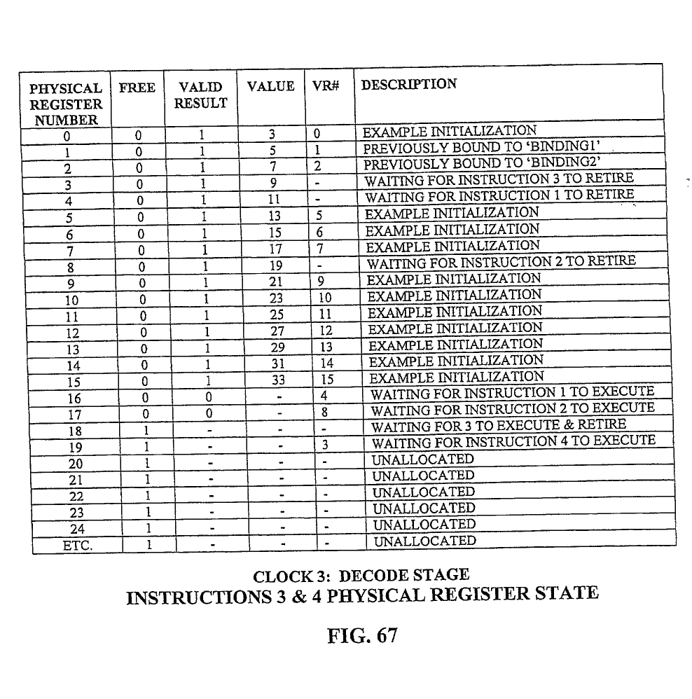

Clock 3 performs pre-execution processing steps 507, 508, 510, 512, 514, 516, 518, 532, 536, 704, 708 on Instructions 3 and 4 and maps their Virtual Registers to Physical Registers. FIG. 65 shows how Instruction 3 is mapped. Virtual registers VR3 and VR0 are source registers that are currently mapped to PR3 and PR0 respectively while the destination VR3 is mapped to a new Physical Register PR18 and its old destination PR3 is referenced by Instruction 3's Old Destination field in the mapped instruction. FIG. 66 shows how Instruction 4 is mapped. Virtual Registers VR4 and VR3 are source registers that are currently mapped to PR16 and PR18 respectively while the destination VR3 is mapped to a new Physical Register PR19 and its old destination PR18 is referenced by Instruction 4's Old Destination field in the mapped instruction. FIG. 67 summarizes the state of the Physical Registers at the end of Clock 3. Note the status of PR18 and PR19.

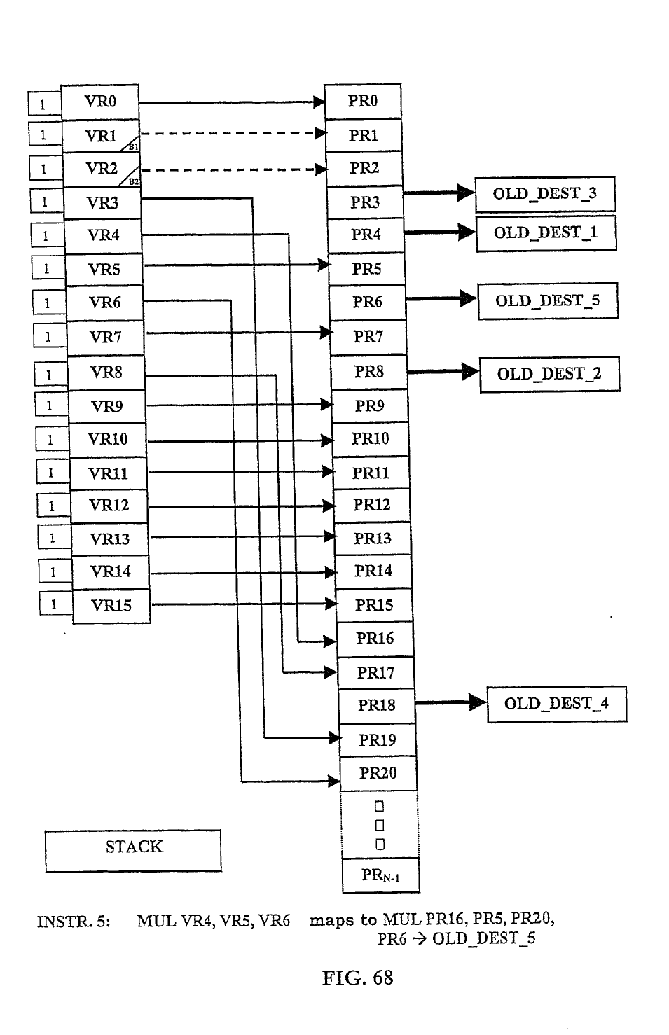

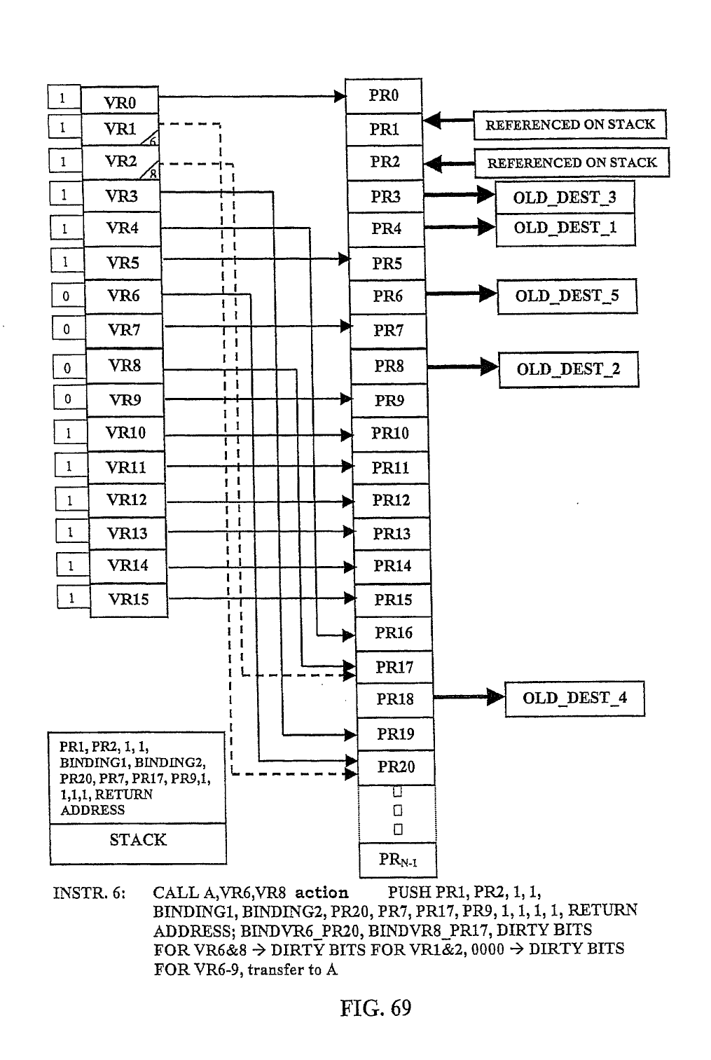

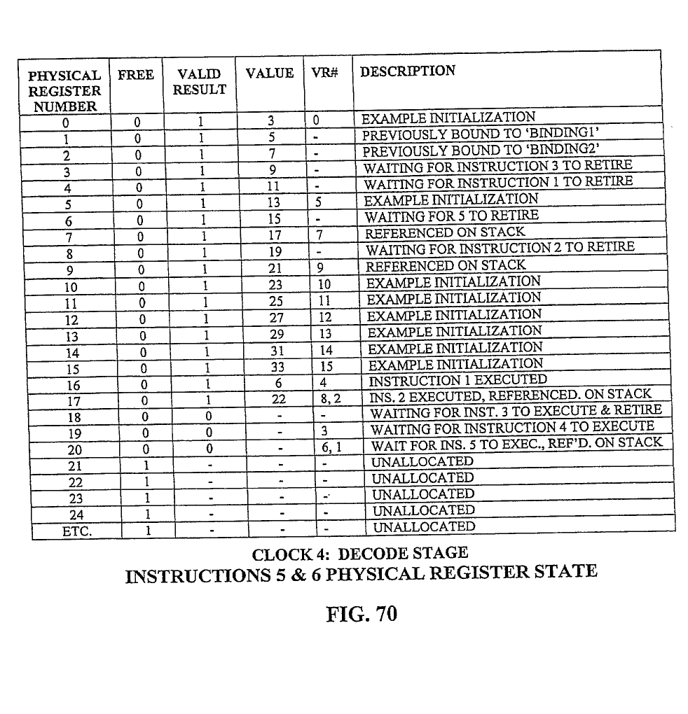

Clock 4 performs pre-execution processing steps 507, 508, 510, 512, 514, 516, 518, 532, 536, 704, 708 on Instructions 5 and 6 and maps their Virtual Registers to Physical Registers. FIG. 68 shows how Instruction 5 is mapped. Virtual registers VR4 and VR5 are source registers that are currently mapped to PR16 and PR5 respectively while the destination VR6 is mapped to a new Physical Register PR20 and its old destination PR6 is referenced by Instruction 5's Old Destination field in the mapped instruction. FIG. 69 shows how Instruction 6 is acted upon. This Call instruction is executed in the decode stage by pushing the Physical Register mappings PR1 and PR2 together with their VR bindings and Status for Virtual Registers 1 and 2 (the formal parameters), respectively, and Physical Register mappings PR20, PR7, PR17, and PR9 for Virtual Registers 6-9 respectively together with their Dirty status Bits and the Return Address of the next sequential instruction onto the previously mentioned stack. The action is completed by Binding VR6 with its map to PR20 to the first formal parameter (VR1) and by Binding VR8 with its map to PR17 to the second formal parameter (VR2) together with their Dirty status Bits, clearing the Dirty status Bits for Virtual Registers 6-9 and transferring control to the instruction addressed by the symbolic reference ‘A’. FIG. 69 shows the new entry on the stack. FIG. 70 summarizes the state of the Physical Registers at the end of Clock 4. Note the status of PR20 and the two VR references associated with it. Similarly there are two VR references associated with PR17. Except for the VR references noted, Instruction 6's actions are not reflected in FIG. 70 because the figure does not describe either the stack or the Dirty status Bits. Also note that Instructions 1 and 2 have executed in this clock and their results were stored in PR16 and PR17.

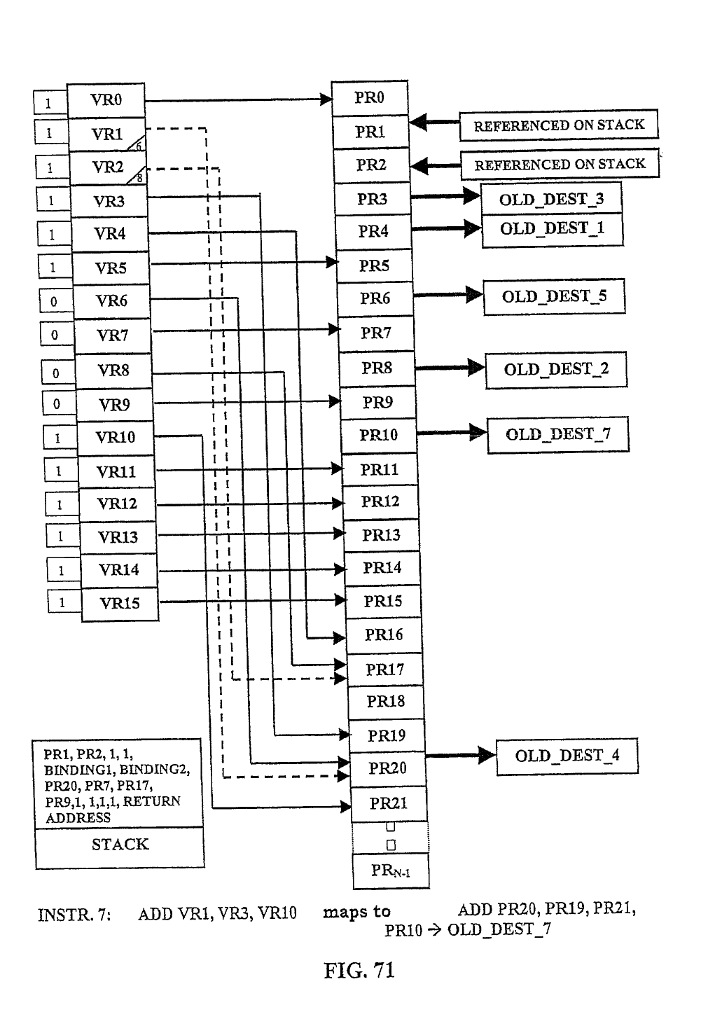

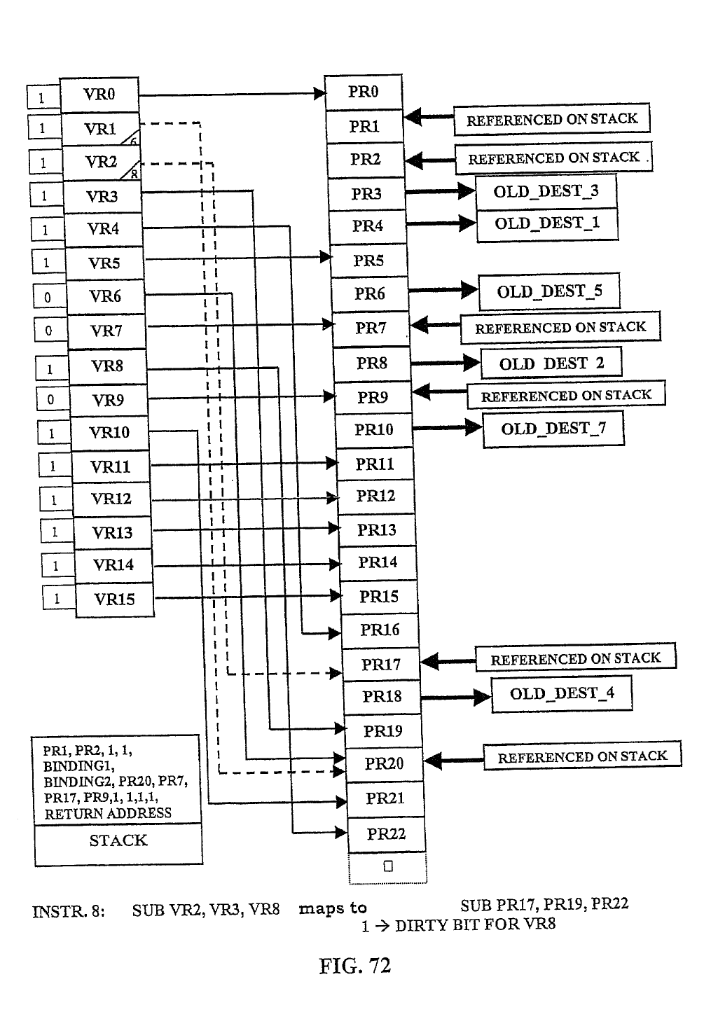

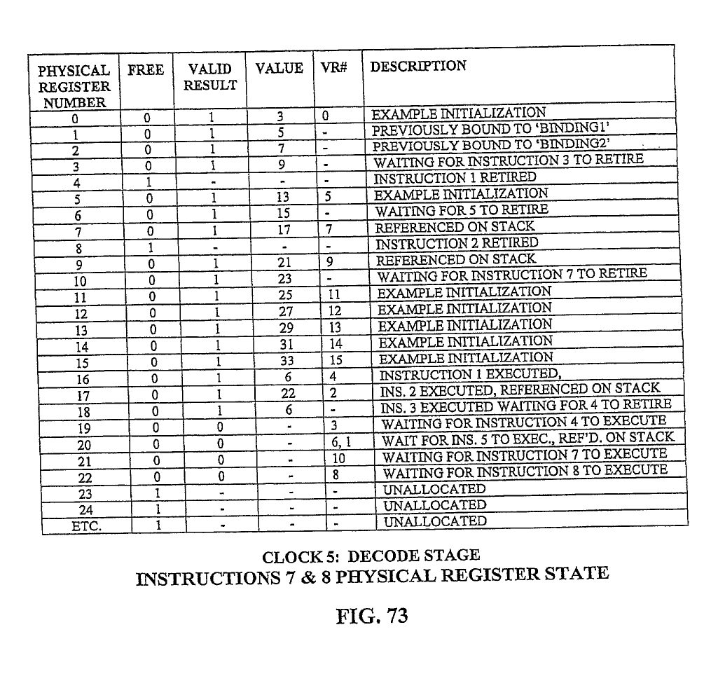

Clock 5 performs pre-execution processing steps 507, 508, 510, 512, 514, 516, 518, 532, 536, 704, 708 on Instructions 7 and 8 and maps their Virtual Registers to Physical Registers. FIG. 71 shows how Instruction 7 is mapped. Virtual registers VR1 and VR3 are source registers that are currently mapped to PR20 and PR19 respectively while the destination VR10 is mapped to a new Physical Register PR21 and its old destination PR10 is referenced by Instruction 7's Old Destination field in the mapped instruction. FIG. 72 shows how Instruction 8 is mapped. Virtual Registers VR2 and VR3 are source registers that are currently mapped to PR17 and PR19 respectively while the destination VR8 is mapped to a new Physical Register PR22 and the Dirty Bit of VR8 is set. The old destination PR17 for VR8 is not referenced by Instruction 8's Old Destination field in the mapped instruction because VR8's Dirty Bit was previously clear. PR17 is, however, referenced by the stack entry made for Instruction 6 and it is also referenced by VR2. FIG. 73 summarizes the state of the Physical Registers at the end of Clock 5. Note the status of PR17, PR21 and PR22. Also note that Instructions 1 and 2 have retired and the state of PR4 and PR8 have been changed to Free.

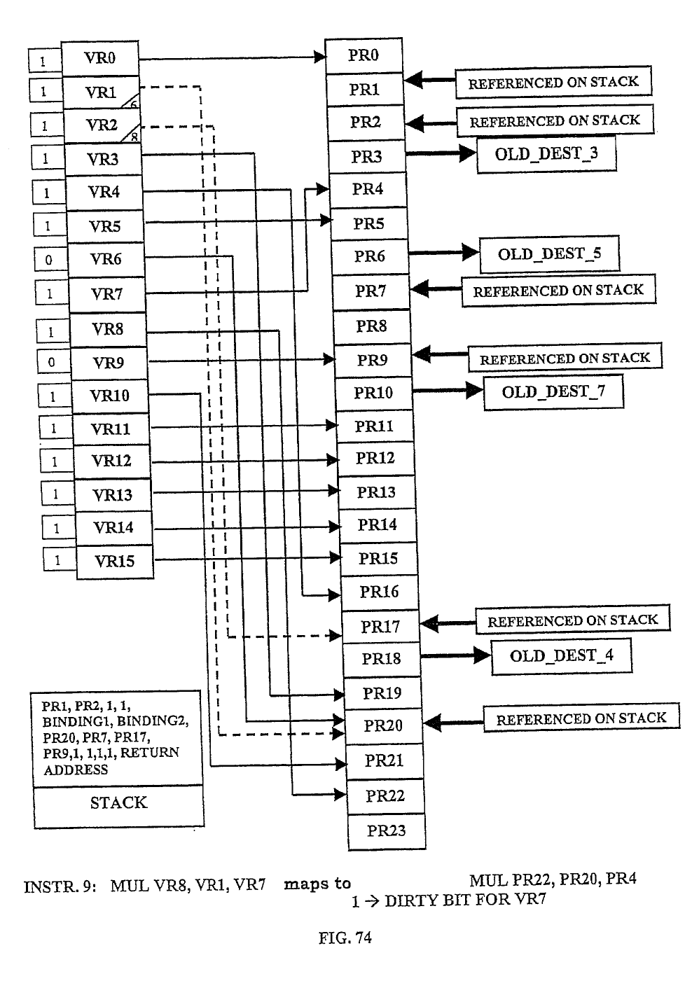

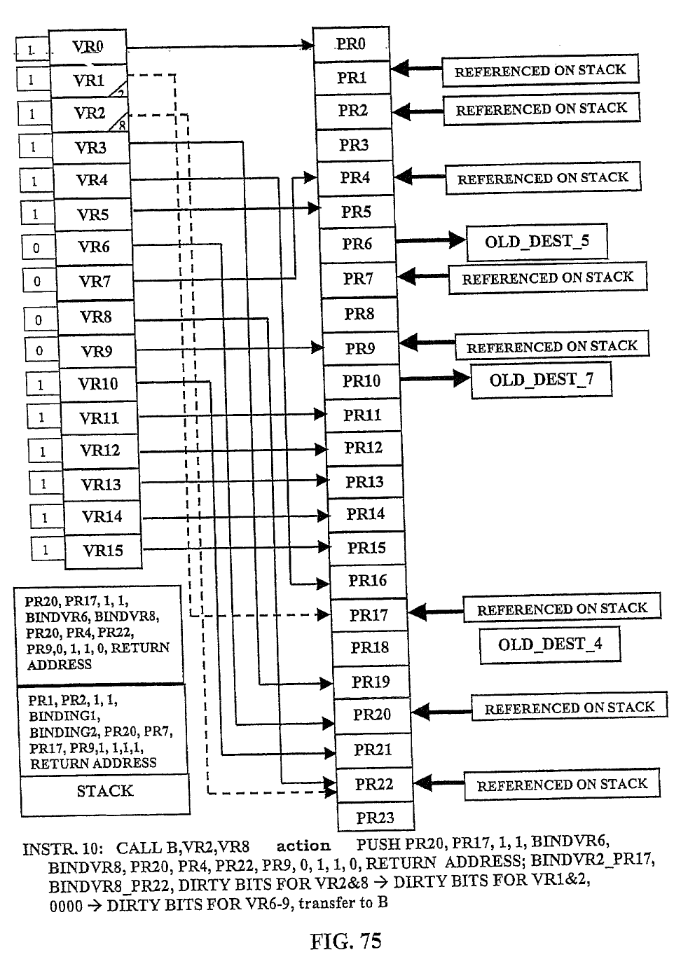

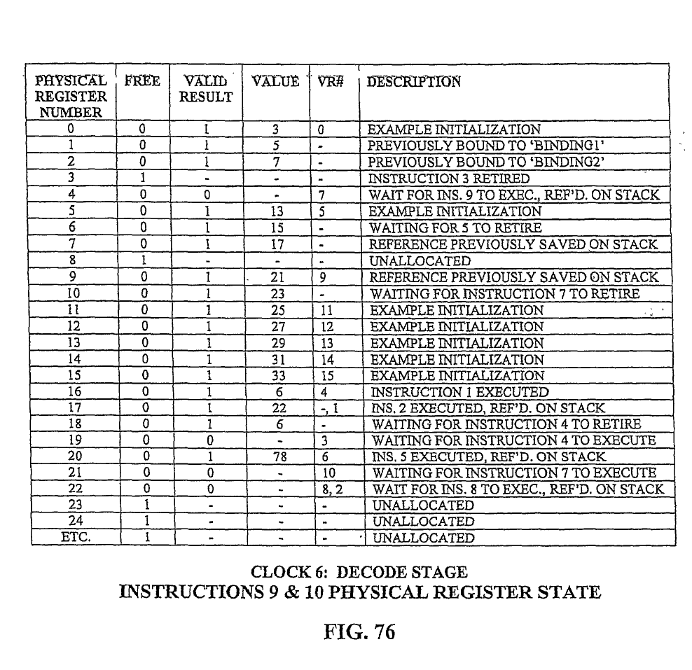

Clock 6 performs pre-execution processing steps 507, 508, 510, 512, 514, 516, 518, 532, 536, 704, 708 on Instructions 9 and 10 and maps their Virtual Registers to Physical Registers. FIG. 74 shows how Instruction 9 is mapped. Virtual registers VR8 and VR1 are source registers that are currently mapped to PR22 and PR20 respectively while the destination VR7 is mapped to a new Physical Register PR4 and the Dirty Bit of VR7 is set. The old destination PR7 for VR7 is not referenced by Instruction 9's Old Destination field in the mapped instruction because VR9's Dirty Bit was previously clear. PR7 is, however, referenced by the stack entry made for Instruction 6. FIG. 75 shows how Instruction 10 is acted upon. This Call instruction is executed in the decode stage by pushing the Physical Register mappings PR20 and PR17 together with their VR bindings and Status for Virtual Registers 1 and 2, respectively, and the Physical Register mappings PR20, PR4, PR22, and PR9 for Virtual Registers 6-9 respectively together with their Dirty status Bits and the Return Address of the next sequential instruction onto the previously mentioned stack. The action is completed by clearing the Dirty status Bits for Virtual Registers 6-9 and transferring control to the instruction addressed by the symbolic reference ‘B’. FIG. 75 shows the new entry on the stack. FIG. 76 summarizes the state of the Physical Registers at the end of Clock 6. Note the status of PR4, PR17, and PR22. Instruction 10's actions are not reflected in FIG. 76 because the figure does not describe either the stack or the Dirty status Bits. Also note that Instruction 5 has executed and restored its result in PR20 and Instruction 3 has retired and the state of PR3 has changed to Free.

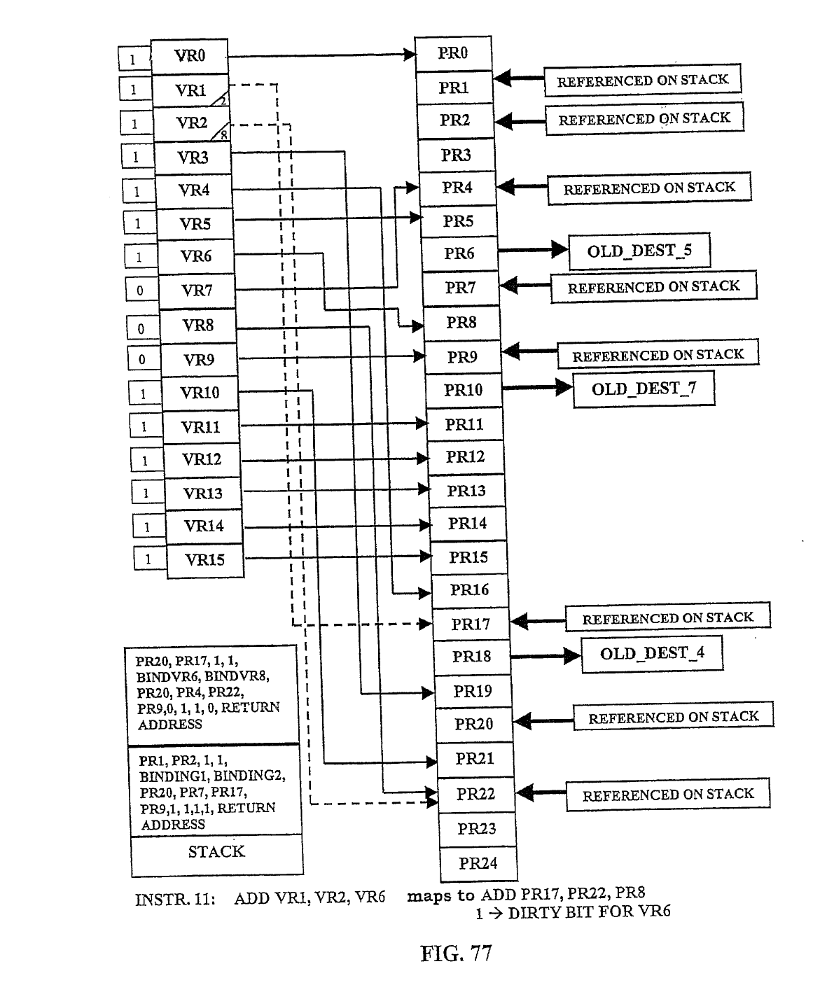

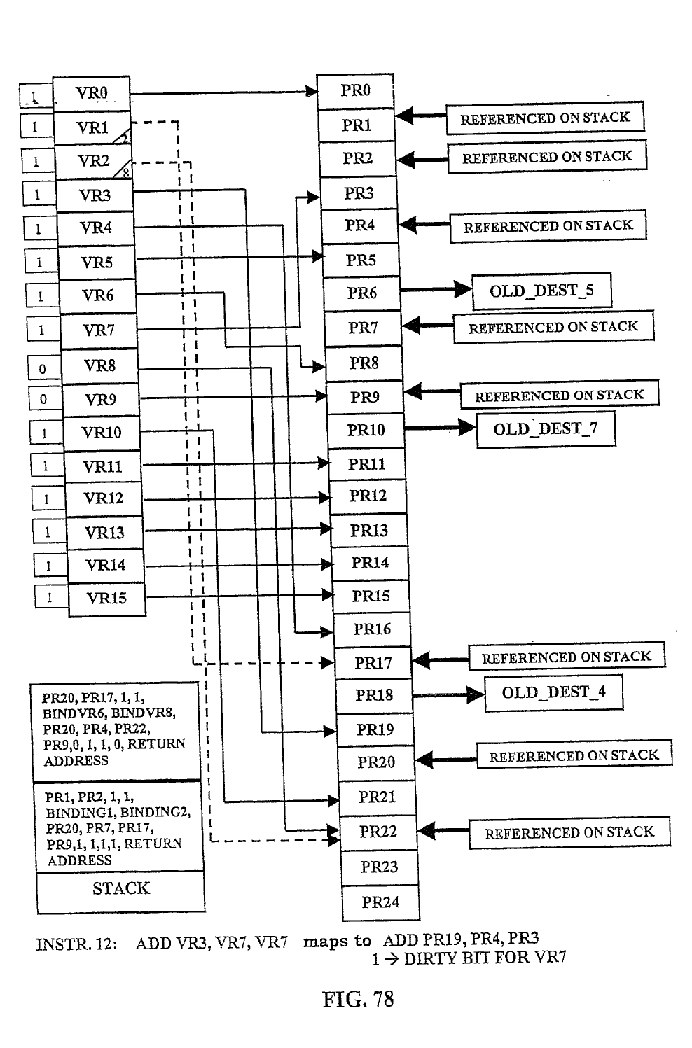

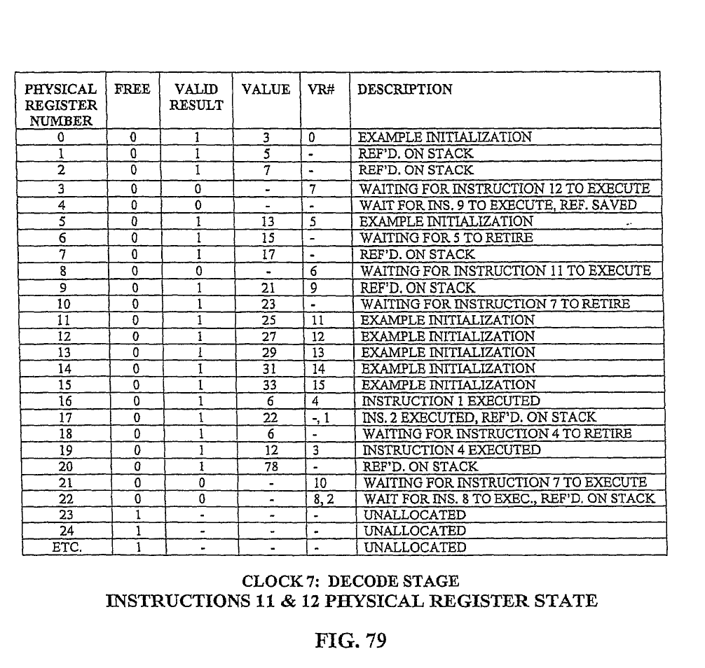

Clock 7 performs pre-execution processing steps 507, 508, 510, 512, 514, 516, 518, 532, 536, 704, 708 on Instructions 11 and 12 and maps their Virtual Registers to Physical Registers. FIG. 77 shows how Instruction 11 is mapped. Virtual registers VR1 and VR2 are source registers that are currently mapped to PR17 and PR22 respectively while the destination VR6 is mapped to a new Physical Register PR8 and the Dirty Bit of VR6 is set. The old destination PR20 for VR6 is not referenced by Instruction 11's Old Destination field in the mapped instruction because VR6's Dirty Bit was previously clear. PR20 is, however, referenced by the stack entry made for Instruction 10. FIG. 78 shows how Instruction 12 is mapped. Virtual Registers VR3 and VR7 are source registers that are currently mapped to PR19 and PR4 respectively while the destination VR7 is mapped to a new Physical Register PR3 and the Dirty Bit of VR7 is set. The old destination PR4 for VR7 is not referenced by Instruction 12's Old Destination field in the mapped instruction because VR7's Dirty Bit was previously clear. PR4 is, however, referenced by the stack entry made for Instruction 10. FIG. 79 summarizes the state of the Physical Registers at the end of Clock 7. Note the status of PR8 and PR3. Also note that Instruction 4 has executed and stored its result in PR19.

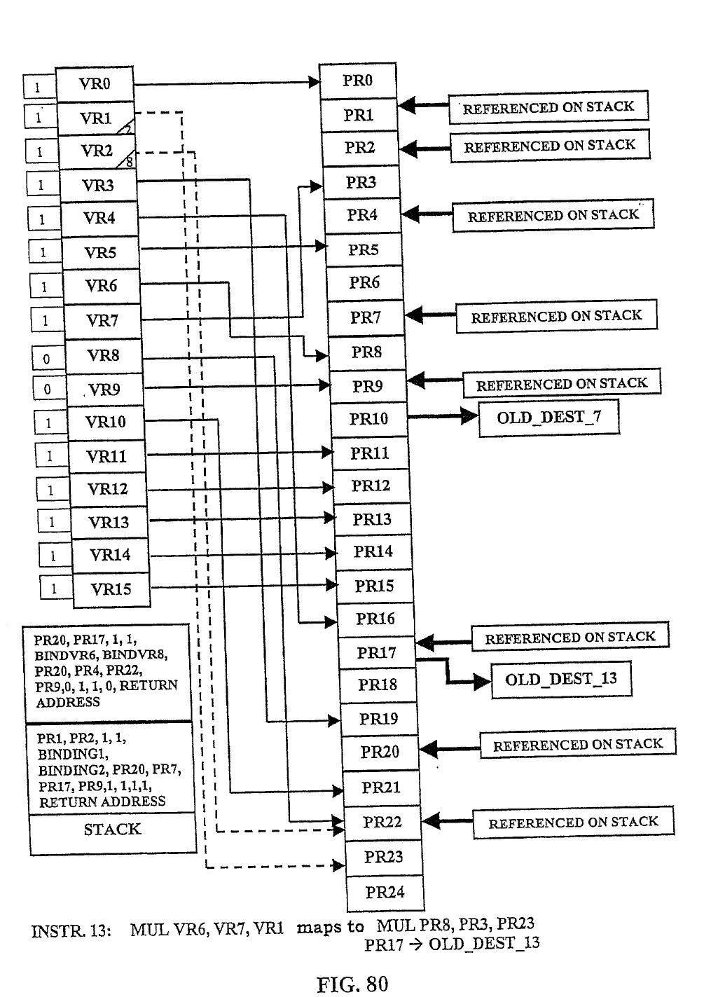

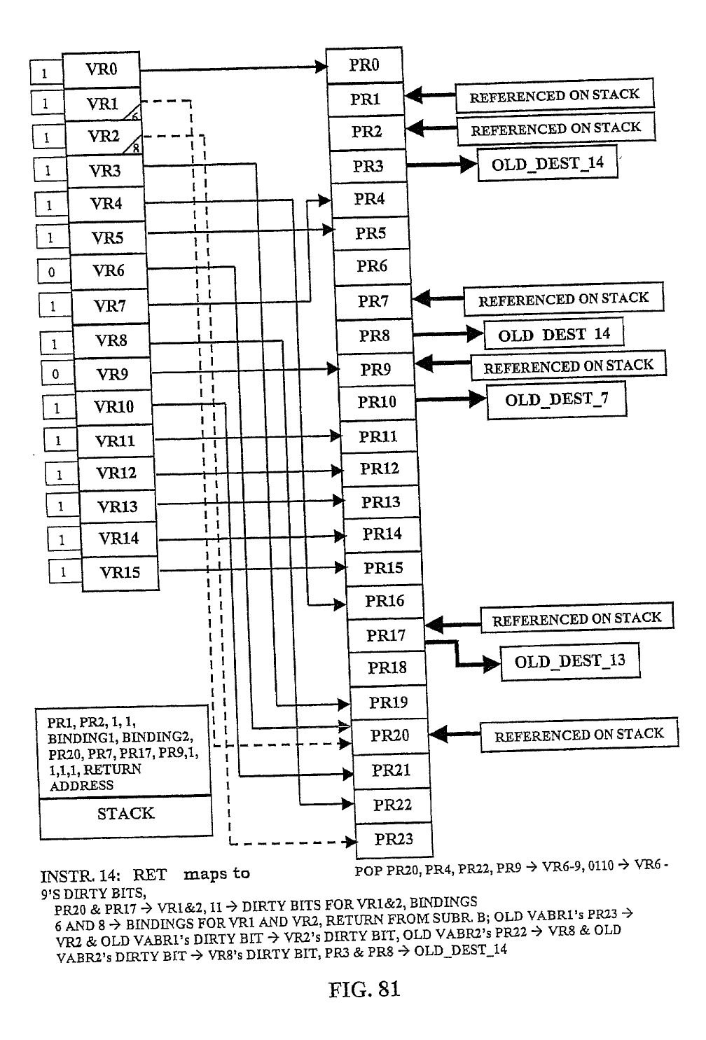

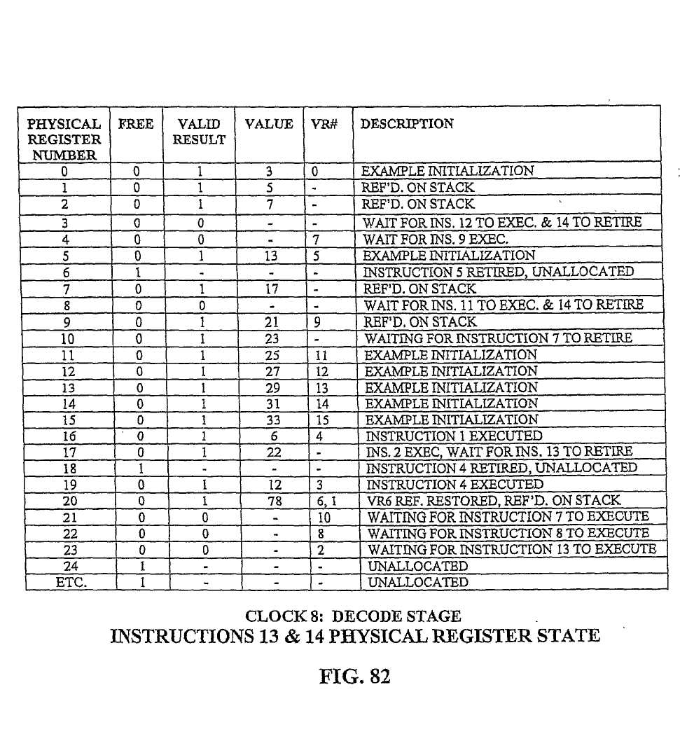

Clock 8 performs pre-execution processing steps 507, 508, 510, 512, 514, 516, 518, 532, 536, 704, 708 on Instructions 13 and 14 and maps their Virtual Registers to Physical Registers. FIG. 80 shows how Instruction 13 is mapped. Virtual registers VR6 and VR7 are source registers that are currently mapped to PR8 and PR3 respectively while the destination VR1 is mapped to a new Physical Register PR23 and its old destination PR17 is referenced by Instruction 13's Old Destination field in the mapped instruction. FIG. 81 shows how Instruction 14 is acted upon. This Return instruction is executed in the decode stage by popping the Physical Register mappings PR20, PR4, PR22, and PR9 into Virtual Registers 6-9 respectively together with their Dirty status Bits, PR20 and PR17 into Virtual Registers 1 and 2 respectively together with their Dirty status Bits and Bindings to VR6 and VR8. Control is then transferred to the instruction addressed by the Return address from the stack. The action is completed by making old destinations PR8 and PR3 referenced by Instruction 14's Old Destination field because the Dirty status Bits for VR6 and VR7 were set which indicated that their mappings had been changed since the Call to the subroutine was made in Instruction 10. FIG. 81 shows the popped state of the stack. FIG. 82 summarizes the state of the Physical Registers at the end of Clock 8. Note the status of PR3, PR4, PR8, PR20, PR22, and PR23. Also note that Instructions 4, 5, and 6 have retired and that the state of PR18 and PR6 have been changed to Free.

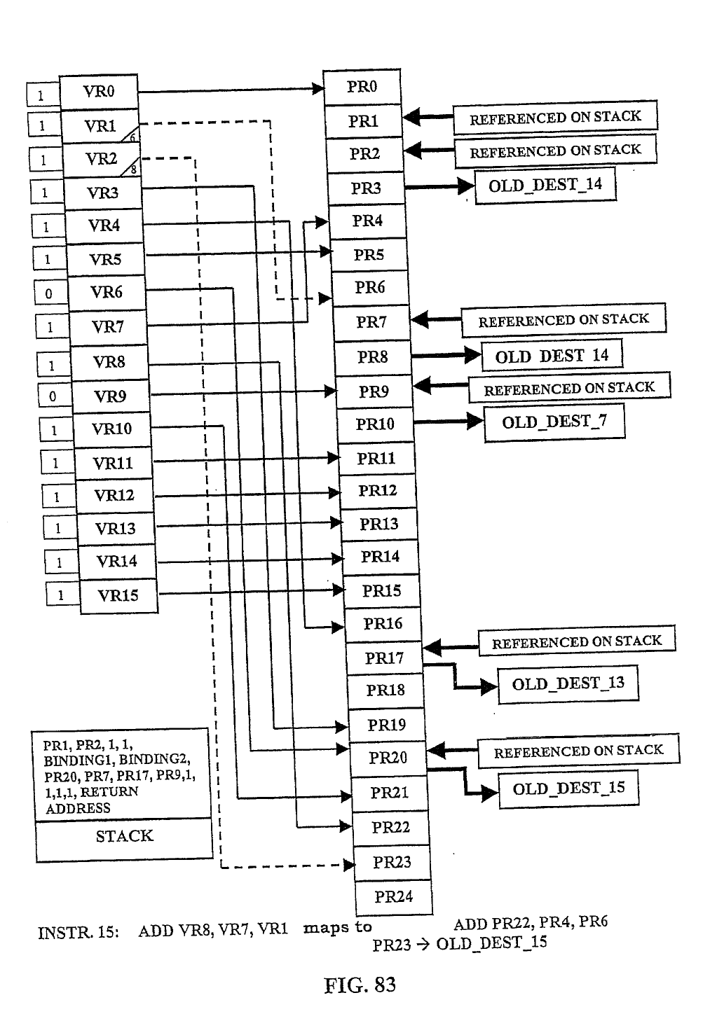

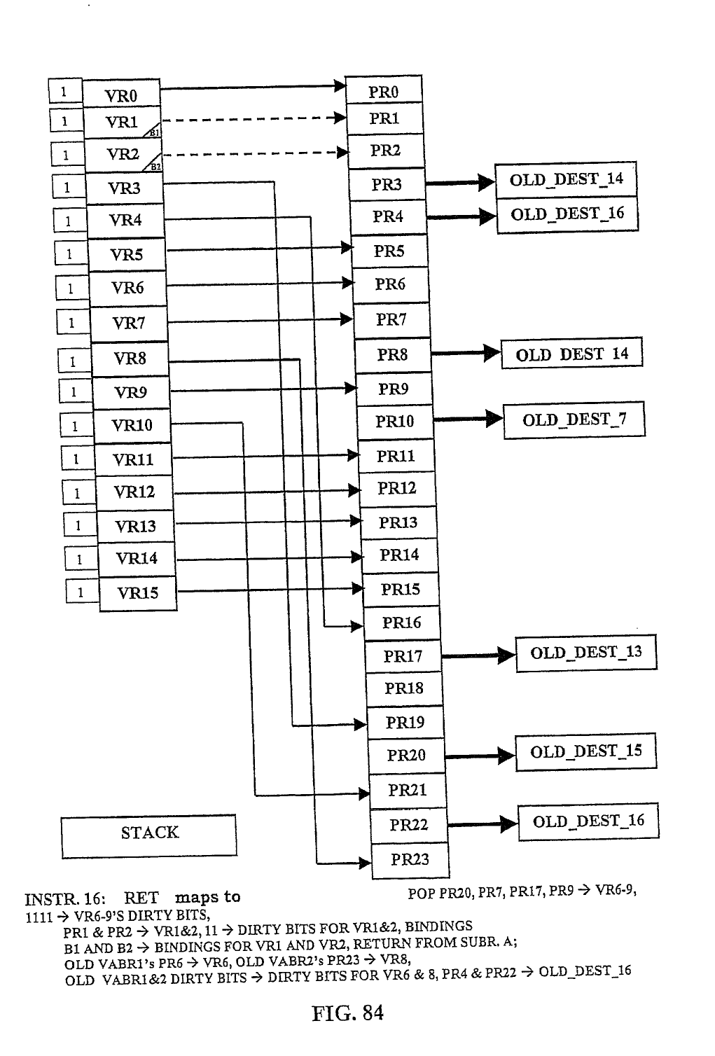

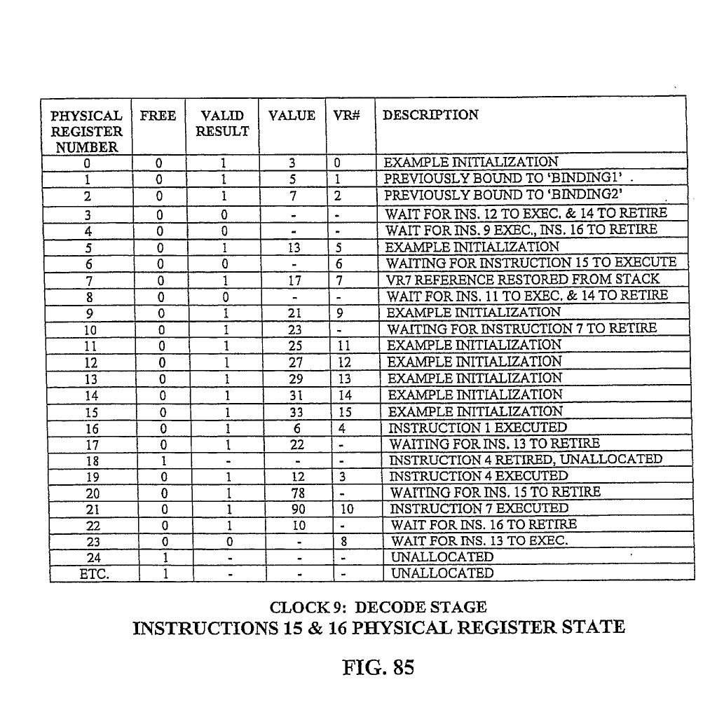

Clock 9 performs pre-execution processing steps 507, 508, 510, 512, 514, 516, 518, 532, 536, 704, 708 on Instructions 15 and 16 and maps their Virtual Registers to Physical Registers. FIG. 83 shows how Instruction 15 is mapped. Virtual registers VR8 and VR7 are source registers that are currently mapped to PR22 and PR4 respectively while the destination VR1 is mapped to a new Physical Register PR6 and its old destination PR23 is referenced by Instruction 15's Old Destination field in the mapped instruction. Note that VR7's mapping to PR4 is to the mapping that existed before the Call to subroutine ‘B’ was executed in Instruction 10. FIG. 84 shows how Instruction 16 is acted upon. This Return instruction is executed in the decode stage by popping the Physical Register mappings PR20, PR7, PR17, and PR9 into Virtual Registers 6-9 respectively together with their Dirty status Bits, PR1 and PR2 into Virtual Registers 1 and 2 respectively together with their Dirty status Bits and Bindings to ‘B1’ and ‘B2’. Control is then transferred to the instruction addressed by the Return address from the stack. The action is completed by making old destinations PR4 and PR22 referenced by Instruction 16's Old Destination field because the Dirty status Bits for VR7 and VR8 were set which indicated that their mappings had been changed since the Call to the subroutine was made in Instruction 6. FIG. 84 shows the popped state of the stack. FIG. 85 summarizes the state of the Physical Registers at the end of Clock 9. Note the status of PR1, PR2, PR7, PR17, PR20, and PR22. Also note that Instructions 7 and 8 have executed and stored their results in PR21 and PR22.

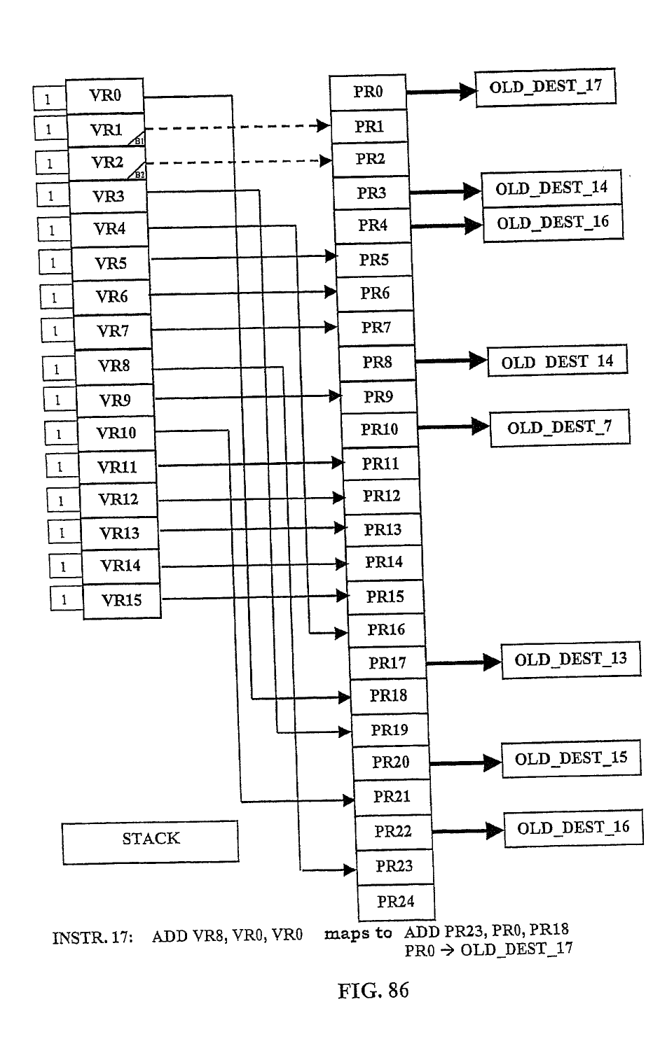

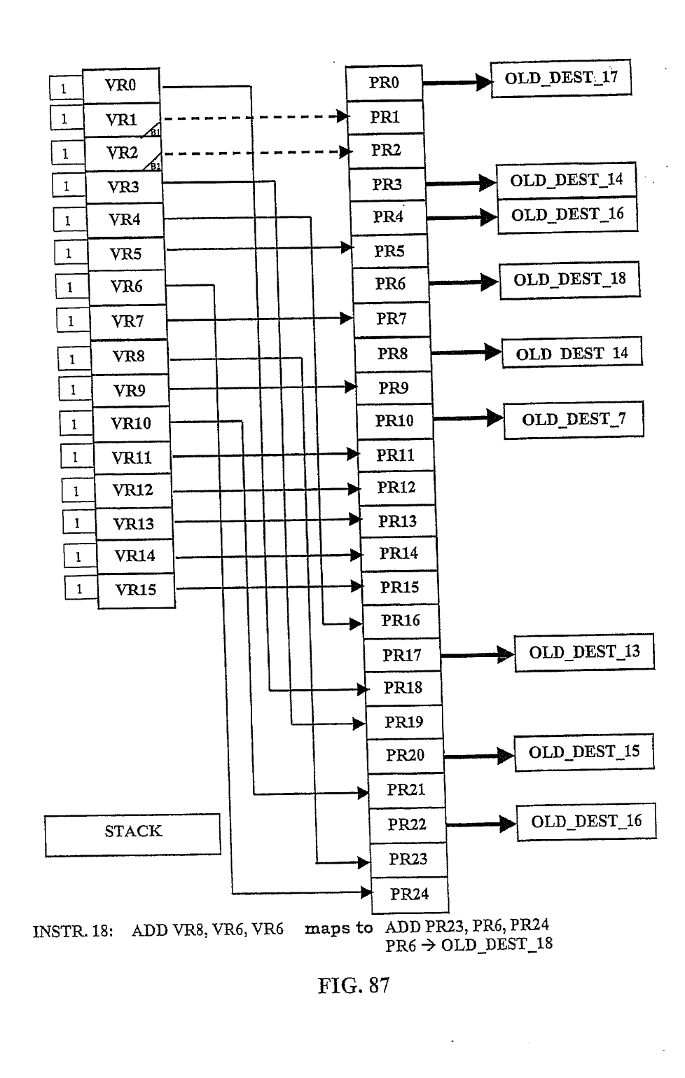

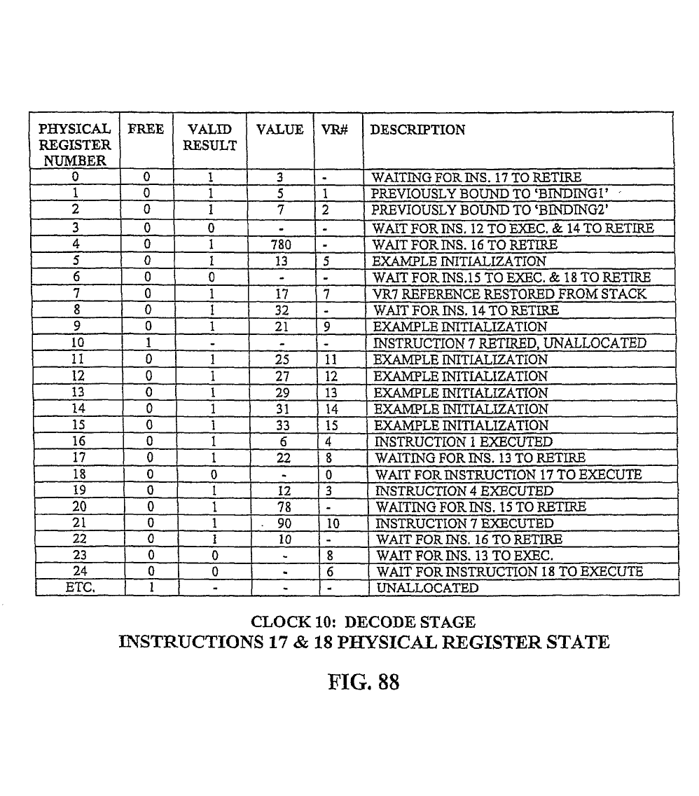

Clock 10 performs pre-execution processing steps 507, 508, 510, 512, 514, 516, 518, 532, 536, 704, 708 on Instructions 17 and 18 and maps their Virtual Registers to Physical Registers. FIG. 86 shows how Instruction 17 is mapped. Virtual registers VR8 and VR0 are source registers that are currently mapped to PR23 and PR0 respectively while the destination VR0 is mapped to a new Physical Register PR18 and its old destination PR0 is referenced by Instruction 17's Old Destination field in the mapped instruction. FIG. 87 shows how Instruction 18 is mapped. Virtual Registers VR8 and VR6 are source registers that are currently mapped to PR23 and PR6 respectively while the destination VR6 is mapped to a new Physical Register PR24 and its old destination PR6 is referenced by Instruction 18's Old Destination field in the mapped instruction. FIG. 88 summarizes the state of the Physical Registers at the end of Clock 10. Note the status of PR18 and PR24. Also note that Instructions 9 and 11 have executed and stored their results in PR4 and PR8.

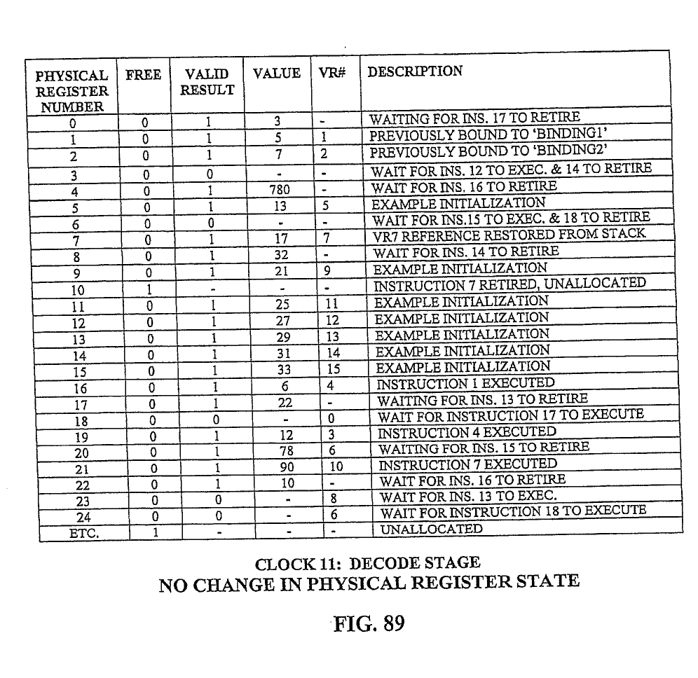

Clock 11 has no further instructions to decode in this example. FIG. 89 shows that there is no change in the physical register state at the end of this clock even though Instructions 9, 10, and 11 have retired.

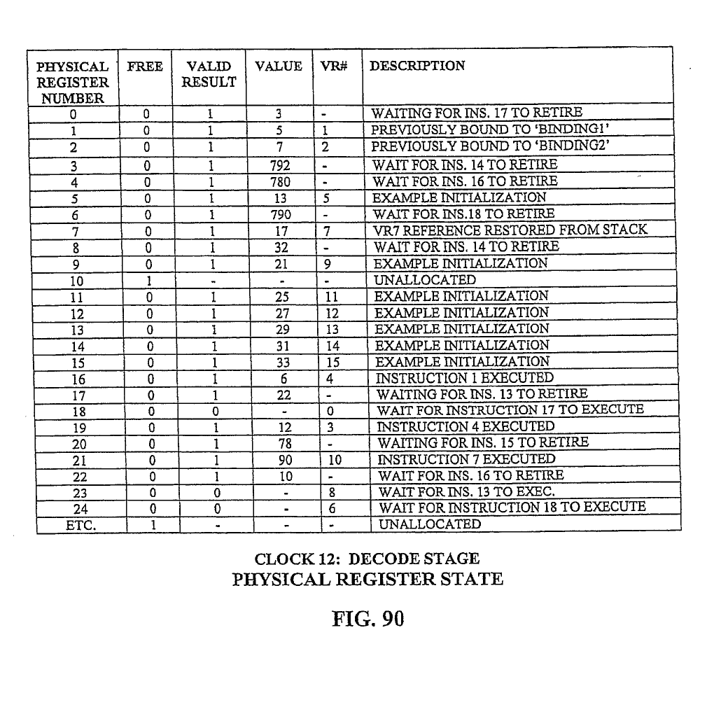

Clock 12 has changes in the physical register state as shown in FIG. 90. Note that Instructions 12 and 15 have executed and stored their results in PR3 and PR6.

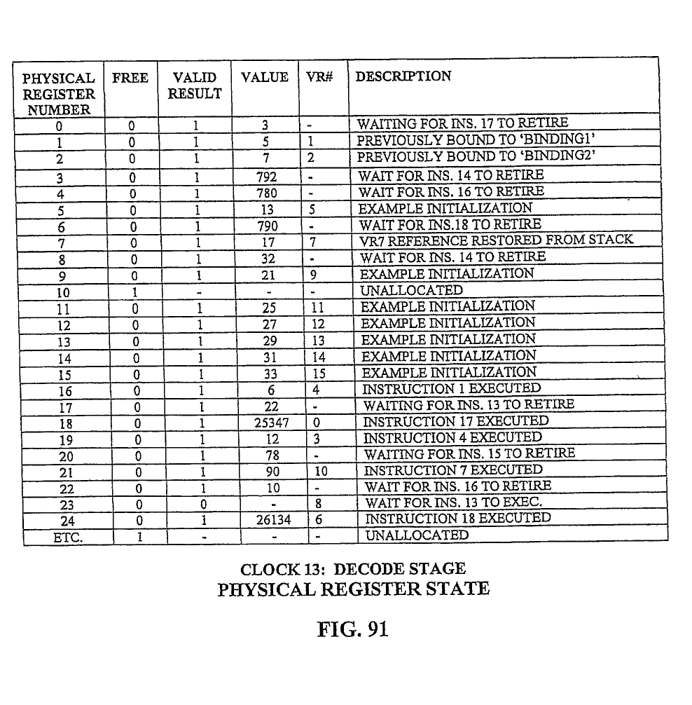

Clock 13 has changes in the physical register state as shown in FIG. 91. Note that Instructions 17 and 18 have executed and stored their results in PR18 and PR24. Also note that Instruction 12 has retired.

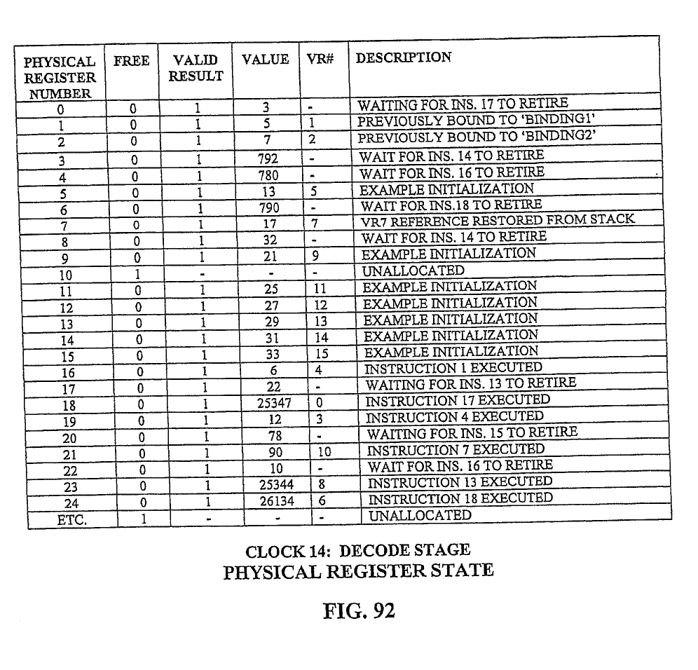

Clock 14 has changes in the physical register state as shown in FIG. 92. Note that Instruction 13 has executed and stored its result in PR23.

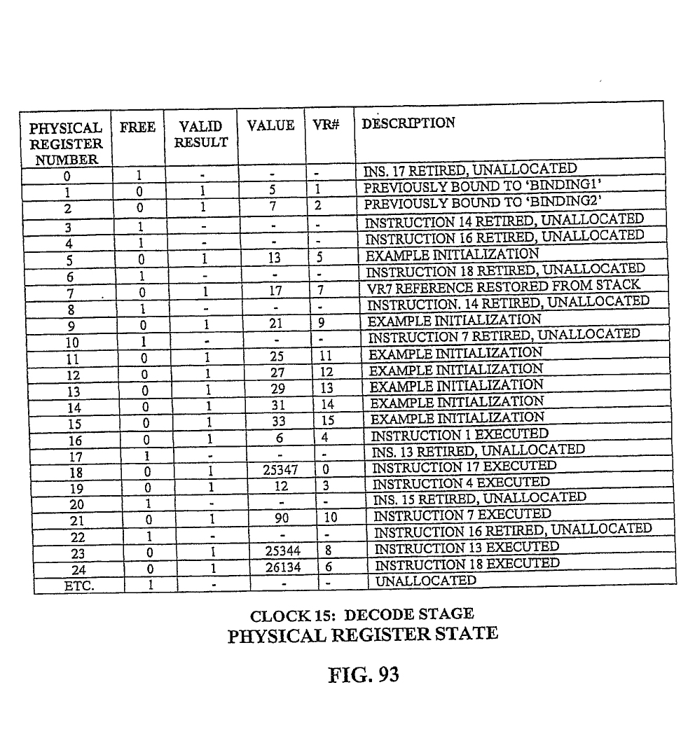

Clock 15 has changes in the physical register state as shown in FIG. 93. Note that Instructions 13, 14, 15, 16, 17, and 18 have retired and that the state of several Physical Registers have been changed to Free.

This completes the example illustration.

Although the above embodiments are described as saving and restoring the subsets of virtual registers as partial steps of call and return instructions, the invention may also be used for saving and restoring of subsets of virtual registers as steps of save and restore instructions, and the subsets could be variable as specified by the instruction. The invention may also be used in saving and restoring the subsets of virtual registers as steps in a combination of call and return instructions and saving and restoring instructions or may be used for saving and restoring of subsets of virtual registers in some other instructions.

Although the stack cache is described as last-in first-out stack, the implementation of the stack cache is not limited to last-in first-out stack but may include any type of memory structure or media that allows the saving of data, such as a table in memory. The stack may be any type of memory structure or circuit that allows the saving of a list of data. More preferably, the stack is a memory structure that allows the last provided data to be able to be removed first.

Although the states of the status bits are described as “clean” and “dirty”, other types of nomenclature may be used, such as “used” and “unused” to generally indicate if a virtual register has been assigned a new destination register. The use of the terms “clean” and “not clean” may be used to indicate “clean” and “dirty” or “used” and “unused” or other such status to indicate that a virtual register has been mapped from an old physical register to a new physical register. Although the preferred embodiment uses a status bit and a comparator 604 to indicate if a virtual register is clean or dirty, other status indicators may be used to indicate if a virtual register is clean or dirty. In another embodiment a value that would be an invalid physical register address may be placed in virtual registers to be indicated as “clean”. A comparator may be used to determine that a virtual register is dirty “not clean” if the virtual register contains a valid physical register address. By placing the value in the virtual register on a stack the status of the virtual register is saved.

While this invention has been described in terms of several preferred embodiments, there are alterations, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A method of mapping a plurality of virtual registers to a plurality of physical registers comprising:
providing a plurality of virtual registers, wherein each virtual register
comprises physical register address bits; and
providing a status indicator for indicating the status of each virtual register.

2. The method, as recited in claim 1, further comprising:
mapping a virtual register from an old physical register to a new physical register, when the virtual register is a destination virtual register of an instruction being decoded; and
placing an address of the old physical register in an instruction retirement list related to the instruction being decoded if and only if the status indicator indicates that the virtual register is not clean.

3. The method, as recited in claim 2, further comprising saving a physical register address held in a virtual register and a status of the virtual register indicated by the status indicator to a stack and setting to clean at least status of the virtual register.

4. The method, as recited in claim 2, further comprising setting the status of a virtual register to not clean when the virtual register is mapped to a new physical register.

5. The method, as recited in claim 4, wherein the status indicator comprises:
a plurality of status bits, wherein each virtual register of the plurality of virtual registers is associated with at least one of the status bits of the plurality of status bits; and
a comparator, which detects the value in each of the status bits of the plurality of status bits, wherein the values in the status bits associated with the saving of a status on a stack is accomplished by saving a value in at least one status bit on the stack.

6. The method, as recited in claim 1, further comprising designating a plurality of virtual registers of the plurality of virtual registers as virtual local registers.

7. The method, as recited in claim 6, further comprising executing a save command, comprising:
saving the mapping of all virtual local registers onto a stack; and
saving a status as indicated by the status indicator for each of the virtual local registers onto the stack.

8. The method, as recited in claim 7, wherein the save command further comprises setting the status of all virtual local registers to “clean”.

9. The method, as recited in claim 8, further comprising executing a restore command, comprising:
popping the mapping of all virtual local registers from the stack to the virtual local registers; and
popping the status of all virtual local registers from the stack.

10. The method, as recited in claim 9, further comprising:
binding a first virtual register of the plurality of virtual registers to a second virtual register of the plurality of virtual registers; and
binding the status of the first virtual register to the second virtual register.

11. The method, as recited in claim 10, wherein the binding comprises placing a physical address stored in the second virtual register in the first virtual register and setting the status of the first virtual register to the status of the second virtual register.

12. The method, as recited in claim 11, wherein the binding further comprises:
saving the mapping of the first virtual register onto the stack cache; and
saving the status of the first virtual local register onto the stack cache.

13. The method, as recited in claim 12, wherein the binding occurs during a call instruction, wherein the call instruction has at least one argument, wherein the first virtual register is used for the at least one argument.

14. The method, as recited in claim 11, wherein subsequent the binding when the first virtual register is a destination register, the first virtual register is assigned a physical register address which is different than a physical register address stored in the second virtual register.

15. The method, as recited in claim 1, wherein the status indicator comprises:
a plurality of status bits, wherein each virtual register of the plurality of virtual registers is associated with at least one of the status bits of the plurality of status bits; and
a comparator, which detects the value in each of the status bits of the plurality of status bits.

16. A processing device, comprising:
a plurality of physical registers;
a plurality of virtual registers, wherein each virtual register comprises physical register address bits; and
a status indicator for indicating a status of each virtual register.

17. The processing device, as recited in claim 16, further comprising:
an instruction decoder for decoding an instruction;
an instruction retirement list;
machine readable code for mapping a virtual register from an old physical register to a new physical register, when the virtual register is a destination virtual register of an instruction being decoded; and
machine readable code for placing an address of the old physical register in an instruction retirement list related to the instruction being decoded if and only if the status indicator indicates that the virtual register is not clean.

18. The processing device, as recited in claim 17, further comprising a stack, wherein a physical register address held in a virtual register and at least one status bit associated with the virtual register of the plurality of virtual registers is saved to the stack and the status of the saved virtual register is set to clean.

19. The processing device, as recited in claim 18, wherein the status indicator comprises:
a plurality of status bits, wherein each virtual register of the plurality of virtual registers is associated with at least one of the status bits of the plurality of status bits; and
a comparator, which detects the value in each of the status bits of the plurality of status bits, wherein the values in the status bits associated with the saving of a status on a stack is accomplished by saving a value in at least one status bit on the stack.

20. The processing device, as recited in claim 19, wherein the status of a virtual register is set to not clean when the virtual register is mapped to a new physical register.
